(19) United States
(12) Patent Application Publication
(10) Pub. No.: US 2026/0312129 A1
(43) Pub. Date: Oct. 8, 2026

(54) MODIFIED INORGANIC SOLID-STATE ELECTROLYTES (SSES) FOR LITHIUM, SODIUM, AND POTASSIUM BATTERIES

(71) Applicant: BOARD OF REGENTS, THE UNIVERSITY OF TEXAS SYSTEM, Austin, TX (US)

(72) Inventors: David MITLIN, Lago Vista, TX (US); Vikalp RAJ, Austin, TX (US)

(21) Appl. No.: 19/484,677

(22) PCT Filed: May 17, 2024
(86) PCT No.: PCT/US2024/029976

§ 371 Date: Nov. 14, 2025

Related U.S. Application Data
(60) Provisional application No. 63/502,817, filed on May 17, 2023.
(60) Provisional application No. 63/528,175, filed on Jul. 21, 2023.

(51) Int. Cl. H01M 10/0562

(52) U.S. Cl. CPC H01M 10/0562; H01M 2300/0071

(57) ABSTRACT

An electrochemical cell and method of making the same is disclosed herein. The electrochemical cell is characterized by comprising a solid-state electrolyte with a toughening phase. The disclosed electrochemical cell is further characterized the toughened solid-state electrolyte having a high density and high ionic conductivity. The disclosed method of making the electrochemical cell comprises forming the solid-state electrolyte with a toughing additive. The toughening additive being one of carbides, nitrides, or any other suitable toughening additive.

### CROSS-REFERENCE TO RELATED APPLICATION

This application claims the benefit of U.S. Provisional Applications 63/502,817, filed May 17, 2023, and 63/528,175, filed Jul. 21, 2023, the contents of each are hereby incorporated in their entirety.

### STATEMENT OF GOVERNMENT SUPPORT

This invention was made with government support under Grant no. DE-SC0023260 awarded by the Department of Energy. The government has certain rights in the invention.

### BACKGROUND

In the past two decades, lithium-ion batteries (LIBs) have made significant strides in reducing cost, increasing energy density, and ramping up global production to address the growing demands for electrochemical energy storage.^{1,2} For example, the cost at the Li-ion pack level have come down from approximately $1000 per kWh in 2009 to $180 per kWh in 2020, with a concomitant increase in gravimetric energy from 125 Wh/kg to 250 Wh/kg.^{3,4} While specific energy of LIBs has grown incrementally at 7% per year, the recurring safety concerns associated with the liquid organic-based electrolytes have remained and even intensified with the application of higher-voltage higher-capacity cathodes.^{5,6} The next-generation “Beyond Lithium” electrochemical energy storage technologies should provide greater specific and volumetric energy, power, as well as long-term cyclability. Reducing cost of the battery systems is a key enabler for much wider application of renewable energy conversion based on solar and wind.^{2,7-9} Optimizing the performance and improving the safety can bolster greater consumer confidence in batteries.^{3,10-12} In addition, ideal storage systems should have the flexibility to provide energy and power on demand, be scalable, and preferably based on earth-abundant materials to counter the supply-chain and other market constraints.¹³

Lithium metal-based batteries (LMBs) employ a Li metal anode coupled with a conventional high voltage ceramic or a low voltage sulfur-based cathode. The configuration can achieve cell level specific energies exceeding 500 Wh/kg,¹⁴ potentially nearly doubling the range of electric vehicles (EVs) on a single charge.^{15,16} However, use of the reactive Li metal anode, versus a conventional ion insertion anode based on graphite, creates substantial issues in battery safety and longevity. Hence, there is a persistent effort in the research community to develop safe LMBs, and more recently sodium metal batteries (SMBs) and potassium metal batteries (KMBs).¹⁷⁻²⁰ The specific capacities of Li, Na and K metal anodes are 3861 mAh/g, 1165 mAh/g and 678 mAh/g, all far surpassing the capacity of graphite with Li at 372 mAh/g and of carbon with K and Na at 250-350 mAh/g.³⁻⁶ The higher capacity combined with wider voltage window results in over 50% increase in the gravimetric energy versus conventional ion-insertion anodes. For example, a key state-of-the-art LMB architecture is based on a high voltage 811 LiNi_{0.8}Co_{0.1}Mn_{0.102} (NMC) cathode with an energy surpassing 500 Wh/kg.³ However, due to the safety concerns of combining a metal anode with a flammable liquid electrolyte, all commercial LMBs remain based on the far less energetic graphite or Si-carbon nanocomposites.²¹⁻²⁴ Likewise, emerging room temperature sodium and potassium-based secondary batteries employ carbon-based anodes instead.

Achieving long-term stable and safe metal anode plating/stripping performance remains a key impediment for successful metal batteries, with conventional liquid organic electrolytes remaining out of reach due to their reactivity with the metal anode, and the associated lifetime and safety concerns.^{25,26} Employing solid-state electrolytes (SSEs) rather than liquid organic electrolytes is a possible path towards greater battery safety since most inorganic SSE's are non-flammable.^{27,28}

### SUMMARY

This invention covers the addition of mechanical toughening second-phase to LLZO and other inorganic solid-state electrolytes (SSEs) to prevent fracture and dendrite growth during service. The toughening phase also aids in the densification of the SSE during sintering resulting in higher final compact density for a given processing regiment. The additives also improve the ionic conductivity of the SSE as a result of the denser structure with less pores and other deleterious interfaces.

Solid state SSEs are prone to fracture and growth of dendrites during service, leading to early failure. The current approach solves this problem.

Currently, the only potential solution to preventing cracks and dendrites is to achieve near 100% dense sintered compacts with minimal defects. This extremely challenging and expensive. The toughened SSEs reported here are mechanical robust without having to achieve near 100% density.

This invention solves the major problem with solid-state batteries, cracking and dendrites being the key impediment to wide-scale commercialization.

In some aspects, the techniques described herein relate to an electrochemical cell including: a solid-state electrolyte including two or more phases; wherein at least one phase is an ion-conductive phase; and wherein at least one phase is a toughening phase.

In some aspects, the techniques described herein relate to a method to make an electrochemical cell, including incorporating at least one toughening additive into a solid-state electrolyte.

### BRIEF DESCRIPTION OF DRAWINGS

The skilled person in the art will understand that the drawings described below are for illustration purposes only.

FIGS. 1A-1D show the crystal structure of tetragonal Li₇La₃Zr₂O₁₂ (LLZO)¹⁴² (FIG. 1A), the crystal structure of cubic LLZO¹⁵² (FIG. 11B), in-situ XRD analysis of Li₇La₃Zr₂O₁₂, showing the evolution of the structure with heating (FIG. 1C), and a plot of undoped and Ta, Nb doped lattice parameters vs. temperature, highlighting doping-induced stabilization of the cubic structure (FIG. 1D).¹⁴¹

FIGS. 2A-2E show oxygen K-edge EELS line scan data of c-LLZO-Li interfacial layer as a function of distance in nm (FIG. 2A),¹⁴⁶ an SEM image of dendritic Li metal nucleated at the grain boundaries of LLZO (FIG. 2B),¹⁶³ Lithium platting/stripping performance of LLCZN (FIG. 2C) and LLCZN@LAO (FIG. 2D) in Li symmetric cells at different current densities,¹⁶⁴ and an SEM image of the contact of a garnet surface with molten Li (FIG. 2E).¹⁶⁵

FIG. 3 shows a SEM image of an as synthesized LLZTO pellet, where cracks/voids running in parallel to the pellet are identified by the inset bounding box.

FIG. 4 shows XRD graphs of standard ICSD (top) and LLZTO (TaC) Pellet (bottom).

FIG. 5 shows a Nyquist plot of LLZTO with TaC additive.

FIGS. 6A and 6B show SEM images of as synthesized LLZTO-TaC pellets.

FIG. 7 shows a Li/LLZTO-TaC/Li Symmetric cell cycled at a current density (j) of 1 mA/cm² and a capacity of 1 mAh/cm².

FIGS. 8A-8E show a schematic show in the synthesis mechanism of ZrO₂-LLZTO and baseline LLZTO pellets (FIG. 8A); SEM image and associated EDXS elemental maps of La, Zr, Al and a mix phase of fracture surface region for ZrO₂-LLZTO (FIG. 8B) and baseline LLZTO (FIG. 8C); and high resolution XPS spectra of Zr 3d (FIG. 8D) and Ta 4f (FIG. 8E) with increasing concentration of TaC.

FIGS. 9A-9B show secondary electron (SE) mode SEM image of ZrO₂-LLZTO fracture surface (FIG. 9A). The image highlights the presence of spherical zirconium oxide phase at an exposed grain boundary of a single large LLZTO particle. FIG. 9B shows SEM image and associated EDXS elemental maps of La, Zr and O of another fracture surface region, also highlighting zirconium oxide at several grain boundaries.

FIG. 10 shows XRD analysis comparing ZrO₂-LLZTO, baseline LLZTO and a standard diffraction pattern.

FIG. 11A-11E shows SEM and EDXS analysis of ZrO₂-LLZTO including SEM images of polished cross-section, presented at increasing magnification (FIGS. 11A-11C); SEM and EDXS analysis of a polished cross-section (FIG. 11D); and SEM and EDXS analysis of mechanically fractured surface (FIG. 11E).

FIG. 12A-12C Cross-section SEM of polished LLZTO pellets with 4 wt. % (FIG. 12A), 6 wt. % (FIG. 12B), and 8 wt. % (FIG. 12C) ZrO₂ phases respectively. Arrows in FIG. 12A point to the spherical shaped zirconia oxide precipitated at the LLZTO grain boundaries.

FIG. 13A-13E show SEM and EDXS analysis of baseline LLZTO including SEM images of polished cross-section, presented at increasing magnification (FIGS. 13A-13C); SEM and EDXS analysis of a polished cross-section (FIG. 13D); and SEM and EDXS analysis of mechanically fractured surface (FIG. 13E).

FIG. 14A-14D show example of quantitative stereology analysis of the porosity present in the polished cross-section of the ZrO₂-LLZTO specimen (FIGS. 14A-14B) and example of quantitative stereology analysis of the porosity presents in the polished cross-section of the baseline LLZTO specimen (FIGS. 14C-14D).

FIG. 15 shows Example of quantitative stereology analysis of the volume fraction of zirconia oxide in the 4 wt. % ZrO₂-LLZTO specimen.

FIG. 16A-16D show room temperature Nyquist plots for ZrO₂-LLZTO and baseline LLZTO compacts (FIG. 16A), obtained using gold blocking electrode symmetric cells; a comparison plot of ionic conductivity vs. temperature for the specimens (FIG. 16B); Nyquist plots for 4 wt. % ZrO₂ LLZTO compacts obtained at different temperatures (FIG. 16C); and a comparison of electronic conductivity vs. temperature extracted using titanium blocking electrode cells (FIG. 16D).

FIG. 17A-17B show a Nyquist plot for EIS performed on LLZTO pellets with varying ZrO₂ concentration (FIG. 17A), and a comparison of how the amount of ZrO₂ influences the activation energy for ionic diffusion (FIG. 17B), the room temperature ionic conductivity, and the relative density of LLZTO.

FIG. 18A-18D show galvanostatic cycling of ZrO₂-LLZTO symmetric cells (FIG. 18A) and baseline LLZTO at increasing current density for establishing the CCD; and potential and % voltage polarization vs. applied current density for ZrO₂-LLZTO (FIG. 18C) and baseline-LLZTO (FIG. 18D), respectively.

FIG. 19A-19B show galvanostatic cycling of symmetric cells employing ZrO₂-LLZTO (FIG. 19A) and baseline LLZTO (FIG. 19B), respectively.

FIG. 20A-20B show an EIS Nyquist plot for ZrO₂-LLZTO symmetric cell analysed in the as-assembled state (FIG. 20A), prior to being electrically shorted and after the short; and the same analysis for the baseline LLZTO (FIG. 20B).

FIG. 21A-21F show galvanostatic data and associated EIS data for ZrO₂-LLZTO half-cell that underwent a single electrodeposition step of 0.2 mA/cm² to a cumulative capacity of 0.3 mAh/cm² for single galvanostatic plating profile (FIG. 21A); magnified section of the plating profile taken at time scale of 0-2000 seconds (FIG. 21B), 2000-4000 seconds (FIG. 21C), and 4000-5400 seconds (FIG. 21D); EIS Nyquist plot for as-assembled ZrO₂-LLZTO half-cell (FIG. 21E); EIS Nyquist plot for ZrO₂-LLZTO half-cell that was electrically shorted (FIG. 21F).

FIG. 22A-22F show galvanostatic data and associated EIS data for baseline LLZTO half-cell that underwent a single electrodeposition step of 0.2 mA/cm² to a cumulative capacity of 0.3 mAh/cm² for single galvanostatic plating profile (FIG. 22A); magnified section of the plating profile taken at time scale of 0-2000 seconds (FIG. 22B), 2000-4000 seconds (FIG. 22C), and 4000-5400 seconds (FIG. 22D); EIS Nyquist plot for as-assembled ZrO₂-LLZTO half-cell (FIG. 22E); EIS Nyquist plot for ZrO₂-LLZTO half-cell that was electrically shorted (FIG. 22F).

FIG. 23A-23B show cryo-FIB SEM images and corresponding EDXS elemental maps of a region from the LLZTO-ZrO₂ half-cell (FIG. 23A), showing an example of crack deflection by the zirconia phase near the metal-electrolyte interface; and the same analysis for the baseline LLZTO half-cell (FIG. 23B). The half-cells were short-circuited by a single step galvanostatic procedure described in the text.

FIG. 24A-24B show cryo-FIB SEM images and corresponding EDXS elemental maps of other regions of the ZrO₂-LLZTO half-cell at the Li-SSE interface. The half-cell was short-circuited having undergone an electrodeposition step at 0.2 mA/cm² and a cumulative capacity of 0.3 mAh/cm². The arrows identify the zirconia phase in each panel.

FIG. 25A-25D show experimental setup for DCT fracture toughness measurement and DCT sample (ZrO₂-LLZTO) after fracture (FIG. 25A), load vs. displacement plot of ZrO₂-LLZTO and baseline LLZTO (FIG. 25B), yielding a K_{1c}=1.33 MPa m^{0.5} and K_{1c}=1.13 MPa m^{0.5} respectively. SEM images of fractured surface of ZrO₂-LLZTO sample (FIG. 25C) and baseline LLZTO sample (FIG. 25D).

FIG. 26A-26H show as prepared sample following ASTM standards using nano and femtosecond laser (FIG. 26A); notch prepared using FS laser (FIG. 26B); fracture surface SEM of ZrO₂-LLZTO in the fracture regime (FIGS. 26C-26E); and the same analysis for baseline LLZTO sample (FIGS. 26F-26H).

FIG. 27A-27F show optimized atomic bulk and surface structures for ZrO₂ (FIGS. 27A-27C) and LLZTO (FIGS. 27D-27F). In FIG. 27D, L1-L4 indicate the four Zr layers where Ta ions can occupy. F is the fracture energy to cleave the two surfaces. Excess electron charge density distribution for ZrO₂ (111) surface (FIG. 27B) and Ta-segregated LLZTO (110) surface (FIG. 27E) are shown in (FIG. 27C) and (FIG. 27F), respectively. The excess electron density is 0.0021 Å⁻² and the iso-surface level is 0.0001 Å⁻³.

FIG. 28A-28B show total DOS for the bulk and surface structures of ZrO₂ (FIG. 28A) and LLZTO (FIG. 28B). The vacuum level (dashed line) is determined using the work function of LLZO (4.13 eV). The Li Fermi level (solid line) is calculated using the Li work function (3.05 eV) and the Li⁺/Li⁰ deposition potential (dashed line) is 1.39 eV below the vacuum level.

FIG. 29A-29F show a schematic illustration of the Li metal anode and SSE domains (FIG. 29A), where the solid electrolyte microstructure consists of grains and grain boundaries; zoomed in representation of the Li/SSE interface consisting of Li/grain and Li/grain boundary interfaces (FIG. 29B); effect of mechanical mismatch (Young's modulus ratio) and transport mismatch (defined by ion occupation descriptor χ=−RT ln(κ_{gb}/κ_{g}) (FIG. 29C), where κ_{gb}/κ_{g} is the ionic conductivity ratio) between grain and grain boundary on reaction distribution at the Li/SSE interface represented as the ratio of reaction current density in the grain boundary to that in the grain; reaction current profile at the Li/SSE interface for the model domain shown in (FIG. 29B) for baseline and toughened LLZTO (FIG. 29D); crack deflection vs. crack penetration analysis suggesting that the crack is deflected by the grain boundary for the toughened LLZTO (FIG. 29E); and crack propagation mechanism for the toughened LLZTO (FIG. 29F).

### DETAILED SPECIFICATION

Some references, which may include various patents, patent applications, and publications, are cited in a reference list and discussed in the disclosure provided herein. The citation and/or discussion of such references is provided merely to clarify the description of the present disclosure and is not an admission that any such reference is “prior art” to any aspects of the present disclosure described herein. In terms of notation, “[n]” corresponds to the n^{th} reference in the list. All references cited and discussed in this specification are incorporated herein by reference in their entireties and to the same extent as if each reference was individually incorporated by reference.

Although example embodiments of the present disclosure are explained in some instances in detail herein, it is to be understood that other embodiments are contemplated. Accordingly, it is not intended that the present disclosure be limited in its scope to the details of construction and arrangement of components set forth in the following description or illustrated in the drawings. The present disclosure is capable of other embodiments and of being practiced or carried out in various ways.

It must also be noted that, as used in the specification and the appended claims, the singular forms “a,” “an,” and “the” include plural referents unless the context clearly dictates otherwise. Ranges may be expressed herein as from “about” or “5 approximately” one particular value and/or to “about” or “approximately” another particular value. When such a range is expressed, other exemplary embodiments include from the one particular value and/or to the other particular value.

By “comprising” or “containing” or “including” is meant that at least the name compound, element, particle, or method step is present in the composition or article or method, but does not exclude the presence of other compounds, materials, particles, method steps, even if the other such compounds, material, particles, method steps have the same function as what is named.

In describing example embodiments, terminology will be resorted to for the sake of clarity. It is intended that each term contemplates its broadest meaning as understood by those skilled in the art and includes all technical equivalents that operate in a similar manner to accomplish a similar purpose. It is also to be understood that the mention of one or more steps of a method does not preclude the presence of additional method steps or intervening method steps between those steps expressly identified. Steps of a method may be performed in a different order than those described herein without departing from the scope of the present disclosure. Similarly, it is also to be understood that the mention of one or more components in a device or system does not preclude the presence of additional components or intervening components between those components expressly identified.

The expressions “ambient temperature” and “room temperature” as used herein are understood in the art and refer generally to a temperature from about 20 □C to about 35° C.

As used herein, the term “composition” is intended to encompass a product comprising the specified ingredients in the specified amounts, as well as any product which results, directly or indirectly, from a combination of the specified ingredients in the specified amounts.

References in the specification and concluding claims to parts by weight of a particular element or component in a composition denotes the weight relationship between the element or component and any other elements or components in the composition or article for which a part by weight is expressed. Thus, in a mixture containing 2 parts by weight of component X and 5 parts by weight, components Y, X, and Y are present at a weight ratio of 2:5 and are present in such ratio regardless of whether additional components are contained in the mixture.

A weight percent (wt. %) of a component, unless specifically stated to the contrary, is based on the total weight of the formulation or composition in which the component is included.

It will be understood that when an element is referred to as being “connected” or “coupled” to another element, it can be directly connected or coupled to the other element, or intervening elements may be present. In contrast, when an element is referred to as being “directly connected” or “directly coupled” to another element, there are no intervening elements present. Other words used to describe the relationship between elements or layers should be interpreted in a like fashion (e.g., “between” versus “directly between,” “adjacent” versus “directly adjacent,” “on” versus “directly on”).

Notwithstanding that the numerical ranges and parameters setting forth the broad scope of the disclosure are approximations, the numerical values set forth in the specific examples are reported as precisely as possible. Any numerical value, however, inherently contains certain errors necessarily resulting from the standard deviation found in their respective testing measurements. Furthermore, when numerical ranges of varying scope are set forth herein, it is contemplated that any combination of these values inclusive of the recited values may be used. Further, ranges can be expressed herein as from “about” one particular value and/or to “about” another particular value. When such a range is expressed, another aspect includes from the one particular value and/or to the other particular value.

Similarly, when values are expressed as approximations, by use of the antecedent “about,” it will be understood that the particular value forms another aspect. It will be further understood that the endpoints of each of the ranges are significant both in relation to the other endpoint and independently of the other endpoint. Unless stated otherwise, the term “about” means within 5% (e.g., within 2% or 1%) of the particular value modified by the term “about.”

Similarly, numerical ranges recited herein by endpoints include subranges subsumed within that range (e.g., 1 to 5 includes 1-1.5, 1.5-2, 2-2.75, 2.75-3, 3-3.90, 3.90-4, 4-4.24, 4.24-5, 2-5, 3-5, 1-4, and 2-4). It is also to be understood that all numbers and fractions thereof are presumed to be modified by the term “about.”

It will be understood that, although the terms “first,” “second,” etc., may be used herein to describe various elements, components, regions, layers, and/or sections. These elements, components, regions, layers, and/or sections should not be limited by these terms. These terms are only used to distinguish one element, component, region, layer, or section from another element, component, region, layer, or section. Thus, a first element, component, region, layer, or section discussed below could be termed a second element, component, region, layer, or section without departing from the teachings of example embodiments.

As used herein, the term “substantially” means that the subsequently described event or circumstance completely occurs or that the subsequently described event or circumstance generally, typically, or approximately occurs.

Still further, the term “substantially” can in some aspects refer to at least about 80%, at least about 85%, at least about 90%, at least about 91%, at least about 92%, at least about 93%, at least about 94%, at least about 95%, at least about 96%, at least about 97%, at least about 98%, at least about 99%, or about 100% of the stated property, component, composition, or other condition for which substantially is used to characterize or otherwise quantify an amount.

In other aspects, as used herein, the term “substantially free,” when used in the context of a composition or component of a composition that is substantially absent, is intended to refer to an amount that is then about 1% by weight, e.g., less than about 0.5% by weight, less than about 0.1% by weight, less than about 0.05% by weight, or less than about 0.01% by weight of the stated material, based on the total weight of the composition.

As used herein, the terms “substantially identical reference composition,” “substantially identical reference article,” or “substantially identical reference electrochemical cell” refer to a reference composition, article, or electrochemical cell comprising substantially identical components in the absence of an inventive component. In another exemplary aspect, the term “substantially,” in, for example, the context “substantially identical reference composition,” or “substantially identical reference article,” or “substantially identical reference electrochemical cell” refers to a reference composition, article, or an electrochemical cell comprising substantially identical components and wherein an inventive component is substituted with a common in the art component.

The devices, systems, and methods of the appended claims are not limited in scope by the specific devices, systems, and methods described herein, which are intended as illustrations of a few aspects of the claims. Any devices, systems, and methods that are functionally equivalent are intended to fall within the scope of the claims. Various modifications of the devices, systems, and methods, in addition to those shown and described herein, are intended to fall within the scope of the appended claims. Further, while only certain representative devices, systems, and method steps disclosed herein are specifically described, other combinations of the devices, systems, and method steps also are intended to fall within the scope of the appended claims, even if not specifically recited. Thus, a combination of steps, elements, components, or constituents may be explicitly mentioned herein or less; however, other combinations of steps, elements, components, and constituents are included, even though not explicitly stated.

Although several embodiments of the invention have been disclosed in the foregoing specification, it is understood by those skilled in the art that many modifications and other embodiments of the invention will come to mind to which the invention pertains, having the benefit of the teaching presented in the foregoing description and associated drawings. It is thus understood that the invention is not limited to the specific embodiments disclosed hereinabove and that many modifications and other embodiments are intended to be included within the scope of the appended claims. Moreover, although specific terms are employed herein, as well as in the claims which follow, they are used only in a generic and descriptive sense and not for the purposes of limiting the described invention nor the claims which follow.

Unless defined otherwise, all technical and scientific terms used herein have the same meanings as commonly understood by one of skill in the art to which the disclosed invention belongs. Publications cited herein and the materials for which they are cited are specifically incorporated by reference.

While aspects can be described and claimed in a particular statutory class, such as the system statutory class, this is for convenience only and one of ordinary skill in the art will understand that each aspect of the present invention can be described and claimed in any statutory class. Unless otherwise expressly stated, it is in no way intended that any method or aspect set forth herein be construed as requiring that its steps be performed in a specific order. Accordingly, where a method claim does not specifically state in the claims or descriptions that the steps are to be limited to a specific order, it is in no way intended that an order be inferred in any respect. This holds for any possible non-express basis for interpretation, including matters of logic with respect to arrangement of steps or operational flow, plain meaning derived from grammatical organization or punctuation, or the number or type of aspects described in the specification.

In view of the described processes and compositions, hereinbelow are described certain more particularly described aspects of the inventions. These particularly recited aspects should not, however, be interpreted to have any limiting effect on any different claims containing different or more general teachings described herein, or that the “particular” aspects are somehow limited in some way other than the inherent meanings of the language and formulas literally used therein.

The present invention may be understood more readily by reference to the following detailed description of various aspects of the invention and the examples included therein and to the Figures and their previous and following description.

In exemplary aspects, an electrochemical cell may comprise a solid-state electrolyte (SSE) electrolyte comprising two or more separate phases, wherein at least one phase is an ion-conductive phase; and wherein at least one phase is a toughening phase.

In some aspects, the toughening phase may be structurally and/or chemically different from the ion-conductive phase.

The SSE may vary structurally in various aspects. In some aspects, the io-conductive phase may be dispersed through the bulk of the SSE and the toughening phase may be dispersed at one or more grain boundaries of the ion-conductive phase. In other aspects, the SSE may comprise two or more ion-conductive phases and two or more toughening phases, such that at least one of the two or more toughening phases behave as an interphase between the two or more ion-conductive phases. In yet other aspects, the at least one toughening phase may be disposed on at least the first and/or second surface of the SSE.

In some aspects, the at least one toughening phase may be ion-conductive or ion-insulating. In some aspects, the at least one toughening phase may be electron insulating.

The SSE may be configured to prevent fracture and dendrite growth during cell operation and/or storage by the presence of the toughening phase.

The toughening phase may comprise ZrO₂, Y₂O₃, Yttria-stabilized zirconia (YSZ), (ZrO₂)₁₋ₓ(Y₂O₃)ₓ where 0.001≤x≤0.999. In some aspects, the toughening phase may comprise zirconia toughened alumina (ZTA) based on xZrO₂-yAl₂O₃ where x+y=1, mixed oxide ceramics, 20% ZrO₂ and 80% Al₂O₃, magnesium oxide ceramics, MgO, beryllium oxide ceramics, BeO, or mullite ceramics based on x(Al₂O₃)y(SiO₂) where x=2 and y=3 or x=2 and y=1. In yet other aspects, the toughening phase may comprise zirconia toughened mullite (ZTM) based on x(ZrO₂)_{y}(Al₂O₃)_{z}(SiO₂) where x=0.25, y=2 and z=3, phase transforming ceramics, or PZT lead zirconate titanate Pb[ZrₓTi₁₋ₓ]O₃ where 0≤x≤1. In consideration of the above compositions of toughening phase, the toughening phase may comprise oxygen-rich or oxygen-deficient versions thereof, alloys thereof, multiphase composites thereof, or a combination thereof.

In some aspects, the toughening phase may comprise ZrO₂ and/or metal boride. In other implementations, the toughening phase may comprise tantalum diboride (TaB₂), ZrB₂, HfB₂, or combinations thereof. In another implementations, the toughening phase may comprise oxide-carbide, oxide-boride composite particles, or combinations thereof. In yet other implementations, the toughening phase may comprise composite particles of ZrO₂—WC, TiO₂—TiB, or combinations thereof.

In some aspects, the toughening phase may exhibit morphology of equiaxed spherical, cuboidal, ill-defined particulate, plate-like, whiskers, or combinations thereof. The toughening phase blocks cracks and dendrites in the SSE through primary and secondary crack deflection mechanisms.

In some implementations, the toughening phase is present in the SSE in a range from about 0.1% to about 50% by weight. In other aspects, the toughening phase may be present in the SSE at about 0.5% by weight, about 0.75% by weight, about 1.0% by weight, about 1.5% by weight, about 2.0% by weight, about 3% by weight, about 4% by weight, about 5% by weight, about 6% by weight, about 7% by weight, about 8% by weight, about 9% by weight, about 10% by weight, about 15% by weight, about 20% by weight, about 25% by weight, about 30% by weight, about 35% by weight, about 40% by weight, or about 45% by weight.

In some implementations, the ion-conductive phase may comprise oxides, sulfides, borides, phosphides and other inorganic systems. The SSE may comprise garnets, argyrodites, lithium phosphorus oxynitrides, NASICON-type, LISICON-types, beta-alumina, sulfides and halides, thiophosphates, or combinations thereof.

In other implementations, the ion-conductive phase comprises LLZO (Li₇La₃Zr₂O₁₂); Li₆AS₅X, wherein A=P, Sb and X═Cl, Br, I; or Na₃AB₄ or K₃AB₄, wherein A is P, Sb, or As and B is S or Se. The ion-conductive phase may be further ion-conductive phase doped with Ta, Nb, Zr, Mg, B, Si, Mo, or any combination thereof.

In certain aspects, the ion-conductive phase may exhibit ionic conductivity from about 5.0×10⁻⁴ to about 1.0×10⁻³ S/m or more. In certain aspects, the SSE may exhibit ionic conductivity of about 5.5×10⁻⁴ S/m, about 6.5×10⁻⁴ S/m, about 7.5×10⁻⁴ S/m, about 8.5×10⁻⁴ S/m, about 9.5×10⁻⁴ S/m, about 1.5×10⁻³ S/m, or more.

The disclosed electrochemical cell may comprise an anode material such that the anode material may comprise Li, Na, K, Zn, Mg, Li alloys, Li intermetallics, Li compounds, Na alloys, Na intermetallics, Na compounds, K alloys, K intermetallics, K compounds or any combination thereof.

The disclosed electrochemical cell may also comprise a cathode material such that the cathode material may comprise copper, carbon, graphite, sodium, potassium, lithium, magnesium, calcium, aluminum, layered oxides, vanadium-based cathode, sulfur-based cathode, spinels, olivines, or any combination thereof.

In some implementations, a layer comprising Ga, Al₂O₃, or a combination thereof may be disposed on the first and/or second surface of the solid-state electrolyte. In other implementations, the SSE includes at least one electron-conducting phase. The electron-conducting phase is disposed on the first or the second surface of the solid-state electrolyte.

An exemplary electrochemical cell comprising a SSE, itself comprising a toughening phase, may be a symmetrical cell, a half cell, or any other known cell configuration.

In some aspects, the electrochemical cell may exhibit continuous plating of about 0.1-10 mAh/cm⁻² operating at 25-100° C. for 2-5000 cycles at capacity of about 0.1-10 mA/cm⁻².

An exemplary method to make an electrochemical cell is disclosed. The method may comprise incorporating at least one toughening additive into a solid-state electrolyte. The toughening additive may be incorporated into the SSE during any stage of mixing, milling, or sintering.

In exemplary aspects, a method includes incorporating at least one toughening additive into a solid-state electrolyte. The at least one toughening additive may be incorporated into the solid-state electrolyte by any of mixing, milling or sintering, post-sintering impregnation and post-sintering surface coating based on physical or chemical vapor deposited thin films, or wet chemical synthesis. In some aspects, the toughening additive melts, reacts, dissolves, phase transforms, or precipitates during processing.

In some aspects, the toughening additive includes a metal carbide, a metal oxide, a metal nitride, a metal oxynitride, or a metal boride.

In some aspects, the toughening additive includes TaC, MoC, SiC, WC, WC—(Fe, Ni, C), TiC, TaC, NbC, WC—Co, carbon rich or carbon deficient versions of thereof, alloys thereof, multiphase composites thereof, or a combination thereof.

In some aspects, the toughening additive includes TaN, MoN, SiN, W3N2, TiN, NbN, nitrogen rich or nitrogen deficient versions thereof, alloys thereof, multiphase composites thereof, or a combination thereof.

In some aspects, the toughening additive includes TaNₓO₁₋ₓ where 0.001≤x≤0.999, MoNₓO₁₋ₓ, SiNₓO₁₋ₓ, W₃N₂ₓO₁₋ₓ, TiNₓO₁₋ₓ, NbNₓO₁₋ₓ, nitrogen rich or nitrogen deficient versions of thereof, alloys thereof, multiphase composites thereof, or a combination thereof.

In some aspects, the toughening additive includes (TaB₂), ZrB₂ and HfB₂, boron rich or boron deficient versions of thereof, alloys thereof, borides containing oxygen, TaB₂O₁₋ₓ where 0.001≤x≤0.999, multiphase composites thereof, or a combination thereof.

In other aspects, the toughening additive includes metal dichalcogenides.

In some aspects, the toughening additive includes Te, Se, S, MoS₂, MoSe₂, MoTe₂, WS₂, and/or WSe₂.

In some aspects, the toughening additive promotes densification of the solid-state electrolyte during sintering, resulting in higher final compact density of the solid-state electrolyte including the toughening additive than for a given processing regiment of a solid-state electrolyte not including the toughening additive.

In some aspects, the toughening additive is about 5% by weight of the solid-state electrolyte.

In some aspects, the method further includes providing an electron-conductive phase onto one or more surfaces of the solid-state electrolyte.

### EXAMPLES

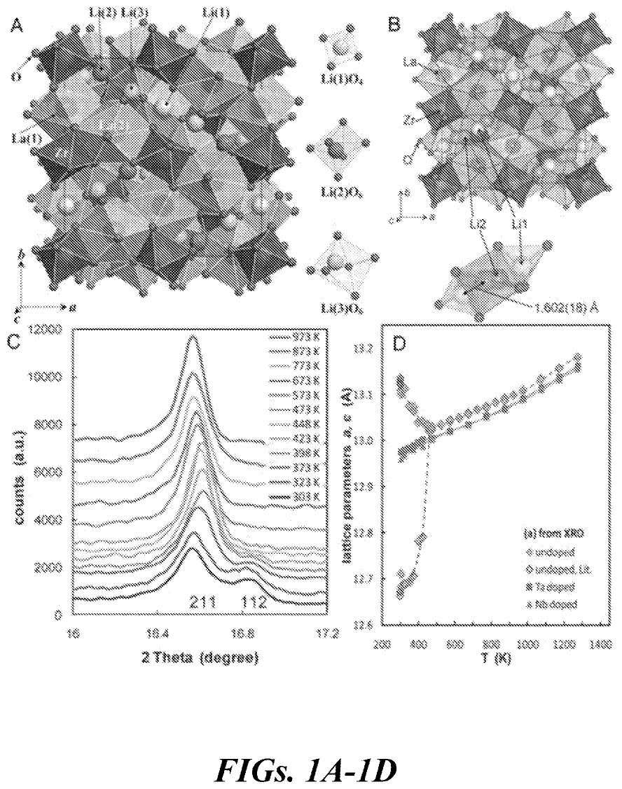

Structure and Ionic Conductivity of Garnet LLZO. Garnet Li₇La₃Zr₂O₁₂ (LLZO) is a well-explored superionic conductor SSE due to its relatively favorable ionic conductivity and kinetic (not thermodynamic) stability relative to Li metal and ceramic cathodes.¹⁴⁶⁻¹⁵¹ There are two crystal structures of LLZO, tetragonal phase (t-LLZO) and cubic phase (c-LLZO). These structures are illustrated in FIGS. 1A and 1B, respectively.^{142,152} The space group of the tetragonal structure LLZO is I4₁/acd with a lattice constant of a=13.134(4) Å, c=12.663(8) Å,¹⁴² while the space group of cubic structure LLZO is Ia3̅d with a lattice constant of a=13.03 Å (520 K).¹⁴¹ In both t-LLZO and c-LLZO, Zr⁴⁺ occupies the ZrO₆ octahedral site and the larger diameter La³⁺ occupies eightfold coordinated LaO₈ dodecahedra. The difference in these two structures is the Li⁺ sites, which is the primary reason for the difference in the ionic conductivity. In t-LLZO, all the three Li⁺ positions (Li1 located at tetrahedral 8a, Li2 located at octahedral 16f, and Li3 at octahedral 32g) are fully occupied, while in c-LLZO, two kinds of Li⁺ (Li1, tetrahedral 24d, Li2, octahedral 96h) are only partly occupied. For c-LLZO, positions of Li1 and Li2 are close to each other (1.602 Å). The repulsion between lithium ions with such short distance makes it impossible to fully occupy the adjunct sites.¹⁵² For example, the Li1 site is occupied with the two adjacent Li2 positions being vacant, and the lithium ions will migrate along this path (from Li1 site to the adjacent empty Li2 site or vice versa). Besides the enriched vacancies and the short jump distance, it has been found that collective motion of strongly correlated Li-ions in c-LLZO also contributes to its superionic conductivity.¹⁰²

The ionic conductivity of the c-LLZO is two orders of magnitude above that of the tetragonal phase, but the t-LLZO structure is more stable at room temperature. Computational modeling, employing implementations of Density Functional Theory demonstrated that the phase stability of t-LLZO is determined by a simultaneous ordering of the Li ions on the Li sublattice, and a volume-preserving tetragonal distortion that relieves internal structural strain.¹⁵³ also It was demonstrated that high-valent doping (Al³⁺ at Li⁺ site¹⁴³ or Nb⁵⁺/Ta⁵⁺ at Zr⁴⁺ site^{141,154,155}) will introduce vacancies into the Li sublattice, which reduces the Li-ion population and Li-ion coulombic repulsion in the framework and stabilizes the elevated-temperature cubic phase by reducing the free energy gain from ordering. The critical temperature for cubic phase stability is lowered as the Li vacancy concentration is increased, with the cubic structure being favored as the vacancy number per formula unit is increased to 0.5 and above.

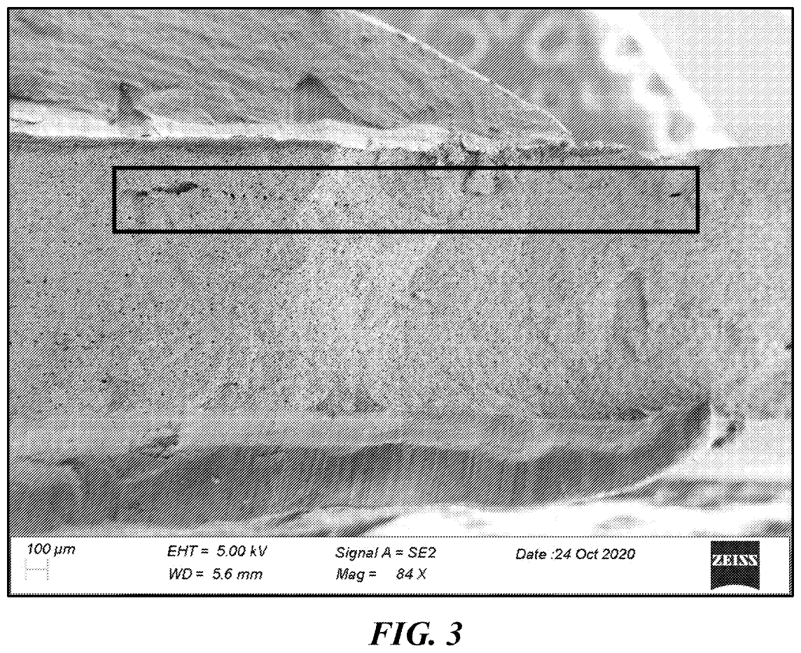

Computational simulations and experimental analysis were combined to examine the correlation between structure and ion mobility in Li₇₋ₓLa₃(Zr₂₋ₓMₓ)O₁₂ (x=0, 0.25; M=Ta⁵⁺, Nb⁵⁺).¹⁴¹ It was demonstrated that pentavalent doping enhances ionic conductivity by increasing the vacancy concentration and by reducing the Li ordering. Moreover, at elevated temperatures, the Li is gradually redistributed to the tetrahedral sites up to a site occupancy factor equaling 0.56. The in-situ XRD analysis demonstrated that the tetragonal to cubic phase transition occurred above 177° C. for Li₇La₃Zr₂O₁₂. These in-situ XRD results and obtained lattice parameters are illustrated in FIGS. 1C and 1D. Above the phase transition temperature, the (211) and (112) peaks from t-LLZO merge together due to the higher symmetry of c-LLZO. High valence Ta⁵⁺/Nb⁵⁺ doping at the Zr⁴⁺ site successfully reduced the phase transition temperature, with no transition to tetragonal phase at room temperature. This is illustrated in FIG. 3(D), which demonstrates the effect of doping on the lattice parameters as a function of temperature.

Chemical Stability of Garnet LLZO. One disadvantage of LLZO is that it is known to degrade in humid air and to form reaction layers when exposed to air.^{154,156} The reaction between LLZO and moisture is conceptualized according to equations 1 and 2:

$${Li}_{7} {La}_{3} {Zr}_{2} {O}_{12} + x {H}_{2} O \to {Li}_{7 - x} {H}_{x} {La}_{3} {Zr}_{2} {O}_{12} + x LiOH \qquad ( 1 )$$

$$LiOH + 1 / 2 {CO}_{2} \to 1 / 2 {Li}_{2} {CO}_{3} + 1 / 2 {H}_{2} O \qquad ( 2 )$$

The Li⁺/H⁺ exchange has a strong negative impact on the ionic conductivity of the LLZO.^{154,156} In addition, the Li₂CO₃ formation layer blocks ion transfer at the interface,¹⁵⁷ leading to a major increase in interface resistance.¹⁵⁸ First-principle calculations showed that the work of adhesion between Li and Li₂CO₃ (0.1 J/m²) is less than that between Li and LLZO (0.67 J/m²), leading to increased wetting contact angle (142° vs. 62°) and increased interfacial resistance (400 Ω/cm² vs. 2 Ω/cm²).¹⁵⁹ The Li₂CO₃ can be removed by wet polishing followed by heating at elevated temperature (>500° C.), leading to a reduction of interfacial resistance from 400 Ω/cm² to 2 Ω/cm².¹⁵⁹ Li₂CO₃ on the surface of LLZO also affects the ionic transport through the PEO-LiTFSI polymer and LLZO interface, due to the Li₂CO₃ layer as a barrier for charge transfer.^{157,160} The area-specific resistance (ASR) between LLZO and PEO can be up to 14.57 kΩ·cm² with Li₂CO₃ on the surface, which can be reduced to only 0.20 kΩ·cm² after removing Li₂O₃ at 700° C.¹⁶⁰

Reaction between Garnet LLZO and Li Metal Anode. Another issue with LLZO is its reactivity with the lithium metal anode. When in contact, excess Li⁺ is able to occupy the Li sites in the cubic LLZO, according to the following equation:³²

$$2 {Li}_{( s )} + {V}_{O}^{\cdot \cdot } ( LLZO ) \to 2 {Li}_{i}^{\cdot } ( LLZO ) + {V}_{O}^{\times } ( LLZO ) \qquad ( 3 )$$

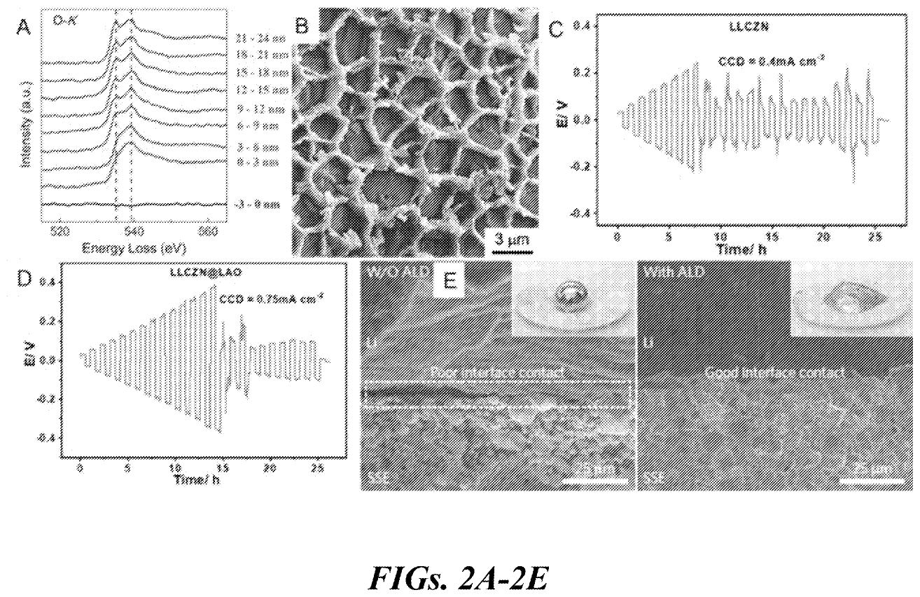

The back filling of Li⁺ makes cubic LLZO unstable at room temperature, making it gradually transform to tetragonal LLZO. This conclusion is directly supported by Electron Energy Loss Spectroscopy (EELS), Transmission Electron Microscope (TEM) analysis, and the associated schematic shown in FIG. 2A.¹⁴⁶ The evolution of the oxygen K-edges in the EELS spectra demonstrates this transformation, where ~6 nm interface layer of LLZO becomes tetragonal. Further decomposition to ZrO_{y} compounds at the LLZO/Li interface also occurs under such reducing conditions (0 V vs. Li/Li⁺). This conclusion is based on Density Functional Theory (DFT) simulations and separately on analysis of the XPS spectra of the interface lawyer.^{161,162} As a positive attribute, however, the interphase layer derived from the reaction between LLZO and Li is kinetically stable, ensuring that the bulk c-LLZO material remains unchanged even after extended contact with Li metal.¹⁴⁶

Dendrite Growth with Garnet LLZO. A major secondary problem for LLZO in contact with Li is dendrite formation and growth, which can lead to battery short circuits during extended cycling.¹⁶⁶ During ongoing charging-discharging, the Li⁺ ions migrate between the anode and cathode through the solid electrolyte.¹⁶⁷ With a fully homogeneous solid electrolyte having a constant ion diffusion resistance, the reduction of voltage would be linear from the cathode to the anode.¹⁶⁸ The voltage away from the anode would always be larger than 0 V vs. Li/Li⁺, making it thermodynamically impossible to form Li dendrites inside the solid electrolyte. However, the lower ionic conductivity at grain boundaries and pores leads to enriched Li⁺ concentration and a cathodic overpotential sufficient for metal nucleation.^{169,170 165,171,172} There is also an additional ionic resistance—enhanced electrical conductivity due to the reaction layer(s) formed at the anode-SEE interface. This would further exacerbate the non-uniform field distribution and drive metal nucleation away from the anode. In parallel, there may be enough electrical conductivity around such sites to allow for local reduction of Li⁺ to form the dendrites. Due to this combination of process-enhanced cathodic overpotentials and localized electrical conductivity, metal dendrite formation on LLZO is a major impediment towards its utilization on full battery cells. Cheng et al. have directly observed that Li metal propagated along the interconnected grain boundaries in polycrystalline Li_{6.25}Al_{0.25}La₃Zr₂O₁₂ ceramic electrolyte.¹⁶³ FIG. 2B illustrates this phenomenon, the SEM images showing the Li metal decorating the grain boundaries. Qi et al. developed a phase-field model to examine the impact of excess surface electrons on the Li dendrite growth morphology in polycrystalline LLZO.¹⁷³ The model successfully explained the experimentally observed dendrite intergranular growth and revealed that the trapped electrons may produce isolated Li-metal nucleation, leading to a sudden increase of Li-dendrite penetration depth.

The local overpotential is affected by site-specific ion diffusion limitations (space charge layer effects,¹⁷⁴ defect relaxation and resistance polarization) and localized current density variations.^{32,175} Solid electrolyte defects such as grain boundaries, pore surfaces and other interfaces typically possess lower ion diffusivity than the bulk crystal,¹⁷⁶ leading to site-specific concentration polarization.³² In parallel, SSEs may possess increased electrical conductivity compared to the bulk crystal, still being low but now sufficient to allow reduction of Li ions to Li metal.¹⁷⁷ In fact, Wang et al. revealed that electrical conductivity is one important condition for the formation of dendrites.¹⁷⁸ Once electrically shorted, there is mixed electron-ionic conduction, leading the charge-discharge curve of a symmetric Li/SSE/Li cell to be relatively flat with minimum polarization.¹⁷⁹ An increasing charging current density would favor both affects; promoting a greater localized cathodic overpotential due to diffusional limitations and increasing localized electron current density. Dendritic lithium has been observed in LLZO solid electrolytes, which has a relatively high electrical conductivity of 5.5×10⁻⁸ S/cm at 30° C.¹⁷⁸ By contrast, the electrical conductivity of LiPON is measured to be in the 10⁻¹⁵ to 10⁻¹² S/cm range.¹⁸⁰ This helps to explain why Li dendrites have not been reported in the LiPON electrolyte.

It should be pointed out that dendrite formation in SSE electrolytes is a complex process that is not fully understood.¹⁷⁵ Lithium growth and penetration through solid electrolytes is fundamentally different from conventional dendrite growth in liquid electrolytes.³² According to the Monroe and Newman model, dendrite growth can be suppressed if the shear modulus of SSE or separator is twice to the shear modulus of lithium (4.8 GPa at 298 K).¹⁸¹ Several SSEs are reported to possess relatively high elastic modulus, such as garnet-type Li₇La₃Zr₂O₁₂ (LLZO) (~100 GPa),¹⁸² β-Li₃PS₄ (10-12 GPa).¹⁸³ However, Li dendrite can still form and propagate in these high-strength SE-based batteries.¹⁵⁹ It is likely that the interface kinetics are non-uniform, depending on localized variations in surface chemistry, reaction layers that may be present, grain boundary orientation, pores, impurities, etc.^{32,175} This creates major challenges in predicting or controlling dendrites in experimentally synthesized SSE materials, which are naturally full of defects such as pores and grain boundaries, as well as containing voids at the anode-SSE interface. Based on such understanding of dendrite formation, targeted strategies can improve the operating current density and cycle life of all solid-state batteries.^{25,32} These include reducing the levels of porosity and grain boundary area, which minimizes the grain boundary ionic resistance. Akimoto et al. successfully fabricated large size garnet-type Li₇₋ₓLa₃Zr₂₋ₓNbₓO₁₂ single crystals without grain boundaries and voids, using flotation zone method.¹⁸⁴ As a result, this single-crystal Li₇₋ₓLa₃Zr₂₋ₓNbₓO₁₂ delivered a total ion conductivity of 10⁻³ S/cm at room temperature and a critical current density (CCD, the largest current density allowed without shorting) of 0.5 mA/cm², both values being considered quite favorable.

Decreasing the electrical conductivity is another effective way to suppress dendrite formation, especially at interfaces, grain boundaries and pores, where dendrites are most likely to form.^{163,171,172} Qi et al. simulated the performance of surface modified LLZO with an insulating layer of Li₂PO₂N, showing that this approach is effective in suppressing dendrite formation.¹⁷⁷ Pan et al. reported that a 5 nm layer of LiAlO₂ (LAO) coated onto the grain surfaces of LLZO prior to sintering results in an improved critical current density for the onset of dendrite growth 0.4 mA/cm² to 0.75 mA/cm². These findings are illustrated in FIGS. 2C and 2D.¹⁶⁴ It was found that when the external voltage was less than 0.4 V, the electrical conductivity was constant. However, as the voltage was increased to over 0.5 V, the electrical conductivity of the solid-state electrolytes would gradually also increase.¹⁶⁴ The change in conductivity was =1.25×10⁻⁸ S/cm at 0.3 V to 3.59×10⁻⁸ S/cm at 1 V (LLZO) and =5.2×10⁻⁹ S/cm at 0.3 V to 1.01×10⁻⁸ S/cm at 1 V (LAO coated LLZO). It was argued that the increased electrical conductivity originated from the grain boundaries, since the polarization voltage was sufficiently large (around 0.5 V in total) to make them electrically conductive. After coating a 5 nm thin insulating buffer layer of LiAlO₂ (LAO) at the grain boundary, the electrical conductivity was effectively reduced, leading to an increased CCD. As FIGS. 2C and 2D indicate, the measured CCD was 0.75 mA/cm², while for the baseline pristine LLCZN this value was 0.4 mA/cm².

Hu et al. reported atomic layer deposition (ALD) grown 5-6 nm layer of Al₂O₃ on the surface of LLZO, leading to a significant decrease of interfacial impedance, from 1,710Ω cm² to 1Ω cm².¹⁶⁵ Experimental and computational results reveal that Al₂O₃ coating enables wetting of metallic lithium in contact with the garnet electrolyte surface. The lithiated alumina interface allowed for more effective Li ion transport between the lithium metal anode and garnet electrolyte, as illustrated in FIG. 2E. With the significantly reduced interfacial resistance after the ALD Al₂O₃ modification, the symmetric Li/SE/Li cell was cyclable at a current density of 0.2 mA/cm² for tens of cycles. By contrast, the baseline specimen without the ALD modification short circuited at only 0.1 mA/cm².¹⁶⁵

Reaction between Garnet LLZO and the Cathode. The electrochemical window of LLZO based on first-principle simulations indicates that LLZO is unstable above 2.91 V vs. Li/Li⁺.^{162,185} However, the cyclic voltammetry of Li/LLZO/LLZO+C/Pt cell indicates that LLZO starts to be oxidized at 4 V. The increased voltage compared to theoretical predictions can be explained by kinetic impediments toward decomposition, leading to large overpotential. X-ray photoelectron spectroscopy (XPS) results indicate that the molar ratio of 0 to Zr decreases from 7.6 to 4.9 when charging to 4.5 V, which confirms that 02 was released during charging.¹⁶² However, this oxidization is kinetically sluggish, especially after passivation layer of zirconium and lanthanum oxides formed.¹⁶² According to the cyclic voltammetry of Li/LLZO/LLZO+C/Pt cell, the oxidization of LLZO with releasing 02 was suppressed after the first cycle, with less than 1 μA peak current vs. 5 μA for the first charge process.¹⁶² All-solid-state battery (ASSB) with LLZO electrolyte and LCO cathode can still cycle for over 100 cycles, with high-capacity retention (98%).¹⁸⁶ Other cathodes like LiFePO₄ (≈3.4 V), S (≈2.2 V) with lower potential vs. Li/Li⁺ are also compatible with LLZO electrolyte.¹⁸⁶ ASSB of LiFePO₄/LLZO/Li retains over 130 mAh/g capacity after 50 cycles (65° C., 200 μA/cm²), while for S/LLZO/Li battery, 800 mAh/g capacity can be retained after 60 cycles (65° C., 200 μA/cm²).¹⁸⁶

Employing LLZO for fabricating high-power all-solid-state batteries remains a challenge, even with an ionic conductivity close to 1 mS/cm. As shown in Table 1, an all-solid-state battery with Li metal anode, LLZO solid electrolyte, and LiCoO₂ cathode obtains capacity of 0.274 mAh/g at a low current density of 2 μA/cm².¹⁸⁷ The key impediment to faster rate performance is the resistance of the cathode-LLZO interface, as reported by Yoshida et al.¹⁸⁷ In one example, LiCoO₂/LLZO pellet/Li metal architecture was employed, measuring the total impedance of the cell to be 1 MΩ.¹⁸⁷ The excessive interfacial resistance, in turn, may be attributed to one or a combination of several factors, including poor physical contact, (electro)chemical instability, stress and space charge layer.¹⁴⁷ Directly depositing the cathode onto the LLZO,¹⁸⁸ high temperature sintering,¹⁸⁹ or filling the gap between the cathode and the LLZO with secondary soft and ionically conductive electrolytes (PEO polymer electrolyte, Li_{2.3}C_{0.7}B_{0.3}O₃ glass electrolyte et al.) can reduce the interfacial resistance.^{147,186} For example, Ohta et al. deposited LiCoO₂ on the surface of LLZNO by pulsed laser deposition (PLD). The total resistance of this Li/LLZNO/LiCoO₂ battery was reduced to only 700Ω versus the typical 1 MΩ (Table 1).^{187,188} However, the areal capacity remained relatively low (3.5 μAh/cm² vs. typical 3 mAh/cm² of 18650 cell¹⁹⁰), due to the mass loading of the cathode (0.27 mg/cm² vs. typical 20 mg/cm² of 18650 cell¹⁹⁰).¹⁸⁸ Sintering at high temperature can improve the contact between LLZO and cathodes, but most cathodes would react with LLZO at high temperatures and form interface layer between them. Chiang et al.¹⁸⁹ used X-ray photoelectron spectroscopy, secondary ion mass spectroscopy, and energy-dispersive X-ray spectroscopy to track the reaction between LLZO and LiCoO₂. Results indicate significant cation interdiffusion and structural changes during heating above 300° C. La₂Zr₂₀₇, Li₂CO₃ and LaCoO₃ are identified as decomposition products with synchrotron X-ray diffraction and X-ray absorption spectroscopy. This interface layer between LLZO and LiCoO₂ contributes a lot to charge transfer resistance, thus the interface resistance increases by 8 time after heating.¹⁸⁹

TABLE 1
All solid-state batteries (ASSBs) based on LLZO solid electrolytes (LLZO represents
Li₇La₃Zr₂O₁₂, LCO represents LiCoO₂, LLZNO represents Nb doped LLZO, LLZTO represents
Ta doped LLZO, NCA represents Ni and Al co-doped LCO, LLCZN represents Ca and Nb co-doped
LLZO, LALZWO represents Al and W co-doped LLZO, NCM represents Ni and Mn co-doped LCO).

| | | | Temperature | Loading | Capacity | | |
|---|---|---|---|---|---|---|---|
| Electrolyte | Cathode | Anode | and current | (mg/cm²) | (mAh/g) | Cycles | Ref. |
| LLZO | LCO | Li | RT, 2 μA/cm² | N/A | 0.274 | 3 | ¹⁸⁷ |
| LLZNO | LCO | Li | 25° C., 3.5 | 0.27 | 127 | 100 | ¹⁸⁸ |
| | (PLD) | | μA/cm² | | | | |
| LLZO | LCO@Li₂CO₃ + | Li | 25° C., 0.05 C | 1 | 94 | 100 | ¹⁴⁷ |
| | Li_{2.3}C_{0.7}B_{0.3}O₃ + | | | | | | |
| | LLZO@Li₂CO₃ | | | | | | |
| LLZTO | LiFePO₄ + | Li | 65° C., 0.1 C | 2-3 | 141.5 | 200 | ¹⁸⁶ |
| | C + CPEO + | | | | | | |
| | LiTFSI | | | | | | |
| LLZTO | NCA + | Cu | 60° C., 0.1 C | 3 | 0.5 mAh/cm² | 50 | ¹⁹⁵ |
| | PEO + | | | | | | |
| | LiTFSI | | | | | | |
| LLCZN | S soaked | Li | 22° C., 0.2 | 7.5 | 470 | 32 | ¹⁹⁸ |
| | with 1M | | mA/cm² | | | | |
| | LiTFSI in | | | | | | |
| | DME/DOL | | | | | | |
| | (1:1 by | | | | | | |
| | volume) | | | | | | |
| LLCZN with | LiFePO₄ | Li | 20° C., 0.1 | N/A | 120 | 100 | ¹⁹⁹ |
| Al coating | soaked | | mA/cm² | | | | |
| | with 1M | | | | | | |
| | LiTFSI in | | | | | | |
| | EC/DEC | | | | | | |
| | (1:1 by | | | | | | |
| | volume) | | | | | | |
| LLCZN with | V₂O₅ + | Li | 100° C., 50 | 0.2 | 125 | 27 | ²⁰⁰ |
| Si coating | CNT | | mA/g | | | | |
| LLCZN with | LiFePO₄ + | Li | 25° C., 1 C | N/A | 138 | 100 | ¹⁹¹ |
| Ge coating | Gel | | | | | | |
| | electrolyte | | | | | | |
| LALZWO with | NCM + | Li | RT, 0.5 C | 2 | 128 | 500 | ²⁰¹ |
| graphite | Super P + | | | | | | |
| coating | LiTFSI in | | | | | | |
| | PY14TFSI | | | | | | |
| LLZTO with | LiFePO₄ + | Li | 30° C., 0.1 C | 2 | 120 | 150 | ²⁰² |
| HCl treating | Super P + | | | | | | |
| | ionic liquid | | | | | | |

Wang et al. incorporated glass electrolyte (Li_{2.3}C_{0.7}B_{0.3}O₃) into the cathode layer, which reduced the interfacial resistance between LLZO and LiCoO₂ (LCO), achieving the favorable performance listed in Table 1.¹⁴⁷ LCO, LLZO and Li_{2.3}C_{0.7}B_{0.3}O₃ glass electrolyte with weight ratio of 58:30:12 were mixed with ethyl cellulose as a binder, and a-terpineol as the solvent to prepare the electrode slurry. The slurry was then coated on the surface of LLZO pellet, and then vacuum heated at 100° C. to remove solvent. The LLZO supported cathode composite was then heated at 700° C. to improve the contact of solids. The total resistance was reduced to 300 Ω·cm² through this approach. The button cell was cycled at 25° C. and current density of 0.05 C, with 1 mg/cm² mass loading and 94 mAh/g after 100 cycles. Another strategy is to incorporate polymer electrolytes into the cathode layer.¹⁸⁶ The mechanical softness of polymers gives the composite electrode improved physical contact with LLZO with the total resistance being reduced to 95Ω at 65° C.¹⁸⁶ However, the low ionic conductivity of polymer electrolytes restricts the operating temperature to above ambient, allowing for cycling at 65° C.¹⁸⁶ A battery with LiFePO₄+C+CPEO+LiTFSI composite cathode (2-3 mg/cm² LiFePO₄), 300 μm LLZTO solid electrolyte and Li metal anode was cycled at 65° C. and 0.1 C. It delivered a reversible capacity of 142 mAh/g after 200 cycles, as shown in Table 1.¹⁸⁶ Wachsman and Hu tuned the garnet solid electrolyte and the Li metal by forming an intermediary Li-metal alloy that dramatically improved the wettability of the garnet surface, and reduced the interface resistance by more than an order of magnitude.¹⁹¹ For the baseline Li₇La_{2.75}Ca_{0.25}Zr_{1.75}Nb_{0.25}O₁₂ (LLCZN)/Li the ionic resistance was 950 ohm cm², while for surface-engineered garnet/Li the resistance was 75 ohm cm². That seminal study provided new paths to address the garnet SSE wetting issue against Li and as a result obtained more stable cell performance.¹⁹² It was further demonstrated for a flexible ceramic textile based on the garnet-type conductor Li₇La₃Zr₂O₁₂.¹⁹³ The unique highly flexible SSE showed a number of advantageous properties, including a lithium-ion conducting cubic structure, low density with multi-scale porosity, and a high surface area to volume ratio.

Outlook for Garnet LLZO. The superionic conductivity (~1 mS/cm) at 25° C., and the wide (kinetic) electrochemical window of LLZO makes it a promising solid electrolyte. Significant work has been done to improve the ionic conductivity and to reduce the interfacial resistance between LLZO and various electrode materials. However, the CCD for most LLZO electrolytes is less than 1 mA/cm², which is only C/3 for a typical areal capacity of 18650 cell (3 mAh/cm²).^{164,194} In addition, several other issues also restrict broader utilization of LLZO for solid state batteries. These include the following: The interface resistance between cathode and LLZO is still as high as hundreds of ohms at room temperature, which strongly limits the power density of the ASSB. The maximum room temperature charging rate achieved with an LLZO SSE in a full battery has been reported as 0.05 C, with only 1 mg/cm² mass loading and 94 mAh/g capacity.¹⁴⁷ The thickness of LLZO pellet is still over hundreds of micrometers, which needs to be reduced to gain higher energy density. For most ASSBs with LLZO pellet, the thickness of LLZO is at least 200 μm to guarantee its strength.^{147,186-188,195} Tape-casting followed by sintering is a saleable way to prepare ceramic films from several millimeters to less than 100 μm.^{196,197} Doeff et al. fabricated LLZO film with thickness of 25-44 μm with tape casting.¹⁹⁶ Precursors of LLZO, Li₂CO₃, polyvinyl butyral, and benzyl butyl phthalate were added to alcohol and acetone solvents and then ball-milled for 48 hours to homogenize the suspension, then tape cast onto a Mylar sheet. After drying, the green tape was peeled from Mylar and punched to 22 mm disks. The tape was then placed between graphite foils, which were then placed between two alumina plates for mechanical support. The entire stack was heated at 1070-1090° C. for 1-2 hours under Ar for densification. Sintered samples were reheated at 840° C. under zero grade air to remove carbon. With this thin film, Li/LLZO/Li symmetric cell only shows a total resistance of 35 Ω·cm². However, a short-circuit occurred when the current density was increased to 0.2 mA/cm².¹⁹⁶ Due to the fragility of the thin ceramic samples, applying pressure may have caused cracks and thus led to the short circuit.

In addition, the highly reactive Li metal anode would bring major difficulties in handling and in manufacturing, leading to high fabrication cost. In principle, a Li metal anode may be unnecessary for Li-containing cathodes. Such “anode-less” or “anode-free” configuration would also reduce the total volume and mass of a solid-state battery. Compared to cells with graphite anode, anode-less cells will save about 50% volume, effectively doubling the cell's specific energy. Even comparing to thin Li metal, the cell volume is still reduced by 23% when going anode-less.¹⁹⁵ Therefore, anode-less ASSB architectures in which the Li anode is formed in-situ during the first charging step are technologically favored.^{175,195} Sakamoto et al. designed an ASSB with Cu foil current collector, Ta doped LLZO (LLZTO) solid electrolyte, and Ni, Al co-doped LiCoO₂ (NCA) cathode.¹⁹⁵ The LLZTO with thickness of 2 mm was polished with 1200 grit sandpaper and then Cu current collector was attached to the LLZTO. The Cu was laminated to LLZTO under a pressure of 3-6 MPa and heated at 700° C. in Ar for 5 min. NCA with 3 mAh/cm² capacity and about 35% porosity was casted on the other side of LLTO as the cathode. Then PEO-LiTFSI electrolyte was infiltrated into the cathode porosity by heating and pressing the PEO under 4.2 MPa and 80° C. With enhancement contact between Cu and LLZTO under pressure of 3-6 MPa and heated at 700° C., Li from NCA cathode would deposit between LLZTO and Cu. The ASSB cell was cycled with current of 0.1 C at 60° C., with 0.5 mAh/cm² capacity being retained after 50 cycles(Table 1).¹⁹⁵ The relatively low capacity of 0.5 mAh/cm² for the ASSB vs. 3 mAh/cm² for the cathode is likely due to the instability of PEO and the associated interfaces: The total resistance increased from 90 Ω·cm² on the first cycle, to 200 Ω·cm² after 50 cycles. A cell based on Cu/LLZO/Li was cycled at 0.05 mA/cm² (0.85 mAh/cm²) without a discernable increase in cell impedance. ¹⁹⁵ This indicates that an anode-less ASSB based on LLZO should be viable. Table 1 provides examples of the ASSBs that have been achieved using LLZO and related SSEs.

The following example follows the fabrication and characterization of toughened LLZTO pellets in an electrochemical system. In general, most as synthesized LLZTO pellets have cracks/voids running in parallel to the pellet, as shown in FIG. 3. These significantly reduce the strength and density of pellet. Addition of a toughening additive, such as TaC additives, strengthens the LLZTO matrix and reduces the occurrence of cracks/voids.

It was observed that cold pressed green LLZTO pellet without any carbide additive was prone to lateral cracks, which may be due to inefficient packing of particles. The carbide additives (both SiC and TaC) eliminated the occurrence of lateral cracks within the green body of LLZTO.

LLZTO was enhanced with TaC additive, where 5% TaC was added to LLZTO resulting in an increase in the relative density of the material and increase the ionic conductivity, as shown in Table 2, compared to LLZTO without TaC additive.

TABLE 2
Relative density (%) and ionic conductivity (S/cm)
of LLZTO with and without TaC additive.

| | Relative Density | Ionic Conductivity |
|---|---|---|
| | (%) | (S/cm) |
| LLZTO | 89-92 | 4.75 × 10⁻⁴ |
| LLZTO (+5% TaC) | 93-96 | 8.88 × 10⁻⁴ |

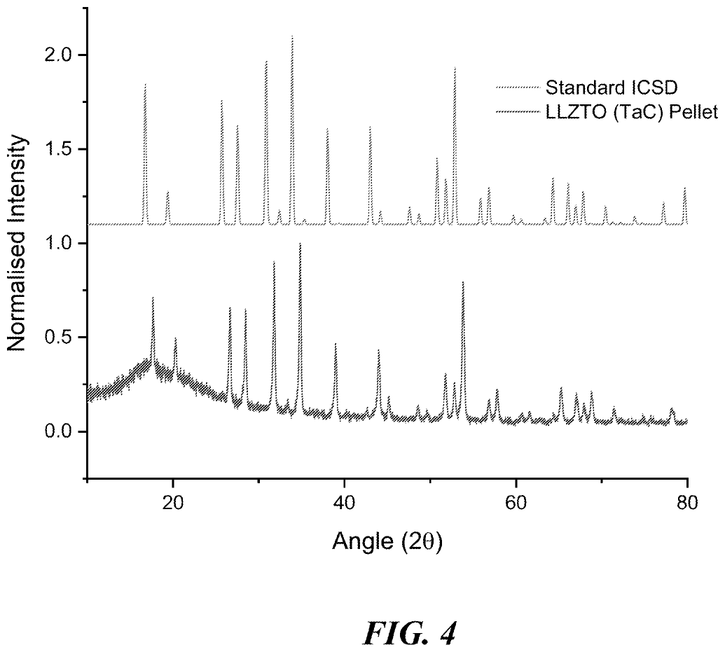

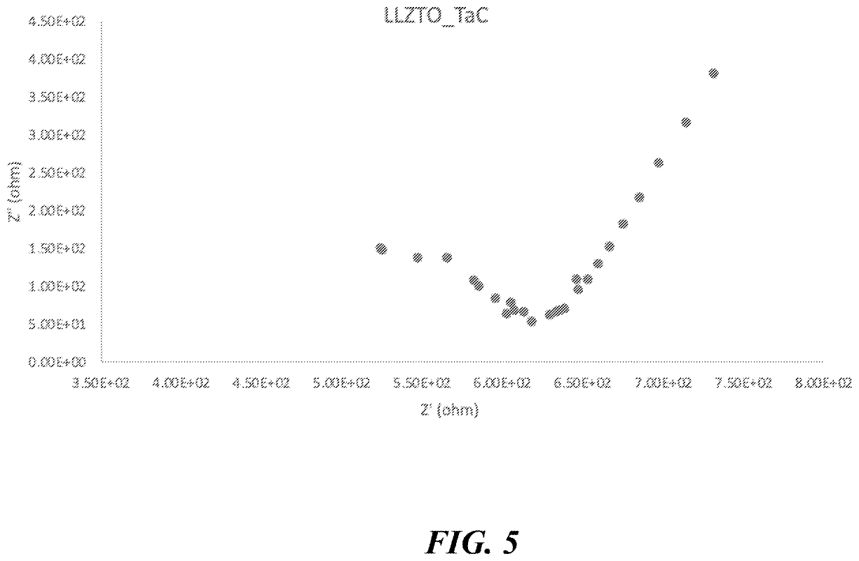

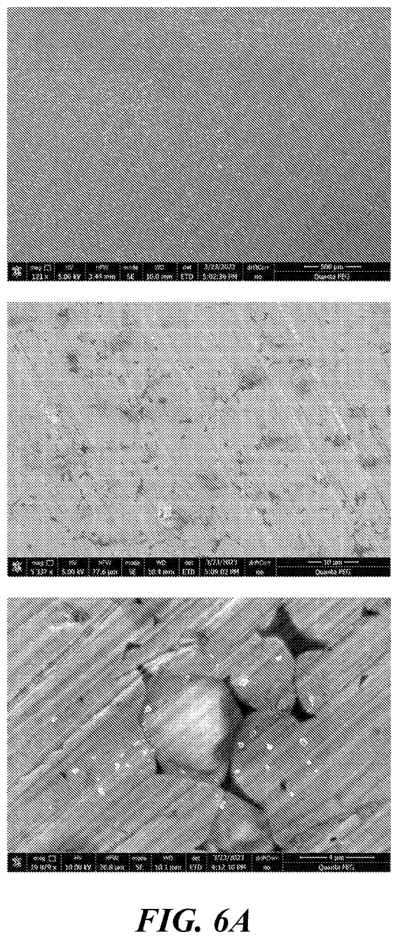

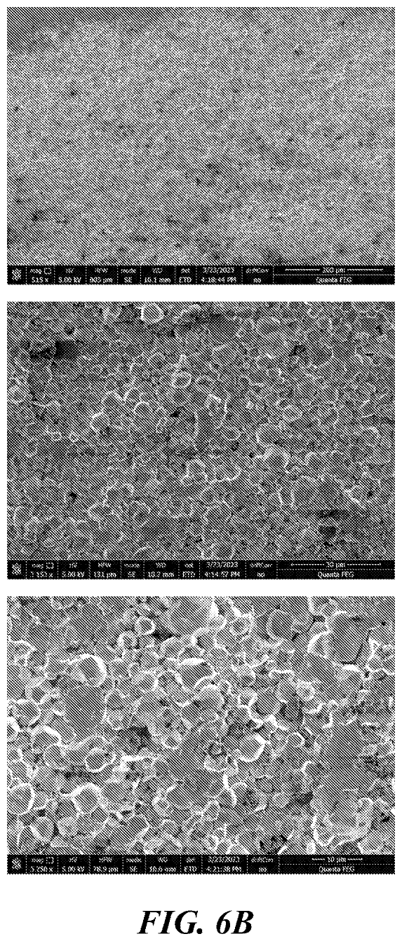

The toughened LLZTO pellet was further characterized using XRD, shown in FIG. 4, and contrasted with standard ICSD refractive index. A toughened LLZTO cell with Ti-blocking electrode was further characterized in an EIS experiment; the resulting Nyquist plot is shown in FIG. 5. FIGS. 6A and 6B show SEM images of LLZTO pellets of different granularity fabricated with TaC additive. It is observed that no such parallel cracks or voids form in the LLZTO samples with TaC additive (FIGS. 6A, 6B versus FIG. 3).

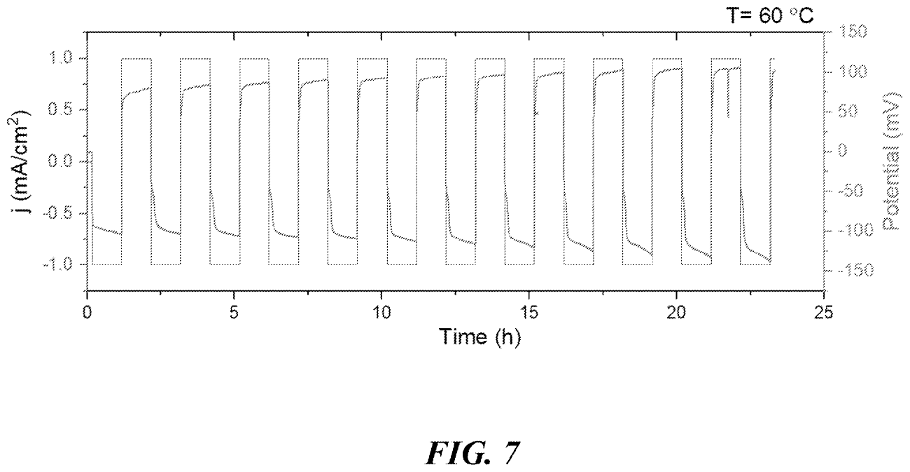

A Li-ion symmetric cell comprising the toughened LLZTO (t-LLZTO) SSE and Li anode and cathode, Li/t-LLZTO/Li, was fabricated, and its electrochemical performance was characterized over a 24-hour period by applying a current density of 1 mA/cm² and capacity of 1 mAh/cm², the results of which are shown in FIG. 7.

During processing of LLZTO and cell fabrication, it was observed that the carbide additives enhanced mechanical strength, whereby the occurrence of pellets breaking has significantly reduced.

Reported herein is a new paradigm for promoting electrochemical stability in garnet-type Li_{6.4}La₃Zr_{1.4}Ta_{0.3}O₁₂ (LLZTO) solid-state electrolyte (SSE) based on grain boundary precipitation of second phase zirconium oxide (ZrO₂). This two-phase microstructure leads to increased compact density and fracture toughness. The composite SSE also displays increased room temperature ionic conductivity (0.7 vs. 0.1 mS/cm) and decreased electronic conductivity (3.4×10⁻⁹ vs. 1.3×10⁻⁸ S/cm) due to insulating zirconia blocking electron transport along grain boundaries. Cryogenic FIB-SEM analysis of cycled electrolyte illustrates how the zirconia suppresses intergranular Li-metal dendrite propagation near the Li-SSE interface. Density functional theory (DFT) calculations illustrate that as compared to baseline LLZTO, the zirconia surfaces are much less electronically conductive and do not trap excess electrons. Electro-chemo-mechanical modeling reveals the role of reduced Li accumulation and increased grain boundary modulus due to zirconia modification on the reaction distribution. These combined attributes (electronic, ionic, and mechanics) lead to a major improvement in the SSE's electrochemical properties: symmetric cell with ZrO₂-LLZTO cycles for 300 hours at 3.2 mA/cm² and 0.53 mAh/cm², versus baseline LLZTO which short circuits at under 20 hours at 1.1 mA/cm² and 0.09 mAh/cm².

This is the first report of second-phase zirconium oxide (ZrO₂) modified lithium lanthanum zirconium tantalum oxide (LLZTO) SSE. During high temperature sintering an in-situ reaction of TaC additive with LLZTO powder leads to precipitation of 4 wt. % amorphous zirconium oxide at the compact grain boundaries. Zirconia is known to promote toughness of structural ceramics such as alumina but has not been applied to modify the microstructure of inorganic or organic SSEs. The ZrO₂-LLZTO composite SSE displays increased density and room temperature ionic conductivity, as well as improved bulk fracture toughness. There is also a significant decrease in the compact's electrical conductivity due to insulating ZrO₂ blocking electronic transport through grain boundaries. These electronic, ionic and mechanics based modifications to the microstructure result in a major improvement of electrochemical properties, giving the composite state-of-the-art performance. Density Functional Theory (DFT) calculations suggest the zirconia has larger fracture energy, increasing the fracture toughness. Per DFT, the high electronic conductivity of pristine LLZTO is attributed to the reduced bandgap and electron trapping states on the internal pore surfaces. In comparison, the ZrO₂ surfaces are much less electronically conductive and do not trap excess electrons. Thus, Li-metal nucleation at the pore surface and grain boundaries is greatly reduced. Electro-chemo-mechanical modeling reveals that the enhanced performance of ZrO₂-LLZTO is attributed to the favorable transport and mechanical characteristics of the SSE grain boundary. This not only inhibits preferential electrodeposition within the grain boundaries but also hinders crack propagation towards the counter electrode.

### Experimental Section

Synthesis. Baseline Li_{6.4}La₃Zr_{1.4}Ta_{0.3}O₁₂ (LLZTO) powder was synthesized using a conventional solid state synthesis method originally established by Goodenough et al. and employed by others.^{[42, 67]} Stoichiometric amounts of Li₂CO₃ (Sigma Aldrich), La₂O₃ (Sigma Aldrich), ZrO₂ (Sigma Aldrich), and Ta₂O₅ (Sigma Aldrich) were weighed. A 50 wt. % excess of Li₂CO₃ was added to compensate for lithium loss during sintering.³ The powders were co-milled (RESTCH Planetary mill PM 100) in a zirconia jar with zirconia balls (6 mm diameter) at 300 rpm for 24 hours (20 minutes milling, 10 minutes rest) using ethanol as the milling solvent. The paste was then dried on a hot plate and annealed in an alumina crucible inside a furnace (Carbolite HTF 17/10) at 900° C. for 12 hours in air. The resultant LLZTO powders (Beige color) were then collected and stored for further pellet fabrication.

For fabrication of ZrO₂-LLZTO pellets, the targeted amount of TaC (Thermofischer, 99.9%) (5 wt. %, 7.5 wt. % and 10 wt. %) was mixed with as-synthesized LLZTO powder. The mixture was milled in a planetary ball mill at 300 rpm for 24 hours (20 minutes milling, 10 minutes rest) using ethanol as the milling solvent. The resultant slurry was then dried on a hotplate at 100° C. for 30 minutes. Once dry, the powders were collected and hand ground using a mortar and pestle so as to pulverize any clumps formed during drying. Roughly 800 mg of powder was weighed and pressed using a stainless-steel die press (diameter=12 mm) with a pressure of 867 MPa. The pellets were then placed inside an alumina crucible with a layer of LLZTO powder at the bottom and another layer at the top. The baseline LLZTO was also milled identically to ensure a similar starting particle size. The ZrO₂-LLZTO and baseline LLZTO pellets were sintered in air at 1140° C. for 16 hours. Once sintering was complete, the pellets were allowed to cool naturally to room temperature.

Electrochemical Analysis. Electrochemical analysis of ZrO₂-LLZTO and baseline LLZTO solid-state electrolytes (SSEs) was carried out using polyether ether ketone (PEEK) mold cells using a two-electrode configuration. All cell fabrication was performed inside an argon filled glove box (O₂, H₂O<0.1 ppm). To investigate the SSE's ionic conductivity, ZrO₂-LLZTO and baseline LLZTO were tested using blocking Au thin film electrodes, without Li metal or other active phases. Electrochemical impedance spectroscopy (EIS) was performed on symmetric cells with gold blocking electrodes 7.6 mm in diameter. 15 nm of gold was sputtered on the LLZTO using a Cressington sputter coater with mica masks to control the coated area. EIS was performed at various temperatures with an amplitude of 20 mV from 1 MHz to 10 Hz. Symmetric cells with titanium blocking electrodes were constructed to study the electronic conductivity using the methods by Han et.al,⁴ The Ti was sputtered (200 nm thickness and 8 mm diameter) on the LLZTO using magnetron sputterer (AJA Orion-8). The cells were polarized to 0.1 V and the current was monitored for 1 hour. The experiment was performed at multiple temperatures.

In-depth electrochemical analysis of the SSEs was performed using Li metal symmetric cells and half-cells. First a 20 nm layer of W was sputtered on each side of the SSE. A 250 μm lithium circular disk from (MTI) with a 4 mm diameter was first cleaned using a knife and then punched and placed onto each side of the SSE. Both lithium electrodes were then covered with disc of the Cu current collector (8 mm diameter and 0.25 mm thickness). A pressure of 1 MPa was then applied to allow for lithium to interface with SSE. The pressure was released and the entire cell was then placed on a hotplate, covered with a glass beaker and held at 300° C. (hotplate temperature) for 8 hours. For the half-cells, one side of SSE was interfaced with Li metal as described above, while the other side had 1-micron Cu sputtered onto the surface. To standardize the test, all cells were tested at room temperature using an external pressure of approximately 0.1 MPa. All the electrochemical measurements were performed using a Princeton PARSTAT MC electrochemical workstation equipped with the Versastudio software.

Analytical Characterization. Scanning electron microscopy (SEM) imaging was performed using a field emission scanning electron microscope (Thermofischer Apreo 2C) equipped with an energy-dispersive X-ray spectrometer (EDXS). Cryogenic electron microscopy (Cryo-EM) analysis was performed using a Thermo Scientific Scios 2 Dual Beam SEM/FIB with a Leica VCT cryogenic stage and an EDXS detector. Gallium ion focused ion beam (FIB) milling was performed while the sample was held at −150° C., using an accelerating voltage of 30 keV. X-ray photoelectron spectroscopy (XPS) analysis was performed on a customized system equipped with Hemispherical Energy Analyzer PHOIBOS 100 (SPECS Surface Nano Analysis GmbH), with Mg Kα as the excitation source. X-ray diffraction analysis was recorded using a Rigaku Miniflex 600 Diffractometer with Cu Kα radiation (λ=1.54178 Å) at a scan rate of 4° per minute within the 2θ range from 10° to 80°.

Fracture toughness was assessed using miniature disk compact tension (DCT) test specimens, which had a thickness ranging from 1.2 to 1.5 mm and a diameter of 10 to 11 mm. The notch in these DCT samples was 5 mm long and up to 100 μm wide. The notches along with 1.2 mm pin holes were machined from as-fabricated polished SSE disks, following the ASTM standard D7313 guidelines using either nanosecond (NS) or femtosecond (FS) lasers. Optical and scanning electron microscopy was used to measure the as-machined dimensions. In these brittle samples, the crack propagated unstably through the entire sample once generated. It is important to note that these measurements were exclusively conducted for the purpose of comparing ZrO₂-LLZTO versus baseline LLZTO pellets. A comparison of samples with different notch thicknesses revealed no significant disparities between the 30 μm notched (FS laser cut) sample and the 100 μm notched (NS laser cut) sample. The DCT tests were conducted under displacement control, with a controlled rate of 0.1 mm/min, employing a test resource model 3 load frame with an MTS 492 digital controller and a calibrated 250 lb. load cell. Following testing, the fracture toughness (Kc) values were computed using the provided equation⁵, where a represents crack length, w signifies specimen width, B denotes specimen thickness, P denotes the applied load, and α is a/w.

$${K}_{Ic} = \frac{P}{{Bw}^{1 / 2}} [ \frac{( 2 + α ) ( 0.76 + 4.8 α - 11.58 {α}^{2} + 11.43 {α}^{3} - 4.08 {α}^{4} )}{{( 1 - α )}^{3 / 2}}$$

Subsequently, the fractured samples were sputter coated in 5 nm gold to facilitate examination of the fractured surfaces via scanning electron microscopy (SEM).

DFT Computational details. Plane-wave DFT calculations implemented in the Vienna Ab initio Simulation Package (VASP)⁶ were performed to compare the bulk and surface properties of ZrO₂ and LLZTO. The Perdew-Burke-Ernzerhof (PBE) functionals of the generalized gradient approximation (GGA)⁷ and the projector-augmented wave (PAW) pseudopotentials⁸ were employed as our previous LLZO work.⁹ A cutoff⁷energy of 520 eV is enough to reach the convergence in the self-consistent loop, 10⁻⁵ eV in energy and 0.03 eV/Å in force. 5×5×5 and 3×3×3 Monkhorst-Pack k-point grids were imposed on the reciprocal lattices for crystal ZrO₂ and LLZTO bulk calculations. Only 1 k-point was put along the surface norm direction for slab calculations (k-point grid 5×5×1 or 3×3×1). Gaussian smearing were used in structural optimization, while the tetrahedron smearing method with Blöchl corrections¹⁰ was employed to get more accurate DOS and charge distributions for surfaces.

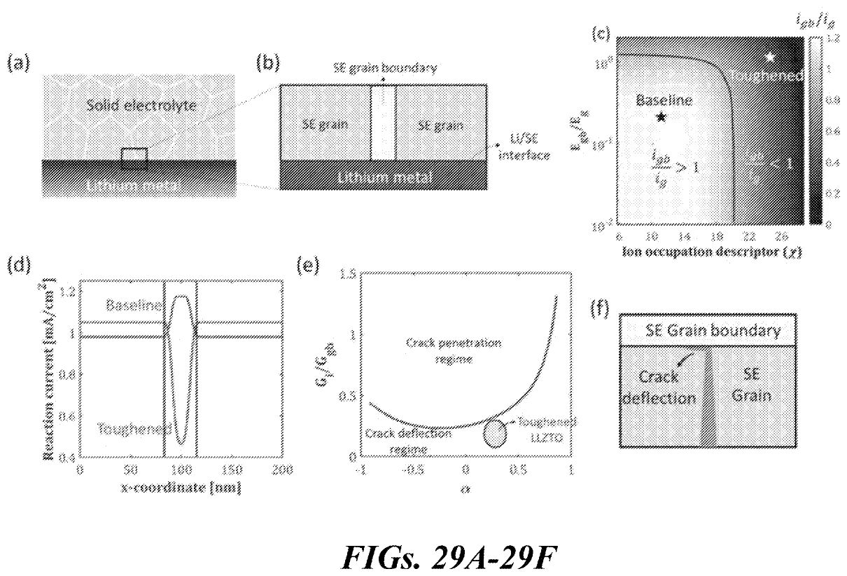

The bulk cubic ZrO₂ simulation cell (MP-1565, space group Fm-3m) is taken from the Materials Project database¹¹ to represent the precipitated zirconia phase at elevated temperature. FIG. 29A. The baseline bulk LLZTO structure is constructed based on the supercell¹² of cubic 8(Li₇La₃Zr₂O₁₂.). Both Li₅₆La₂₄Zr₁₁Ta₅O₉₆ and Li₅₆La₂₄Zr₁₀Ta₆O₉₆ were calculated based on the lowest energy configuration after sampling 13 Ta configurations. FIG. 29D shows the structure of Li₅₆La₂₄Zr₁₀Ta₆O₉₆, with an optimized lattice parameter of 12.59 Å, comparable to the XRD measured value (0.9% difference).

Slab models with 10 Å of vacuum were used for surface calculations. It has been found that the stoichiometric (110) surface low energy in LLZO. Therefore, three surface stoichiometries were compared for LLZTO (110). The surface properties are listed in Table 3.

The fracture energy (F) is defined similarly as surface energy, as

$$Γ = \frac{1}{A} ( {E}_{slab} - n \times {E}_{bulk} - \sum {n}_{i} \times {μ}_{i} ) , \qquad ( 1 )$$

where A is the surface cross section area, E_{slab} is the energy for the surface slab, n is the number of bulk formulas, E_{bulk} represents the bulk energy per formula, nᵢ is the excessive or defective numbers of elements with chemical potential μᵢ referenced to the Li metal and stale oxides at the interface.¹³

A lower fracture energy suggests the surface is easier to cleave (prone to fracture) and more stable. The O rich (001) surface is the least stable ZrO₂ surface, mainly because to expose those excessive O atoms on the surface, half of the Zr—O bonds (4 out of 8) are broken, corresponding to extremely high fracture energy (13.76 J/m²). The numbers of broken Zr—O bonds per Zr atom are 2 and 1 for the (110) and (111) surfaces, respectively. With the fewest broken bonds, the ZrO₂ (111) surface is the most stable surface. Among the LLZTO surfaces, the stoichiometric (110) surface shows comparable fracture energy (2.22 J/m²) with LLZO (110) surface.⁹ With fewer Ta atoms on the surface, F for the nonstoichiometric less Ta (110) surface is only 0.1 J/m² higher than that for the stoichiometric (110) surface. Moreover, when more Ta atoms are on the surface, F is decreased to 1.94 J/m². This is intuitive because the surface can release strain caused by Ta doping. Nonetheless, the surface electronic properties should not be significantly altered by Ta atoms as the under-coordinated cations (such as La) on the surface still provide empty states for excess electrons. Noticeably, ZrO₂ surfaces show higher fracture energy than LLZTO surfaces in general, revealing the benefits of the zirconia phase in crack deflection.¹⁴

The DOS of the bulk and surfaces for both ZrO₂ and LLZTO are plotted to further understand the impacts of surface states on dendrite growth. The alignment of DOS versus the vacuum and Li Fermi level follows the same way in previous papers.^{14,15} The LLZO work function (4.13 eV) is used to determine the vacuum level and the Li⁺/Li⁰ deposition potential is 1.39 eV below the vacuum level. For ZrO₂, both (001) and (110) surfaces decrease the bulk band gap by around 0.6 eV, but the most stable surface (111) shows comparable band gap (3.47 eV) to that in the bulk (3.54 eV) because only 1 Zr—O bond is broken for each Zr atom, which helps retain the bulk property. In contrast, all LLZTO (110) surfaces decrease the bulk band gap (4.31 eV) by more than 2 eV due to the exposed cation orbitals. Even worse for Li-dendrite growth, the states between the Li Fermi level (black vertical line) and the Li⁺/Li⁰ deposition potential can trap electrons, leading to Li nucleation inside the electrolyte and dendrite growth.

TABLE 3
Calculated fracture energy (Γ) for ZrO₂ and LLZTO surfaces.

| | | | Fracture energy |
|---|---|---|---|
| Materials | Surfaces | Slab structures | (J/m²) |
| ZrO₂ | O rich (001) | Zr₁₀O₂₄ | 13.76 |
| | Stoichiometric (110) | Zr₂₂O₄₄ | 4.86 |
| | Stoichiometric (111) | Zr₂₀O₄₀ | 3.12 |
| LLZTO | Stoichiometric (110) | Li₅₆La₂₄Zr₁₀Ta₆O₉₆ | 2.22 |
| | Less Ta (110) | Li₅₆La₂₄Zr₁₆Ta₈O₉₆ | 2.32 |
| | Ta segregated (110) | Li₅₆La₂₄Zr₁₄Ta₁₀O₉₆ | 1.94 |

Electro-chemo-mechanical modeling. A coupled electro-chemo-mechanical model is developed. The domain considered for the model is schematically illustrated in FIG. 29B of the manuscript. Here, ionic transport in the SE is modeled using the charge conservation equation as follows:

$$∇ \cdot ( {k}_{SE} ∇ {ϕ}_{SE} ) = 0 \qquad ( 2 )$$

1 mA/cm² of constant applied current is given as the boundary condition at the top boundary of the SE and mechanics coupled reaction-kinetics is fed as the boundary condition at the Li/SE interface, which can be expressed as follows:

$${i}_{BV} = {i}_{0} exp ( \frac{Δ {μ}_{{e}^{-}}}{2 RT} ) ( exp ( \frac{F η}{2 RT} ) - exp ( - \frac{F η}{2 RT} ) ) \qquad ( 3 )$$

Additionally, the left and right boundaries of the SE are set to: ∇φ_{SE}. n=0. Here, k_{SE} and φ_{SE} are the ionic conductivity and the electric potential in the SE, i₀ is the exchange current density, R is the universal gas constant, T is the operating temperature, F is the Faraday's constant, η is the electrical overpotential and Δμₑ—is change in the electrochemical potential due to mechanical stresses at the interface. Δμₑ—can be mathematically expresses as follows:

$${Δμ}_{{e}^{-}} = - \frac{1}{2} ( {Ω}_{Li} ) ( {e}_{n} \cdot ( ( {τ}_{d}^{Li} - {τ}_{d}^{SE} ) {e}_{n} ) ) + \frac{1}{2} ( {Ω}_{Li} ) ( Δ {p}^{Li} + Δ {p}^{SE} ) \qquad ( 4 )$$

where, Ω_{Li} is the molar volume of metallic lithium,

$${τ}_{d}^{Li} and {τ}_{d}^{SE}$$

are the interfacial deviatoric stress tensors for lithium and SE, respectively and Δp^{Li} and Δp^{SE} are hydrostatic stress components at the interface for Li metal and SE, respectively. For evaluating the stresses in the Li metal and SE, a linear elasticity model has been adopted in this work. All the parameters used in the modeling framework are given in Table 4.

TABLE 4
Parameters used in the model.

| | | |
|---|---|---|
| Parameters | Values | Units |

Constants

| | | | |
|---|---|---|---|
| R | Gas constant | 8.314 | J mol⁻¹ K⁻¹ |
| F | Faraday constant | 96,487 | C mol⁻¹ |
| T | Reference temperature | 298.15 | K |

Electrochemical and Mechanical parameters

| | | | |
|---|---|---|---|
| i₀ | Exchange current density | 5.5¹⁶ | A m⁻² |
| Ω_{Li} | Molar volume of metallic lithium | 1.3 × 10⁻⁵ | m³ mol⁻¹ |
| k_{g} | Ionic conductivity of SE grain | 0.04¹⁷ | S m⁻¹ |
| E_{Li} | Young's modulus of Li | 7.83¹⁸ | GPa |
| E_{g} | Young's modulus of SE grain | 140¹⁹ | GPa |
| E_{gb, toughened} | Young's modulus of toughened grain | 209.3²⁰ | GPa |
| | boundary | | |
| υ_{Li} | Poisson's ratio of Li | 0.381 | — |
| υ_{SE} | Poisson's ratio of SE | 0.27 | — |
| G_{g} | Fracture toughness of SE grain | 1.17²¹ | MPa m^{0.5} |
| G_{gb, toughened} | Fracture toughness of toughened | 4-8²² | MPa m^{0.5} |
| | grain boundary | | |

TABLE 5
List of DCT samples tested and obtained
fracture toughness (K_{IC}) values

| | | | Fracture Toughness | |
|---|---|---|---|---|
| | Max. Load (P) in Newton | | (K_{1C}) in MPa m^{0.5} | |
| | Sample 1 | Sample 2 | Sample 1 | Sample 2 |
| LLZTO samples | (NS Laser) | (FS Laser) | (NS Laser) | (FS Laser) |
| Baseline LLZTO | 24.0 | 28.0 | 1.19 | 1.13 |
| ZrO₂-LLZTO | 28.0 | 25.7 | 1.33 | 1.28 |

### Results and Discussion:

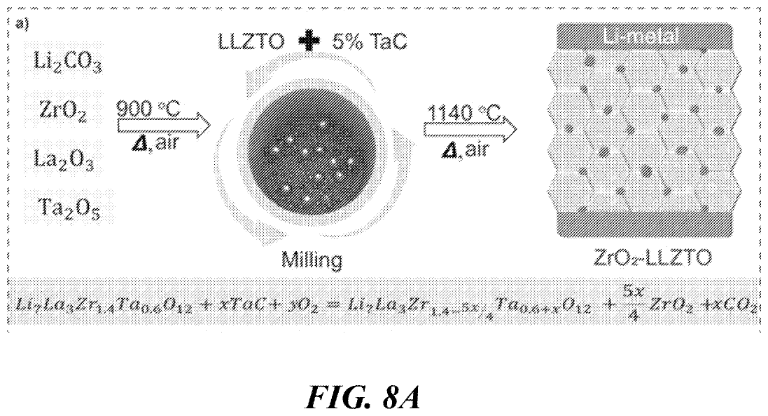

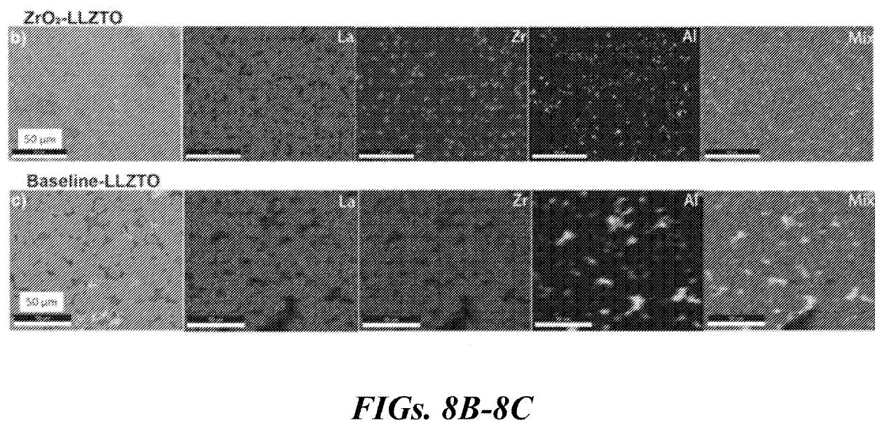

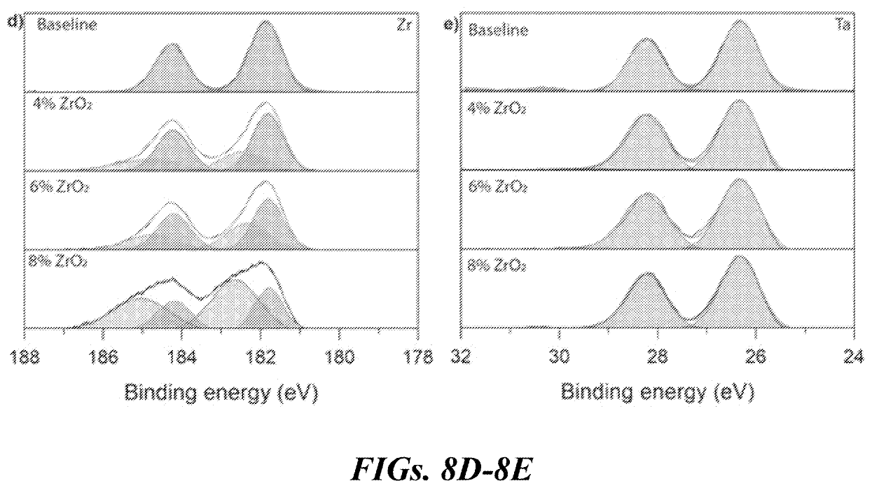

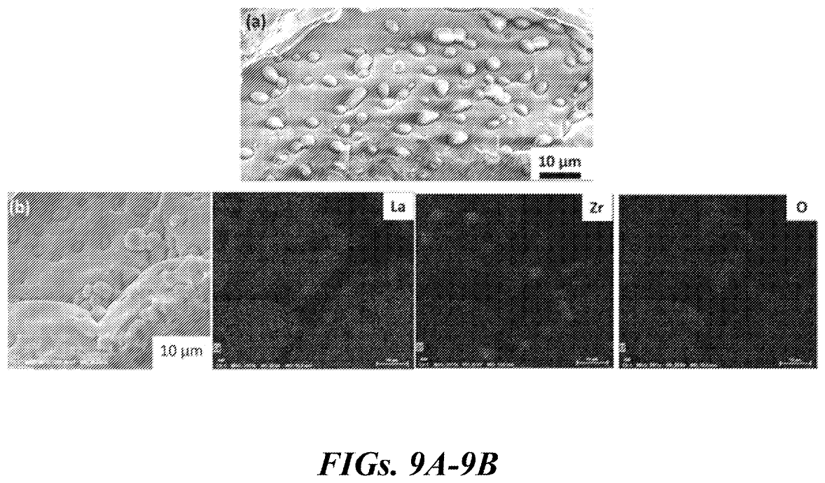

FIG. 8A provides a schematic flowchart for the synthesis of ZrO₂-LLZTO, with fabrication details, including for the baseline LLZTO. In summary, baseline LLZTO powder is synthesized by a conventional solid state synthesis method as established by Goodenough and co-workers and employed by others.^{20,42} Stoichiometric amounts of Li₂CO₃, La₂O₃, ZrO₂ and Ta₂O₅ are employed as precursors, with 50 wt. % excess of Li₂CO₃ being added to compensate for lithium loss during sintering.⁴³ The powders are co-milled and sintered at 900° C. for 12 hours in air in alumina crucible. For fabrication of ZrO₂-LLZTO, the targeted amount of TaC (5 wt. % being optimum, 7.5 wt. % and 10 wt. % also tested) is co-milled with the as-synthesized LLZTO powder. The baseline LLZTO is also milled identically to ensure a similar starting particle size. Pressed compacts of LLZTO or TaC-LLZTO are sintered in air at 1140° C. for 16 hours, while surrounded by loose LLZTO powder to prevent Li loss. During sintering the TaC reacted with both air and the LLZTO, the carbon being volatilized as CO₂. The formation of zirconium oxide (ZrO₂) is due to the reaction between Ta and LLZTO in which Ta substitutes for Zr in the octahedral sites. This yields a Ta-rich LLZTO while causing a supersaturation of Zr that precipitates out at the grain boundaries and forms an amorphous oxide (see FIG. 9). The precipitated ZrO₂ also acts as a sintering aid, filling in the inter-grain porosity that would have otherwise been left vacant. During the course of this research, it was observed that the addition of metallic Ta or Ta₂O₅ instead of TaC is not effective. At elevated temperatures the Ta metal powder simply oxidized, while the Ta₂O₅ remained stable, neither being reactive with LLZTO powder.

Assuming that all “extra” Ta goes into the LLZTO solid-solution, the change in the LLZTO stoichiometry may be straightforwardly calculated. For example, with 5 wt. % TaC addition, the composition of the LLZTO will change from the standard Li_{6.4}La₃Zr_{1.4}Ta_{0.6012} to Li_{6.4}La₃Zr_{1.07}Ta_{0.87012}, with 4 wt. % (0.0031 moles) ZrO₂ being precipitated out. The same calculation yields 6 wt. % ZrO₂ and 8 wt. % ZrO₂ for the 7.5 wt. % TaC and 10 wt. % TaC specimens, respectively. During characterization of the ZrO₂-LLZTO SSEs in the as-synthesized condition, or at various stages of electrochemical testing, there was no evidence for the formation of a secondary TaₓO_{y} phase, implying that the above calculations for the terminal LLZTO stoichiometry are reasonable. Furthermore, atomistic structures of Li₅₆La₂₄Zr₁₀Ta₆O₉₆ and Li₅₆La₂₄Zr₁₁Ta₅O₉₆ are also used to evaluate the thermodynamics driving force of the reaction.

$${Li}_{56} {La}_{24} {Zr}_{11} {Ta}_{5} {O}_{96} + TaC + 2 {O}_{2} {\to }^{1140 ° C} {Li}_{56} {La}_{24} {Zr}_{10} {Ta}_{6} {O}_{96} + {ZrO}_{2} + {CO}_{2}$$

The reaction energy of the crystal structures cubic TaC (MP-1086),⁴⁴ and the gas phase of O₂ and CO₂ were all minimized. The reaction energy, ΔE(r)=−10.108 eV, was obtained for Equation (1) using the DFT energy for each species at 0 K. Since DFT energy is obtained at 0 K, the entropy contribution, mainly due to the gas molecules, should be included at the synthesis temperature to reveal the thermodynamics. Based on the data provided for the Ellingham diagram, the entropy contribution (TLS) to the Gibbs free energy is less than 3 eV from 0 K to 867 K, which leads to the Gibbs free energy change for Equation (1)~−7 eV. Hence, the synthesis of ZrO₂-LLZTO is thermodynamically feasible.

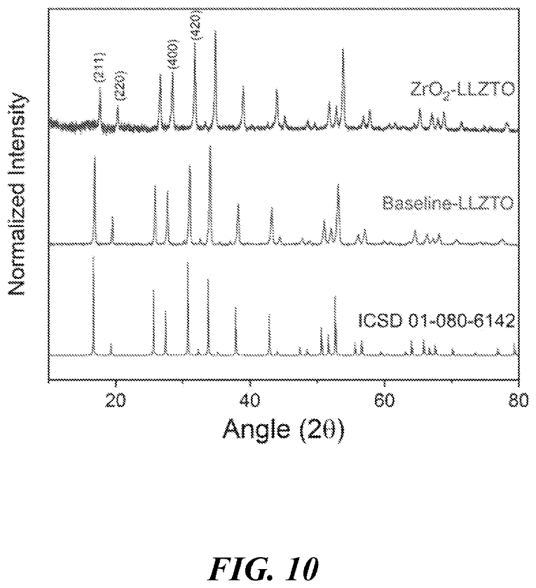

Because of the combination of the highest room temperature ionic conductivity and highest relative density, the 4 wt. % ZrO₂ specimen was selected as the primary focus of this study (labelled as ZrO₂-LLZTO), using the unmodified LLZTO as a baseline. Again, it should be emphasized that the same mechanical milling and sintering regiment was employed for all specimens, the only difference being the addition of TaC for the targeted materials. FIG. 10A compares the X-ray diffraction (XRD) patterns of ZrO₂-LLZTO and baseline LLZTO compacts with standard cubic LLZTO data (ICDD 01-080-6142, Ia3̅d and a lattice parameter of 1.291 nm). A near perfect match with the standard pattern confirms that the crystalline portion of the ZrO₂-LLZTO SSE is the same as for baseline LLZTO. From the XRD plot, the lattice parameter for baseline LLZTO was calculated to be 1.253 nm and 1.247 nm for ZrO₂-LLZTO. This decrease in lattice parameter is in accordance with the reported literature values where an increase in doping with relatively smaller Ta ion results in decrease in LLZTO lattice parameter from 1.291 nm (Ta=0.6 moles) to 1.283 nm (Ta=0.8 moles).⁴⁵ The precipitated zirconia phase is amorphous and does not produce characteristic Bragg peaks. Other analytical techniques are employed to characterize sample structure, as described in the following paragraphs.

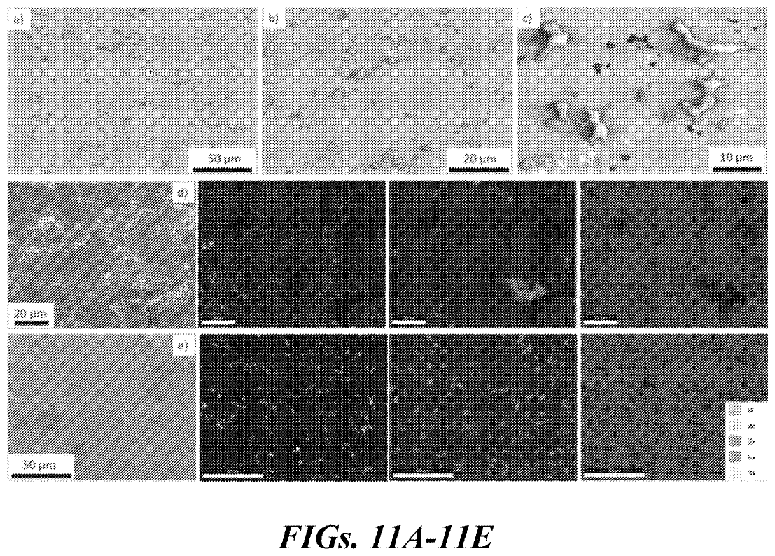

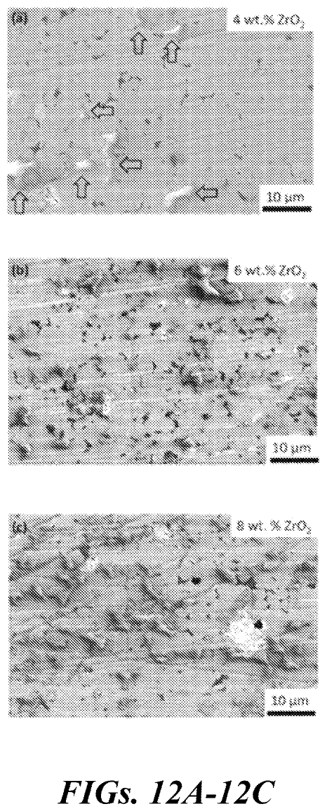

FIG. 9B and FIGS. 11A-11E show scanning electron microscope (SEM) images and energy-dispersive X-ray spectroscopy (EDXS) elemental maps of La, Zr and O for ZrO₂-LLZTO. The figures highlight a polished cross-section and a mechanically fractured surface, respectively. The ZrO₂-LLZTO microstructure contains a distinct second phase that is interspersed between the LLZTO grains. The second-phase irregular rounded morphology is distinct from alumina that is known to uniformly wet the grain boundaries.⁴² The high melting point and kinetically sluggish crystallization kinetics of zirconium oxide cause its presence as an amorphous phase in multi-phase ceramics.^{46,47} The irregular rounded (lacking clear crystallographic facets) rather than crystallographic morphology of the zirconia phase also agrees the amorphous assignment.⁴⁸ As shown in FIG. 12A-12C, the volume fraction of the zirconia scales with the amount of TaC additive. As the concentration of TaC increases, progressively more zirconium oxide particles precipitate at the grain boundaries, agreeing with the calculations provided earlier. However, the shape of the zirconia particles at the three different volume fractions is similar. The 4 wt. % ZrO₂ SSE is the primary focus of this study, as the ionic conductivity and the relative density of the compact decreased at higher ZrO₂ content.

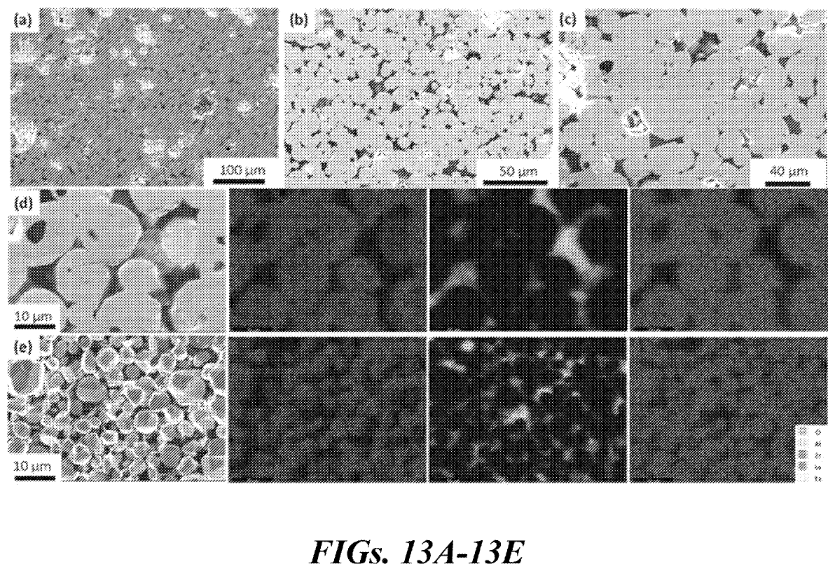

The ZrO₂-LLZTO and baseline LLZTO compact density was calculated using Archimedes principle. The density range for ZrO₂-LLZTO was 94-98%, while for the baseline LLZTO it was 89-92%. Despite identical sintering conditions, the ZrO₂-LLZTO is denser than the baseline LLZTO. FIG. 9C and FIG. 13A-13E show SEM and EDXS analysis of baseline LLZTO, highlighting analysis of polished cross sections and of fracture surfaces. As expected, the baseline LLZTO sample displays a small quantity of amorphous alumina wetted to the grain boundaries, a known outcome of using alumina boat crucibles during sintering. Grain boundary alumina originates from the reaction vessel and has been reported to aid in sintering and the stabilizing cubic phase of LLZTO.⁴² However alumina has been attributed to being favorable nucleation sites for lithium metal³⁵ and is not known to impart improved mechanical toughness to the compact. Zirconium oxide is highly refractory (Tₘₑₗₜ=2715° C.) and would not be present as a liquid phase during sintering at 1140° C. In the solid-state the precipitation of zirconium oxide may still aid densification through a number of mechanisms, including enhanced diffusion and modification of the surface tensions.

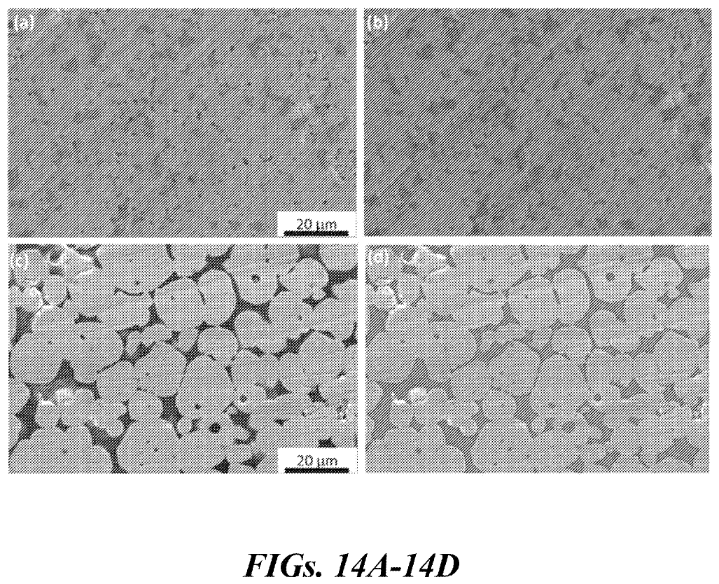

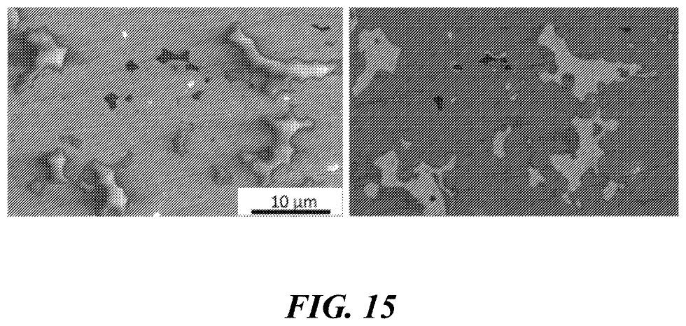

Quantitative stereology analysis of the porosity present in the polished cross-sections was performed using ImageJ software available on the NIST database. FIG. 14A-14B displays an example of pore size analysis performed on the 4 wt. % ZrO₂-LLZTO specimen. FIG. 14C-14D displays an example of pore size analysis performed on the baseline LLZTO specimen. The average porosity for 4 wt. % ZrO₂-LLZTO is 1.7%, with average pore area of 0.44 μm². In contrast, the average porosity for baseline LLZTO is 12%, with an average pore area of 46 μm². Based on similar analysis, the percentage zirconia in ZrO₂-LLZTO is calculated to be 14% by area. An example of this analysis is shown in FIG. 15. As will be highlighted by the DFT analysis shown later in the manuscript, the reduced pore surface area is important for preventing dendrite penetration.

X-ray photoelectron spectroscopy (XPS) analysis was conducted to investigate the chemical valences of Ta and Zr. As shown in FIG. 9D, the high-resolution Zr 3d spectrum of the baseline LLZTO sample displays two peaks at 181.9 and 184.3 eV, attributed to the Zr⁴+3d_{5/2} and Zr⁴+3d_{3/2}, respectively. With ZrO₂-LLZTO a new pair of Zr peaks emerges at higher binding energies. These new peaks at 182.5 and 184.9 eV are assigned to Zr⁴⁺ (ZrO₂) 3d_{5/2} and Zr⁴⁺ (ZrO₂) 3d_{3/2}, respectively. Notably, the intensity of ZrO₂ peaks increase as the amount of TaC precursor increases, indicating a change in the composition of the resulting LLZTO electrolyte, with progressively more ZrO₂ phase precipitating out. FIG. 9E shows the high-resolution Ta 4f spectrum of the baseline LLZTO sample, revealing two major peaks. The dominant peak at 26.3 eV corresponds to Ta⁵+4f_{7/2}, followed by Ta⁵+4f_{5/2} at 28.2 eV. The Ta peaks show no significant changes with different amounts ZrO₂ present, indicating that in ZrO₂-LLZTO the Ta remains in its 5⁺ oxidation state.

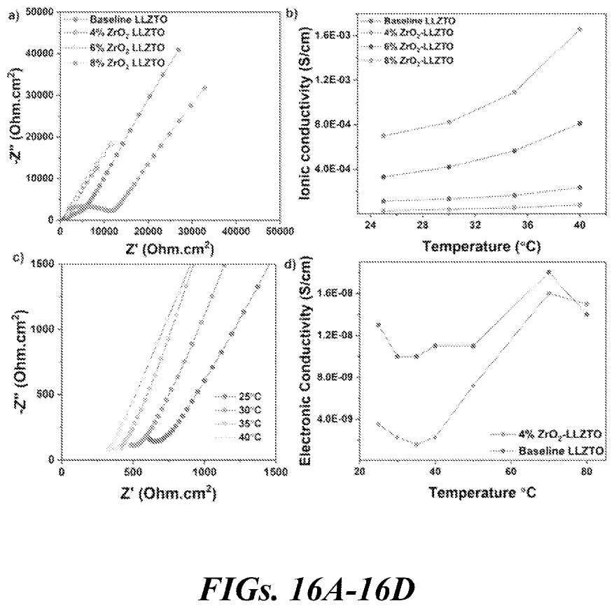

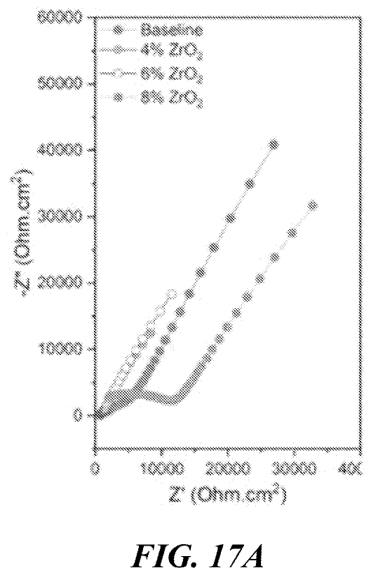

FIG. 16A and FIG. 17A show the electrochemical impedance spectroscopy (EIS) Nyquist plots (1 MHz-10 Hz) performed on ZrO₂-LLZTO compacts and baseline LLZTO at room temperature. FIG. 16B plots room-temperature ionic conductivity extracted from fitting the Nyquist lots at various temperatures. FIG. 16C shows one of the Nyquist plots performed on 4 wt. % ZrO₂-LLZTO at different temperatures. FIG. 17B plots the ionic conductivity versus the relative density for the four specimens. The room temperature ionic conductivity and density peaked with the 4 wt. % ZrO₂ addition, increasing from 0.11 mS/cm for the baseline LLZTO to 0.7 mS/cm for the targeted ZrO₂-LLZTO. The increased room temperature ionic conductivity is likely due to the density difference between ZrO₂-LLZTO and baseline LLZTO compacts: Conductivity is conductance (reciprocal measured resistance) multiplied by the compact area divided by the compact thickness. A lower pore volume fraction means that more LLZTO versus pore is in contact with the blocking electrodes, leading to an effectively larger area. It also means reduced tortuosity of the Li ion path through the compact. The path length is decreased and so is the effective compact thickness. With higher weight fractions of ZrO₂ both the room temperature ionic conductivity and the relative density decreased. The 6 wt. % ZrO₂ measured 0.33 mS/cm while the 8 wt. % ZrO₂ measured 0.026 mS/cm. We did not investigate the origin of these effects since those samples were not employed for cycling electroanalysis.

FIG. 16D plots the electronic conductivity of 4 wt. % ZrO₂-LLZTO and baseline LLZTO. This data was obtained using a symmetric titanium blocking electrode configuration. The cells were polarized to 0.1 V while the current was monitored for 1 hour at each temperature.

The measured reduced electronic conductivity should be highly beneficial for preventing Li metal nucleation in the bulk of LLZTO compacts, per the analysis provided in literature.²⁵⁻²⁷ The room temperature electronic conductivity of 4 wt. % specimen was calculated to be 3.4×10⁻⁹ S/cm, which is significantly lower than that of baseline LLZTO (1.38×10⁻⁸ S/cm). The decreased electronic conductivity is likely coming from additional ZrO₂ and less porous surfaces. Tian et al. showed that some internal surfaces (e.g. the existing pore surfaces) can trap electrons with smaller surface band gaps, additional surface electronic states, or even some metallic characteristics, leading to the reported low electron conductivity.¹⁹ This phenomenon extends to crack surfaces and even grain boundaries. The trapped electrons, especially on La-site, will lead to nucleation of metallic-Li inside of LLZO, at, or even in front of the Li-dendrite front. These calculations concur with the experimentally observed correlation of enhanced electrical conductivity at LLZTO grain boundaries and the localized nucleation-growth of metal dendrites. Such dendrites do not need to originate at the metal—SSE interface but may form in the bulk of the SSE at a “hot point” with enough electrical conductivity.^{19,26} Thus, the trapped electrons on LLZO surfaces will accelerate Li dendrite growth within the propagating cracks.

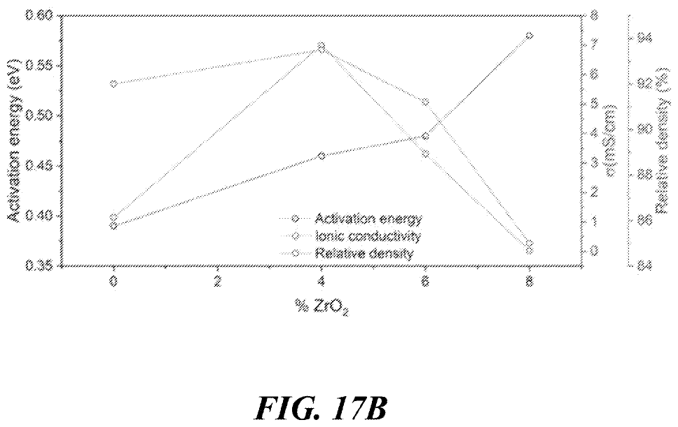

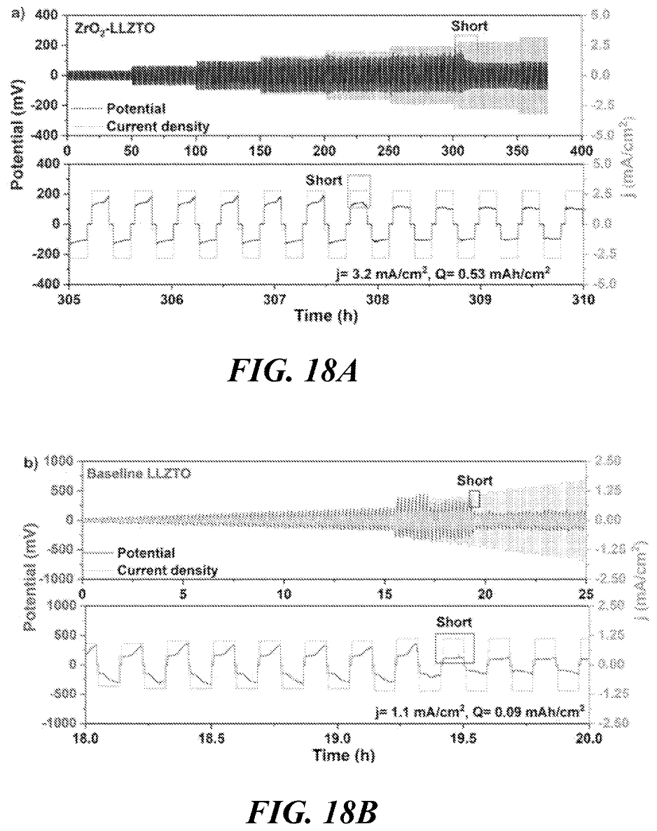

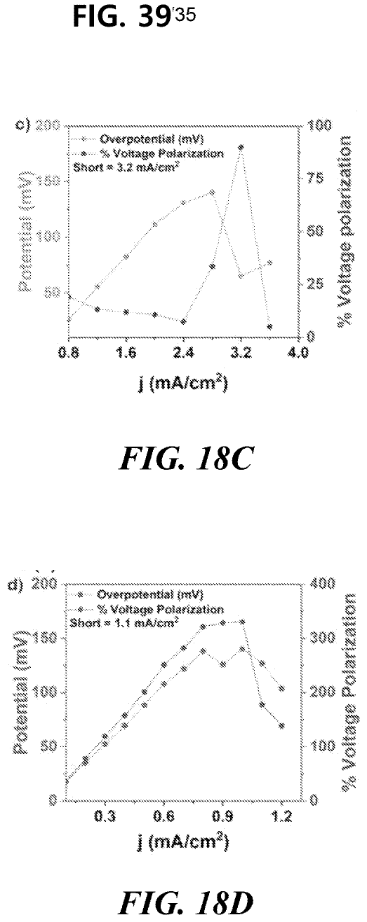

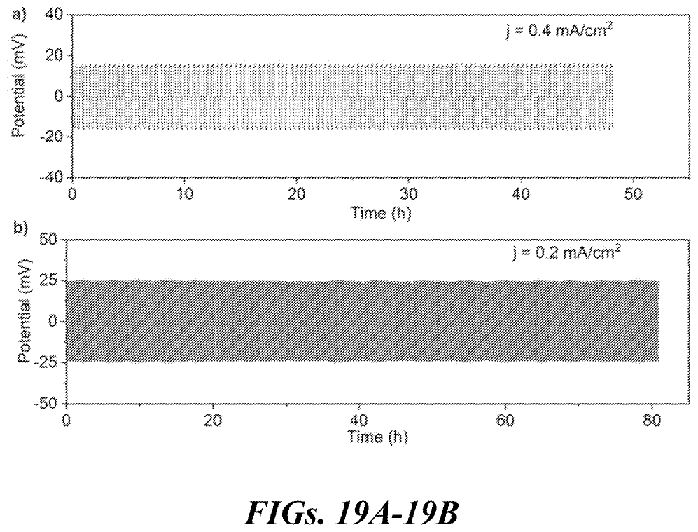

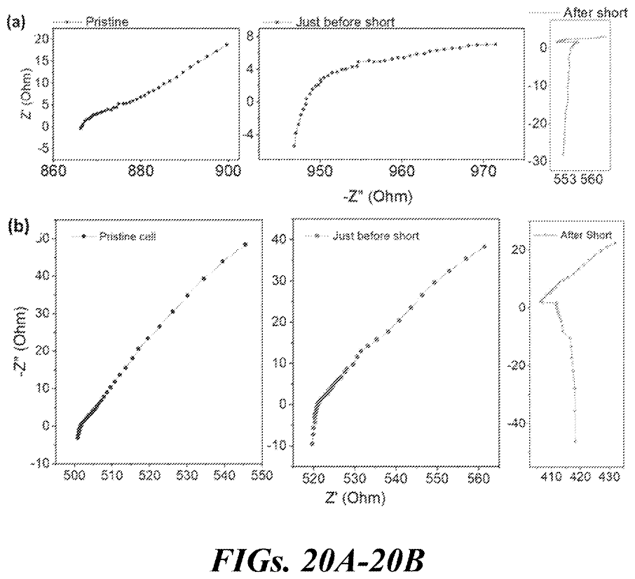

FIG. 18A and FIG. 19A display the galvanostatic analysis of symmetric cells based on Li metal and ZrO₂-LLZTO solid electrolyte. The cells were tested for critical current density (CCD). As shown in FIG. 19A, initially the cells were cycled at current density of 0.4 mA/cm² for a duration of 600 seconds. This corresponds to a capacity of 0.067 mAh/cm² per cycle. Then the cells were operated at increasing current density, starting from 0.8 mA/cm². The current density was increased with a step size of 0.4 mA/cm² with the capacity at each step corresponding what is achievable at 600 seconds. For example, at 0.8 mA/cm² this capacity was 0.13 mAh/cm², at 1.2 mA/cm² it was 0.26 mAh/cm². Since the capacity increases with increasing current density, the CCD at which the cell shorts should be conservatively low. Those results are shown in FIG. 18A. The cell cycled without any signature of short for 300 hours and at a high current density of 3.2 mA/cm² (capacity=0.53 mAh/cm²). FIG. 18C shows a plot of potential and polarization vs applied current density for the same ZrO₂-LLZTO cell. A drop in cell potential from 140 mV to 70 mV at a current density of 3.2 mA/cm² further confirms the electrical short in the cell. FIG. 20A shows the Nyquist plot at different stages of cell cycling. Upon electrical short circuiting there is a sudden drop in the impedance. A noticeable inductance loop can also be observed at high frequency regime (100 kHz) just before cell shorting.

FIG. 18B and FIG. 19B plot the galvanostatic behavior of a symmetric cell based on Li metal and baseline LLZTO. The cell displayed a poor electrochemical performance compared to ZrO₂-LLZTO symmetric cell and thus was subjected to a moderated galvanostatic cycling. First the cells were cycled at a constant current density of 0.2 mA/cm² for 80 hours corresponding to a capacity of 0.016 mAh/cm² for a duration of 300 seconds per cycle. The baseline LLZTO cell also displayed a stable voltage response with an average overpotential of 22 mV. Next the current density was increased in steps of 0.1 mA/cm² with capacity at each step corresponding to what was achievable in 300 seconds, e.g.: 0.024 mAh/cm² for 0.3 mA/cm² and so on. At each current density step, the cell was cycled for only 5 cycles instead of 120 cycles done for ZrO₂-LLZTO cell. Upon stepping up the current density the cell achieved a CCD of 1.1 mA/cm² corresponding to a capacity of 0.09 mAh/cm². FIG. 18D shows a plot of potential and polarization vs. applied current density for the same baseline LLZTO cell. A drop in cell potential from 140 mV to 127 mV at a current density of 1.1 mA/cm² further confirms the electrical short in the cell. For each cited study, the table provides the CCD or maximum current density, the maximum capacity, the maximum cycling duration, the temperature and stack pressure employed and a brief description of how LLZTO was modified. In general, the ZrO₂-LLZTO SSE displays a highly favorable combination of electrochemical properties compared to other SSE.

To further understand the role of ZrO₂-LLZTO microstructure on lithium electrodeposition/dissolution behavior, half-cells with an “empty” Cu current collector were fabricated and tested. A single galvanostatic plating step was performed at 0.2 mA/cm² for a duration of 7000 seconds. Such an electrochemical regiment in a half-cell configuration has been demonstrated to be well-suited for analyzing dendrite growth patterns in LLZTO.¹⁸ This architecture is also representative of anode-free all solid-state metal batteries (AF-ASSBs), where the entire Li supply is in the cathode. For the ZrO₂-LLZTO specimen an electrical short circuit occurred at lithium electrodeposition capacity of 0.3 mAh/cm², i.e. at 5400 seconds.

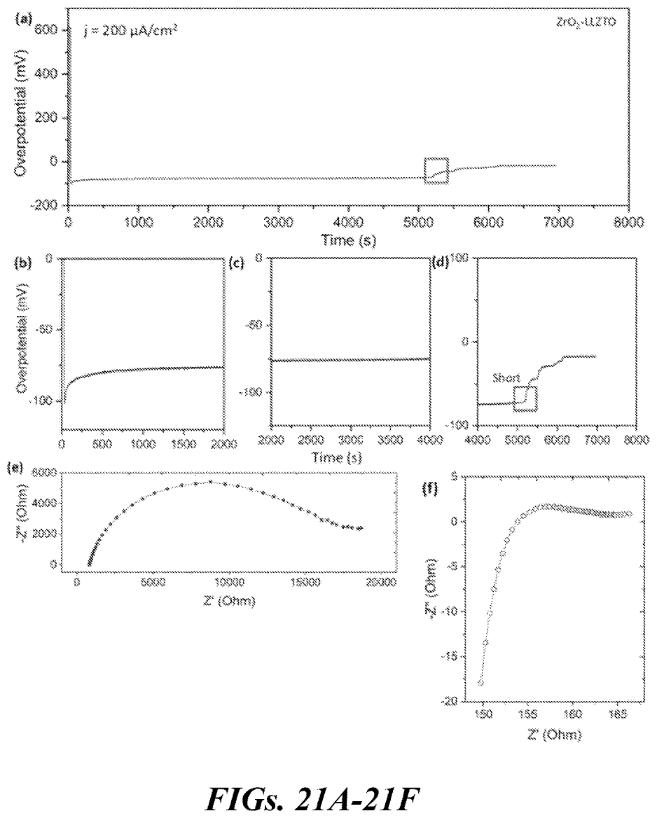

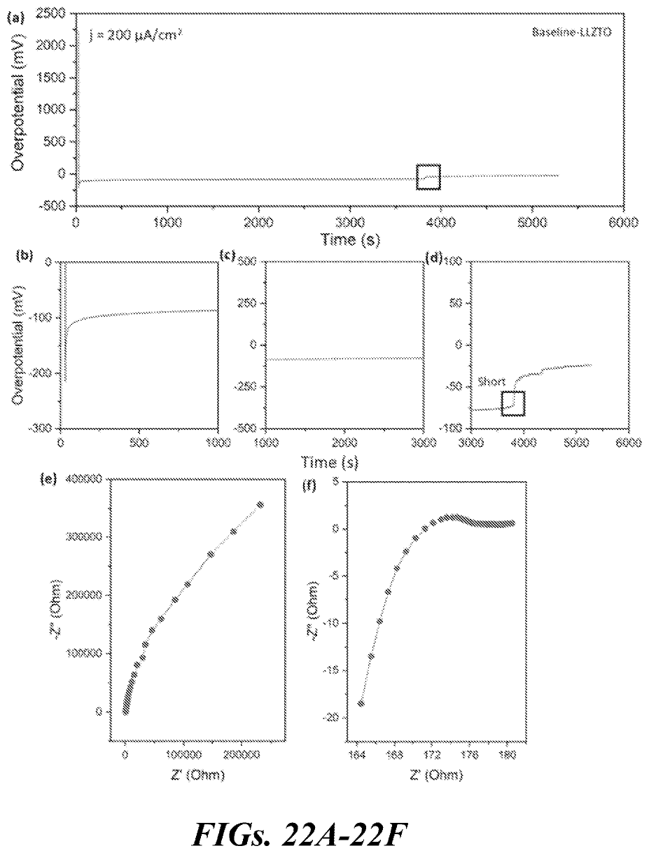

FIG. 21A shows this result. FIG. 21B displays a magnified section of the electrodeposition profile between 0-2000 seconds, highlighting the early-stage behavior. FIG. 21C displays the magnified section of the profile taken at 2000-4000 seconds, highlighting the behavior prior to electrical shorting. FIG. 21D displays the magnified section of the plating profile taken at 4000-7000 seconds highlighting the Ohmic resistance profiles during and after short. After 5200 seconds there is an abrupt drop in the overpotential remaining a constant at 21 mV, corresponding to the cell's Ohmic resistance. FIG. 21E and FIG. 21F present Nyquist plots for the as-assembled ZrO₂-LLZTO half-cell and for the cell after shorting. The Nyquist plot of the cell before and after the short circuit shows a drop in the Ohmic resistance and emergence of an inductance loop at high frequency of 100 kHz, further confirming the short in the cell. An identical single step galvanostatic experiment was applied for the baseline LLZTO half-cell. Electrical short circuiting occurred after a lithium plating of 0.2 mAh/cm². FIG. 22A shows the associated single galvanostatic plating profile. FIG. 22A-22F displays the magnified sections of the galvanostatic profiles and the associated EIS Nyquist plots.

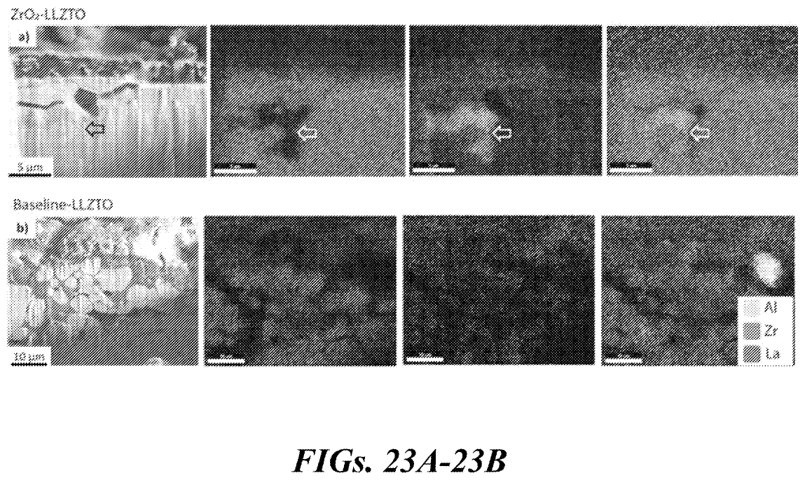

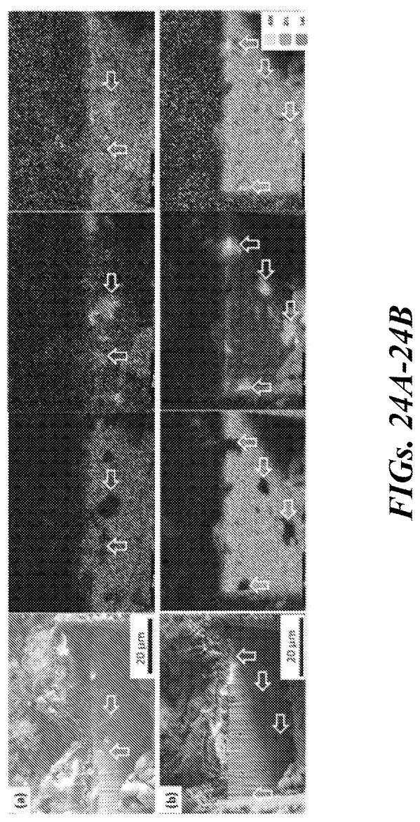

After the LLZTO-ZrO₂ and baseline LLZTO half-cells were short circuited, post-mortem cryogenic focused ion beam (cryo-FIB) SEM analysis was performed on the Li metal-electrolyte interfaces. FIG. 23A and FIG. 24A-24B compare cross-sectional SEM images of the ZrO₂-LLZTO cell. The metal-electrolyte interface is generally homogenous and intact, with no vertical growth of lithium metal being detected in the region that was analyzed. An example of a crack originating from the metal electrolyte interface and propagating into the SSE is shown in FIG. 23A. Imaging shows the ZrO₂ phase is serving to fill in the pores. The zirconia acts in a bridging role between adjacent LLTZO grains and prevents the crack from propagating through that interface due to its higher toughness. FIG. 23B shows a cross-sectional SEM image of the failed baseline LLZTO. The SEM image and the associated EDXS maps show isolated LLZTO gains that are encapsulated by a complex Li dendrite. The electrolyte microstructure literally falls apart near its interface with the working Li metal anode. Per FIG. 24A-24B, no such failure phenomenology is detected at the interface of Li metal and ZrO₂-LLZTO, instead, the grains remain intact.

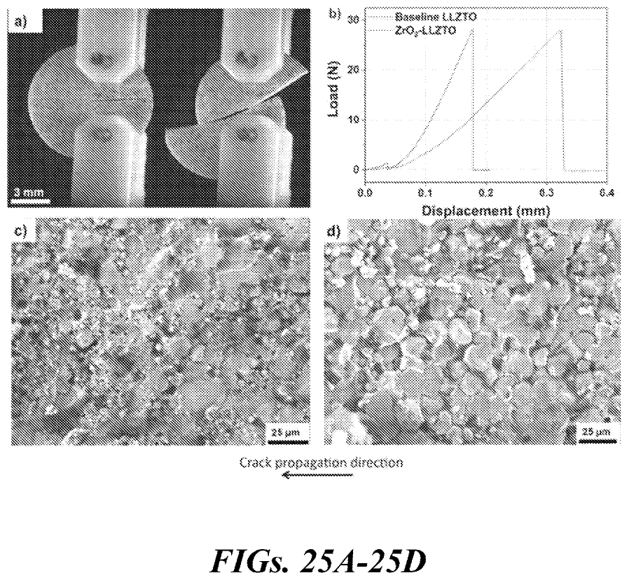

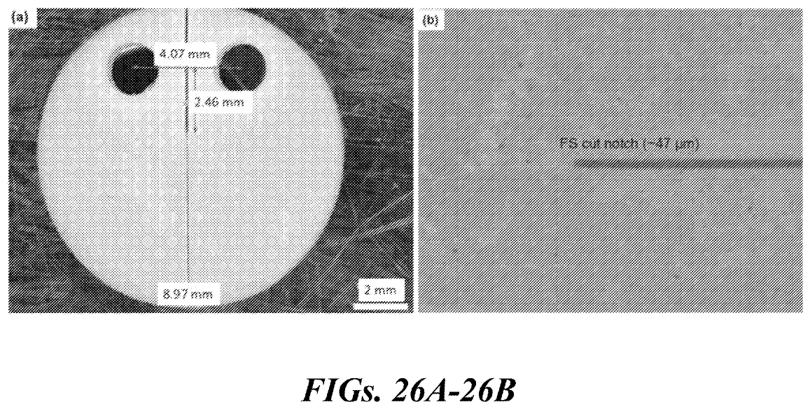

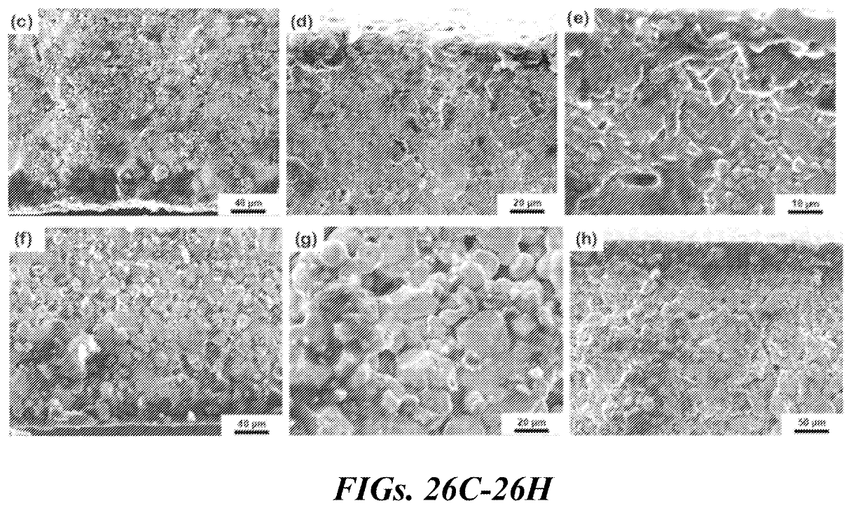

The fracture toughness K_{1C} values were determined on two samples for each of the ZrO₂-LLZTO and the baseline LLZTO. Values were measured for notches cut with either a nanosecond (NS) laser (~100 μm notch diameter) or a femtosecond (FS) laser (~30 μm notch diameter). FIG. 25A shows experimental setup for DCT fracture toughness measurement and DCT sample after fracture, using the FS Laser cut ZrO₂-LLZTO specimen as an example. FIG. 26A-26B illustrates the notch prepared using the FS laser. FIG. 25B shows load-displacement curve obtained from the DCT test, which was used to measure the K_{1C} value. In this case the data from FS Laser cut ZrO₂-LLZTO and baseline LLZTO are overlaid. The toughness K_{1C} values shown in Table 4, indicate that ZrO₂-LLZTO displayed an average 15% increase in the notched fracture toughness value versus the baseline. For the NS laser cut specimens, toughness increased from 1.19 to 1.33 MPa m^{0.5}, while for FS cut specimen it increased from 1.13 to 1.28 MPa m^{0.5}. A comparison of the fractured surfaces of ZrO₂-LLZTO versus the baseline LLZTO are displayed in FIG. 25C-25B and FIG. 26D-26I. These surfaces exhibit distinct characteristics, showcasing differences in fracture mechanisms. The baseline LLZTO samples primarily exhibit intergranular fracture, showcasing a brittle morphology reminiscent of grain boundary embrittlement. Some instances of brittle cleavage are observed. Conversely, the ZrO₂-LLZTO sample does not show a prevalence of intergranular fracture; instead, it displays a planar fracture surface indicative of transgranular fracture. The increase in toughness can be rationalized from the contribution of ZrO₂ effectively serving as a sintering aid, filling in many of the otherwise empty interstices between adjacent LLTZO grains. The corresponding improvement in toughness is commonly observed with the elimination of porosity in brittle materials^{49,50}, with the Zr-rich interstitial particles serving to bridge stresses across the pores between adjacent grains.

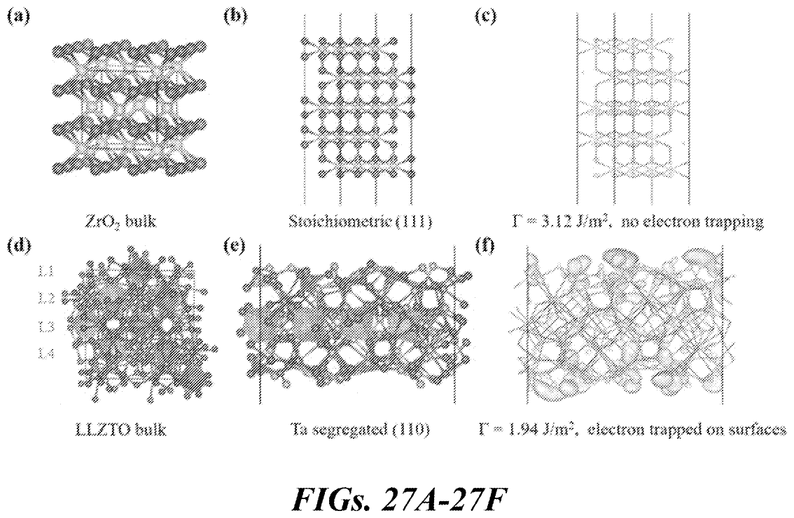

As discussed in the Introduction, there are several coupled factors and key mechanisms that facilitate dendrite propagation inside of LLZO. While these factors are intertwined in promoting enhanced electrochemical performance, simulations can isolate the individual contributions. To understand the difference between LLZTO and ZrO₂, DFT calculations were performed following the protocol by Tian et al.¹⁹ FIG. 27A-27F shows the relaxed bulk and the most stable (the easy cleaving) surface structures for ZrO₂ and LLZTO. The computed fracture energy, F, is 3.12 J/m² for ZrO₂(111) and 1.94 J/m² for LLZTO (110). This is consistent with the increased fracture toughness due to ZrO₂ modification. Other cleaved surfaces and corresponding fracture energy are provided in FIG. 27 and Table 3, respectively.

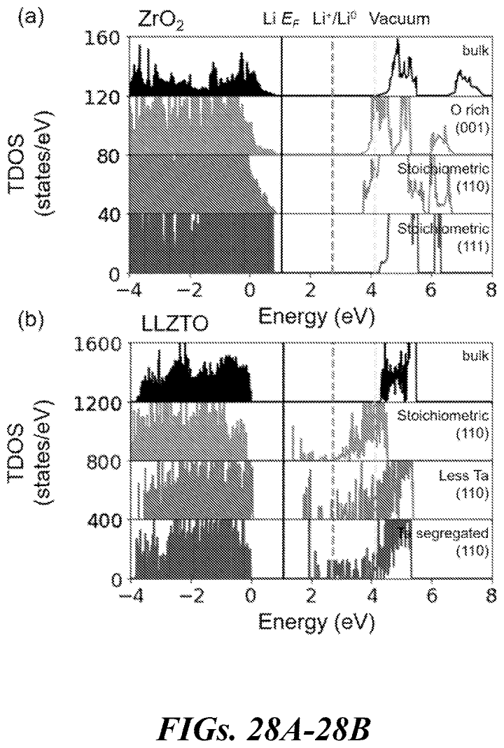

The electronic density of states (DOS, FIG. 28) of these two interfaces showed the bulk band gap for LLZTO is reduced from 4.31 eV to 1.95 eV on the Ta-segregated (110) surface shown in FIG. 27E and can be even lower on other surfaces. Moreover, these additional surface states are under the Li ion deposition potential, thus can trap electrons. But for ZrO₂, the (111) surface band gap does not show any significant decrease compared to the bulk (change from 3.54 eV to 3.47 eV). As dendrite propagation brings excess electrons inside of LLZTO, due to cracked surfaces, the locations of the excess electrons are very important. FIGS. 27C and 27F show the excess electrons are distributed across the whole ZrO₂ surface slab (FIG. 27C), while the majority of excess electrons are localized on the LLZTO surface (FIG. 27F), similar to the surface electron trapping seen on LLZO surfaces.⁵¹ The trapped electrons on the LLZTO surface, localized on the exposed cation orbitals (such as La), tend to nucleate with Li ions to form Li atoms inside the solid electrolyte,^{19,26} which eventually leads to the formation of Li dendrites. The excess electrons in ZrO₂ occupies the empty bands in the conduction bands, which mainly comes from Zr in the bulk. As the low energy ZrO₂(111) surface is O-terminated, no electrons are localized on the ZrO₂ surface, which is drastically different from LLZO or LLZTO. Therefore, the ZrO₂-LLZTO has ZrO₂ modified grain boundaries, which prevents electron accumulation seen in the baseline LLZTO, drastically improving its resistance to Li-dendrite nucleation and propagation.

The presence of ZrO₂ at the grain boundary modifies its ion transport and mechanical characteristics. As schematically illustrated in FIGS. 29A-29B, presence of grains and grain boundaries in the LLZTO microstructure gives rise to distinct Li/grain and Li/grain boundary interfaces. To investigate this phenomenon, an electro-chemo-mechanical model is developed. For the computational domain shown in FIG. 29B, the model captures the mechanical stresses within the SSE and Li metal, ionic transport within the SSE grain and grain boundary, and mechanics-coupled reaction kinetics at the Li/SSE interface. All details regarding the mathematical formulation are given in the Supporting Information.

FIG. 29C shows the effect of mechanical mismatch (Young's modulus ratio, E_{gb}/E_{g}) and transport mismatch (defined by a ion occupation descriptor χ=−RT ln(κ_{gb}/κ_{g}), where κ_{gb}/κ_{g} is the ionic conductivity ratio) between grain and grain boundary on reaction heterogeneity. Here, reaction heterogeneity is represented as the ratio of reaction current density at the Li/grain boundary interface to that at the Li/grain interface (i.e., i_{gb}/i_{g}). As observed in the figure, both E_{gb}/E_{g} and X affect the reaction distribution at the interface. While χ governs the ion occupation in grain and grain boundary, E_{gb}/E_{y} contributes via dictating mechanical overpotential arising due to interfacial stresses (Equation 4 in the Supplementary Information). Based on the reported values in literature^{30,52}, baseline LLZTO falls into the regime of i_{gb}/i_{g}>1, thereby favoring dendrite growth via current focusing on the grain boundaries. The corresponding reaction current profiles for the baseline and toughened LLZTO are shown in FIG. 29D. Overall, results presented in FIGS. 29C-29D indicate that the preferential deposition within the grain boundaries governs the dendrite growth and failure mechanism for baseline LLZTO.

To further investigate the failure mechanism for toughened LLZTO, fracture mechanics analysis is conducted, as presented in FIGS. 29E-29F. For a crack propagating through the SSE grain and encountering the grain boundary, the figure demarcates the crack deflection and crack penetration regimes as a function of Dundurs' parameter α=(Ē_{gb}−Ē_{g})/(Ē_{gb}+Ē_{g}), where Ē=E/(1−ν²), and fracture toughness ratio, Gᵢ/G_{gb}, as proposed by He and Hutchinson.⁵³ By substituting the mechanical properties of LLZTO grain and zirconia-toughened grain boundary into this analysis, we find that the toughened LLZTO falls into the crack deflection regime, as shown in FIG. 29E. Thus, the presence of a toughened grain boundary not only prevents preferential Li deposition within the grain boundaries but also acts as a mechanical barrier for crack propagation.

In summary, this was the first report of second-phase zirconium oxide modified lithium lanthanum zirconium tantalum oxide (LLZTO) solid-state electrolyte (SSE). The demonstrated approach is straightforward and scalable. It is based on the in-situ reaction of a TaC additive with as-fabricated LLZTO powder during compact sintering, with the Density Functional Theory (DFT) analysis supporting the thermodynamic feasibility of the proposed high temperature chemistry. DFT and mesoscale modeling are also employed to explain the resulting changes in the mechanical toughness and electronic properties of the LLZTO grain boundaries due to zirconia. Cryogenic FIB-SEM analysis of cycled electrolyte illustrates how the zirconia suppresses intergranular dendrite propagation at the Li-SSE interface versus the baseline. These combined attributes lead to a major improvement of the electrochemical performance of composite “ZrO₂-LLZTO” versus an unmodified baseline.

### Exemplary Aspects

Exemplary aspect 1. An electrochemical cell comprising: a solid-state electrolyte comprising two or more separate phases; wherein at least one phase is an ion-conductive phase; and wherein at least one phase is a toughening phase.

Exemplary aspect 2. The electrochemical cell of exemplary aspect 1, wherein the toughening phase is structurally and/or chemically different from the ion-conductive phase.

Exemplary aspect 3. The electrochemical cell of exemplary aspects 1 or 2, wherein the solid-state electrolyte comprises a bulk and a first and a second surface.

Exemplary aspect 4. The electrochemical cell of exemplary aspect 3, wherein the ion-conductive phase is dispersed through the bulk of the solid-state electrolyte and wherein the toughening phase is dispersed at one or more grain boundaries of the ion-conductive phase.

Exemplary aspect 5. The electrochemical cell of exemplary aspect 3, wherein the solid-state electrolyte comprises two or more ion-conductive phases and two or more toughening phases, wherein at least one of the two or more toughening phases behave as an interphase between at least two of the two or more ion-conductive phases.

Exemplary aspect 6. The electrochemical cell of exemplary aspect 3, wherein the toughening phase is disposed on at least the first and/or the second surface of the solid-state electrolyte.

Exemplary aspect 7. The electrochemical cell of any one of exemplary aspects 1-6, wherein the toughening phase is ion-conductive or ion-insulating.

Exemplary aspect 8. The electrochemical cell of any one of exemplary aspects 1-6, wherein the toughening phase is electron insulating.

Exemplary aspect 9. The electrochemical cell of any one of exemplary aspects 1-8, wherein the toughening phase prevents dendrites and/or fractures during cell operation and/or storage.

Exemplary aspect 10. The electrochemical cell of any one of exemplary aspects 1-9, wherein the toughening phase comprises ZrO₂, Y₂O₃, Yttria-stabilized zirconia (YSZ), (ZrO₂)₁₋ₓ(Y₂O₃)ₓ where 0.001≤x≤0.999, zirconia toughened alumina (ZTA) based on xZrO₂-yAl₂O₃ where x+y=1, mixed oxide ceramics, 20% ZrO₂ and 80% Al₂O₃, magnesium oxide ceramics, MgO, beryllium oxide ceramics, BeO, mullite ceramics based on x(Al₂O₃)y(SiO₂) where x=2 and y=3 or x=2 and y=1, zirconia toughened mullite (ZTM) based on x(ZrO₂)_{y}(Al₂O₃)z(SiO₂) where x=0.25, y=2 and z=3, phase transforming ceramics, PZT lead zirconate titanate Pb[ZrₓTi₁₋ₓ]O₃ where 0<x≤1, oxygen-rich or oxygen-deficient versions thereof, alloys thereof, multiphase composites thereof, or a combination thereof.

Exemplary aspect 11. The electrochemical cell of any one of exemplary aspects 1-10, wherein the toughening phase exhibits morphology of equiaxed spherical, cuboidal, ill-defined particulate, plate-like, whiskers, or combinations thereof.

Exemplary aspect 12. The electrochemical cell of any one of exemplary aspects 1-11, wherein toughening phase blocks cracks and dendrites in the solid-state electrolyte through primary and through secondary crack deflection mechanisms.

Exemplary aspect 13. The electrochemical cell of any one of exemplary aspects 1-12, wherein the toughening phase is present in the solid-state electrolyte in a range from about 0.01% to about 50% by weight.

Exemplary aspect 14. The electrochemical cell of any one of exemplary aspects 1-13, wherein the ion-conductive phase comprises oxides, sulfides, borides, phosphides and other inorganic systems.

Exemplary aspect 15. The electrochemical cell of exemplary aspect 14, wherein the ion-conductive phase comprises garnets, argyrodites, lithium phosphorus oxynitrides, NASICON-type, LISICON-types, beta-alumina, sulfides and halides, thiophosphates, or combinations thereof.

Exemplary aspect 16. The electrochemical cell of any one of exemplary aspects 14-15, wherein the ion-conductive phase comprises pure or dopped LLZO (Li₇La₃Zr₂O₁₂); Li₆AS₅X, wherein A=P, Sb and X═Cl, Br, I; or Na₃AB₄ or K₃AB₄, wherein A is P, Sb, or As and B is S or Se.

Exemplary aspect 17. The electrochemical cell of exemplary aspect 16, wherein the ion-conductive phase is doped with Ta, Nb, Zr, Mg, B, Si, Mo, or any combination thereof.

Exemplary aspect 18. The electrochemical cell of any one of exemplary aspects 1-17, wherein the ion-conductive phase exhibits ionic conductivity from about 5.0×10⁻⁶ to about 1.0×10⁻¹ S/m or more.

Exemplary aspect 19. The electrochemical cell of any one of exemplary aspects 1-18, further comprising an anode material.

Exemplary aspect 20. The electrochemical cell of exemplary aspect 19, wherein the anode material comprises Li, Na, K, Zn, Mg, Li alloys, Li intermetallics, Li compounds, Na alloys, Na intermetallics, Na compounds, K alloys, K intermetallics, K compounds, Si, Si alloys, Si compounds or any combination thereof.

Exemplary aspect 21. The electrochemical cell of any one of exemplary aspects 1-20, further comprising a cathode material.

Exemplary aspect 22. The electrochemical cell of exemplary aspect 21, wherein the cathode material is a metal, a ceramic, or a composite.

Exemplary aspect 23. The electrochemical cell of exemplary aspect 22, wherein the cathode material comprises copper, carbon, graphite, sodium, potassium, lithium, magnesium, calcium, aluminum, layered oxides, vanadium-based cathode, sulfur-based cathode, spinels, olivines, or any combination thereof.

Exemplary aspect 24. The electrochemical cell of any one of exemplary aspects 3-23, therein the first and/or second surface of the solid-state electrolyte comprises a layer comprising Ga, Al₂O₃, or a combination thereof.

Exemplary aspect 25. The electrochemical cell of any one of exemplary aspects 3-24, wherein at least one phase is an electron-conductive phase.

Exemplary aspect 26. The electrochemical cell of exemplary aspect 25, wherein the electron-conductive phase is disposed on the first or the second surface of the solid-state electrolyte.

Exemplary aspect 27. The electrochemical cell of any one of exemplary aspects 1-26, where the electrochemical cell exhibits continuous plating of about 0.01 mAh/cm⁻² to about 10 mAh/cm⁻² operating at 25-100° C. for 2-5000 cycles.

Exemplary aspect 28. A method comprising: incorporating at least one toughening additive into a solid-state electrolyte.

Exemplary aspect 29. The method of exemplary aspect 28, wherein the at least one toughening additive is incorporated into the solid-state electrolyte by any of mixing, milling or sintering, post-sintering impregnation and post-sintering surface coating based on physical or chemical vapor deposited thin films, or wet chemical synthesis.

Exemplary aspect 30. The method of exemplary aspect 28 or 29, wherein the toughening additive melts, reacts, dissolves, phase transforms, or precipitates during processing.

Exemplary aspect 31. The method of any one of exemplary aspects 28-30, wherein the toughening additive comprises a metal carbide.

Exemplary aspect 32. The method of any one of exemplary aspects 28-30, wherein the toughening additive comprises a metal oxide.

Exemplary aspect 33. The method of any one of exemplary aspects 28-30, wherein the toughening additive comprises a metal nitride.

Exemplary aspect 34. The method of any one of exemplary aspects 28-30, wherein the toughening additive comprises a metal oxynitride.

Exemplary aspect 35. The method of any one of exemplary aspects 28-30, wherein the toughening additive comprises a metal boride.

Exemplary aspect 36. The method of any one of exemplary aspects 28-30, wherein the toughening additive comprises TaC, MoC, SiC, WC, WC—(Fe, Ni, C), TiC, TaC, NbC, WC—Co, carbon rich or carbon deficient versions of thereof, alloys thereof, multiphase composites thereof, or a combination thereof.

Exemplary aspect 37. The method of any one of exemplary aspects 28-30, wherein the toughening additive comprises TaN, MoN, SiN, W3N2, TiN, NbN, nitrogen rich or nitrogen deficient versions thereof, alloys thereof, multiphase composites thereof, or a combination thereof.

Exemplary aspect 38. The method of any one of exemplary aspects 28-30, wherein the toughening additive comprises TaNxO1-x where 0.001≤x≤0.999, MoNₓO₁₋ₓ, SiNₓO₁₋ₓ, W₃N₂ₓO₁₋ₓ, TiNₓO₁₋ₓ, NbNₓO₁₋ₓ, nitrogen rich or nitrogen deficient versions of thereof, alloys thereof, multiphase composites thereof, or a combination thereof.

Exemplary aspect 39. The method of any one of exemplary aspects 28-30, wherein the toughening additive comprises (TaB₂), ZrB₂ and HfB₂, boron rich or boron deficient versions of thereof, alloys thereof, borides containing oxygen, TaB₂O₁₋ₓ where 0.001≤x≤0.999, multiphase composites thereof, or a combination thereof.

Exemplary aspect 40. The method of any one of exemplary aspects 28-30, wherein the toughening additive comprises metal dichalcogenides.

Exemplary aspect 41. The method of any one of exemplary aspects 28-30, wherein the toughening additive comprises Te, Se, S, MoS₂, MoSe₂, MoTe₂, WS₂, and/or WSe₂.

Exemplary aspect 42. The method of any one of exemplary aspects 28-41, wherein the toughening additive promotes densification of the solid-state electrolyte during sintering, resulting in higher final compact density of the solid-state electrolyte comprising the toughening agent than for a given processing regiment of a solid-state electrolyte not comprising the toughening additive.

Exemplary aspect 43. The method of any one of exemplary aspects 28-42, wherein the toughening additive is about 5% by weight of the solid-state electrolyte.

Exemplary aspect 44. The method of any one of exemplary aspects 28-43, wherein the solid-state electrolyte comprises one of oxides, sulfides, borides, phosphides, and combinations thereof.

Exemplary aspect 45. The method of any one of exemplary aspects 28-44, wherein the solid-state electrolyte comprises garnets, argyrodites, lithium phosphorus oxynitrides, NASICON-type, LISICON-types, beta-alumina, sulfides and halides, thiophosphates, or combinations thereof.

Exemplary aspect 46. The method of any one of exemplary aspects 28-45, wherein the solid-state electrolyte comprises pure or dopped LLZO (Li₇La₃Zr₂O₁₂); Li₆AS₅X, wherein A=P, Sb and X═Cl, Br, I; or Na₃AB₄ or K₃AB₄, wherein A is P, Sb, or As and B is S or Se.

Exemplary aspect 47. The method of any one of exemplary aspects 28-46, wherein the solid-state electrolyte is doped with Ta, Nb, Zr, Mg, B, Si, Mo, or any combination thereof.

Exemplary aspect 48. The method of any one of exemplary aspects 28-47, further comprising providing an electron-conductive phase onto one or more surfaces of the solid-state electrolyte.

### REFERENCES

1. Luntz, A. (2015). Beyond Lithium Ion Batteries. J. Phys. Chem. Lett. 6, 300-301.
2. Nitta, N., Wu, F., Lee, J. T., and Yushin, G. (2015). Li-ion battery materials: present and future. Mater. Today 18, 252-264.
3. Randau, S., Weber, D. A., Kötz, O., Koerver, R., Braun, P., Weber, A., Ivers-Tiffée, E., Adermann, T., Kulisch, J., Zeier, W. G., et al. (2020). Benchmarking the performance of all-solid-state lithium batteries. Nat. Energy 5, 259-270.
4. Trahey, L., Brushett, F. R., Balsara, N. P., Ceder, G., Cheng, L., Chiang, Y.-M., Hahn, N. T., Ingram, B. J., Minteer, S. D., Moore, J. S., et al. (2020). Energy storage emerging: A perspective from the Joint Center for Energy Storage Research. Proc. Natl. Acad. Sci. USA 117, 12550-12557.
5. Li, W., Zhu, J., Xia, Y., Gorji, M. B., and Wierzbicki, T. (2019). Data-Driven Safety Envelope of Lithium-Ion Batteries for Electric Vehicles. Joule 3, 2703-2715.
6. Nanda, S., Bhargav, A., and Manthiram, A. (2020). Anode-free, Lean-Electrolyte Lithium-Sulfur Batteries Enabled by Tellurium-Stabilized Lithium Deposition. Joule 4, 1121-1135.
7. Evans, A., Strezov, V., and Evans, T. J. (2012). Assessment of utility energy storage options for increased renewable energy penetration. Renew. Sust. Energ. Rev., 16, 4141-4147.
8. Famprikis, T., Canepa, P., Dawson, J. A., Islam, M. S., and Masquelier, C. (2019). Fundamentals of inorganic solid-state electrolytes for batteries. Nat. Mater. 18, 1278-1291.
9. Cano, Z. P., Banham, D., Ye, S., Hintennach, A., Lu, J., Fowler, M., and Chen, Z. (2018). Batteries and fuel cells for emerging electric vehicle markets. Nat. Energy 3, 279-289.
10. Liu, Y., Zhu, Y., and Cui, Y. (2019). Challenges and opportunities towards fast-charging battery materials. Nat. Energy 4, 540-550.
11. Schmuch, R., Wagner, R., Hörpel, G., Placke, T., and Winter, M. (2018). Performance and cost of materials for lithium-based rechargeable automotive batteries. Nat. Energy 3, 267-278.
12. Choi, J. W., and Aurbach, D. (2016). Promise and reality of post-lithium-ion batteries with high energy densities. Nat. Rev. Mater., 1, 16013.
13. Olivetti, E. A., Ceder, G., Gaustad, G. G., and Fu, X. (2017). Lithium-Ion Battery Supply Chain Considerations: Analysis of Potential Bottlenecks in Critical Metals. Joule 1, 229-243.
14. Qiao, Y., Deng, H., He, P., and Zhou, H. (2020). A 500 Wh/kg Lithium-Metal Cell Based on Anionic Redox. Joule 4, 1445-1458.
15. Yu, Z., Wang, H., Kong, X., Huang, W., Tsao, Y., Mackanic, D. G., Wang, K., Wang, X., Huang, W., Choudhury, S., et al. (2020). Molecular design for electrolyte solvents enabling energy-dense and long-cycling lithium metal batteries. Nat. Energy 5, 526-533.
16. Kuhn, A., Kunze, M., Sreeraj, P., Wiemhöfer, H.-D., Thangadurai, V., Wilkening, M., and Heitjans, P. (2012). NMR relaxometry as a versatile tool to study Li ion dynamics in potential battery materials. Solid State Nucl. Mag. 42, 2-8.
17. Liu, P., and Mitlin, D. (2020). Emerging Potassium Metal Anodes: Perspectives on Control of the Electrochemical Interfaces. Acc. Chem. Res. 53, 1161-1175.
18. Sun, B., Xiong, P., Maitra, U., Langsdorf, D., Yan, K., Wang, C., Janek, J., Schroder, D., and Wang, G. (2020). Design Strategies to Enable the Efficient Use of Sodium Metal Anodes in High-Energy Batteries. Adv. Mater. 32, 1903891.
19. Cheng, X.-B., Zhang, R., Zhao, C.-Z., and Zhang, Q. (2017). Toward Safe Lithium Metal Anode in Rechargeable Batteries: A Review. Chem. Rev. 117, 10403-10473.
20. Sun, H., Zhu, G., Xu, X., Liao, M., Li, Y.-Y., Angell, M., Gu, M., Zhu, Y., Hung, W. H., Li, J., et al. (2019). A safe and non-flammable sodium metal battery based on an ionic liquid electrolyte. Nat. Commun. 10, 3302.
21. Casimir, A., Zhang, H., Ogoke, O., Amine, J. C., Lu, J., and Wu, G. (2016). Silicon-based anodes for lithium-ion batteries: Effectiveness of materials synthesis and electrode preparation. Nano Energy 27, 359-376.
22. Xu, J., Dou, Y., Wei, Z., Ma, J., Deng, Y., Li, Y., Liu, H., and Dou, S. (2017). Recent Progress in Graphite Intercalation Compounds for Rechargeable Metal (Li, Na, K, Al)-Ion Batteries. Adv. Sci. 4, 1700146.
23. Ruther, R. E., Hays, K. A., An, S. J., Li, J., Wood, D. L., and Nanda, J. (2018). Chemical Evolution in Silicon-Graphite Composite Anodes Investigated by Vibrational Spectroscopy. ACS Appl. Mater. Interfaces 10, 18641-18649.
24. Kumar, S. K., Ghosh, S., Malladi, S. K., Nanda, J., and Martha, S. K. (2018). Nanostructured Silicon-Carbon 3D Electrode Architectures for High-Performance Lithium-Ion Batteries. ACS Omega 3, 9598-9606.
25. Kasemchainan, J., Zekoll, S., Spencer Jolly, D., Ning, Z., Hartley, G. O., Marrow, J., and Bruce, P. G. (2019). Critical stripping current leads to dendrite formation on plating in lithium anode solid electrolyte cells. Nat. Mater. 18, 1105-1111.
26. Han, F., Westover, A. S., Yue, J., Fan, X., Wang, F., Chi, M., Leonard, D. N., Dudney, N. J., Wang, H., and Wang, C. (2019). High electronic conductivity as the origin of lithium dendrite formation within solid electrolytes. Nat. Energy 4, 187-196.
27. Sun, Y.-K. (2020). Promising All-Solid-State Batteries for Future Electric Vehicles. ACS Energy Lett. 5, 3221-3223.
28. Cao, D., Sun, X., Li, Q., Natan, A., Xiang, P., and Zhu, H. (2020). Lithium Dendrite in All-Solid-State Batteries: Growth Mechanisms, Suppression Strategies, and Characterizations. Matter 3, 57-94.
29. Kato, Y., Hori, S., Saito, T., Suzuki, K., Hirayama, M., Mitsui, A., Yonemura, M., Iba, H., and Kanno, R. (2016). High-power all-solid-state batteries using sulfide superionic conductors. Nat. Energy 1, 16030.
30. Lee, Y.-G., Fujiki, S., Jung, C., Suzuki, N., Yashiro, N., Omoda, R., Ko, D.-S., Shiratsuchi, T., Sugimoto, T., Ryu, S., et al. (2020). High-energy long-cycling all-solid-state lithium metal batteries enabled by silver-carbon composite anodes. Nat. Energy 5, 299-308.
31. Wang, Y., Richards, W. D., Ong, S. P., Miara, L. J., Kim, J. C., Mo, Y., and Ceder, G. (2015). Design principles for solid-state lithium superionic conductors. Nat. Mater. 14, 1026-1031.
32. Krauskopf, T., Richter, F. H., Zeier, W. G., and Janek, J. (2020). Physicochemical Concepts of the Lithium Metal Anode in Solid-State Batteries. Chem. Rev., 120, 7745-7794.
33. Gao, Y., Nolan, A. M., Du, P., Wu, Y., Yang, C., Chen, Q., Mo, Y., and Bo, S.-H. (2020). Classical and Emerging Characterization Techniques for Investigation of Ion Transport Mechanisms in Crystalline Fast Ionic Conductors. Chem. Rev. 120, 5954-6008.
34. Banerjee, A., Wang, X., Fang, C., Wu, E. A., and Meng, Y. S. (2020). Interfaces and Interphases in All-Solid-State Batteries with Inorganic Solid Electrolytes. Chem. Rev. 120, 6878-6933.
35. Nolan, A. M., Zhu, Y., He, X., Bai, Q., and Mo, Y. (2018). Computation-Accelerated Design of Materials and Interfaces for All-Solid-State Lithium-Ion Batteries. Joule 2, 2016-2046.
36. Bao, C., Wang, B., Liu, P., Wu, H., Zhou, Y., Wang, D., Liu, H., and Dou, S. (2020). Solid Electrolyte Interphases on Sodium Metal Anodes. Advanced Functional Materials 30, 2004891.
37. Cui, G. (2020). Reasonable Design of High-Energy-Density Solid-State Lithium-Metal Batteries. Matter 2, 805-815.
38. Kalaga, K., Rodrigues, M.-T. F., Gullapalli, H., Babu, G., Arava, L. M. R., and Ajayan, P. M. (2015). Quasi-Solid Electrolytes for High Temperature Lithium Ion Batteries. ACS Appl. Mater. Interfaces 7, 25777-25783.
39. Jaumaux, P., Wu, J., Shanmukaraj, D., Wang, Y., Zhou, D., Sun, B., Kang, F., Li, B., Armand, M., and Wang, G. (2021). Non-Flammable Liquid and Quasi-Solid Electrolytes toward Highly-Safe Alkali Metal-Based Batteries. Advanced Functional Materials 31, 2008644.
40. Guo, X., Bae, J., Ding, Y., Zhang, X., and Yu, G. (2021). Liquid Alloy Enabled Solid-State Batteries for Conformal Electrode-Electrolyte Interfaces. Adv. Funct. Mater. 31, 2010863.
41. Gao, X., Zheng, X., Wang, J., Zhang, Z., Xiao, X., Wan, J., Ye, Y., Chou, L.-Y., Lee, H. K., Wang, J., et al. (2020). Incorporating the Nanoscale Encapsulation Concept from Liquid Electrolytes into Solid-State Lithium-Sulfur Batteries. Nano Lett. 20, 5496-5503.
42. Wang, C., Fu, K., Kammampata, S. P., McOwen, D. W., Samson, A. J., Zhang, L., Hitz, G. T., Nolan, A. M., Wachsman, E. D., Mo, Y., et al. (2020). Garnet-Type Solid-State Electrolytes: Materials, Interfaces, and Batteries. Chem. Rev. 120, 4257-4300.
43. Ding, Y.-L., Kopold, P., Hahn, K., van Aken, P. A., Maier, J., and Yu, Y. (2016). Facile Solid-State Growth of 3D Well-Interconnected Nitrogen-Rich Carbon Nanotube-Graphene Hybrid Architectures for Lithium-Sulfur Batteries. Adv. Funct. Mater. 26, 1112-1119.
44. Pang, Y., Pan, J., Yang, J., Zheng, S., and Wang, C. (2021). Electrolyte/Electrode Interfaces in All-Solid-State Lithium Batteries: A Review. Electrochem. Energy Rev. 4, 169-193.
45. Bae, J., Zhang, X., Guo, X., and Yu, G. (2021). A General Strategy of Anion-Rich High-Concentration Polymeric Interlayer for High-Voltage, All-Solid-State Batteries. Nano Lett. 21, 1184-1191.
46. Yuan, H., Li, H., Zhang, T., Li, G., He, T., Du, F., and Feng, S. (2018). A K2Fe4O7 superionic conductor for all-solid-state potassium metal batteries. J. Mater. Chem. A 6, 8413-8418.
47. Fuchs, T., Culver, S. P., Till, P., and Zeier, W. G. (2020). Defect-Mediated Conductivity Enhancements in Na₃₋ₓPn₁₋ₓWₓS₄ (Pn=P, Sb) Using Aliovalent Substitutions. ACS Energy Lett. 5, 146-151.
48. Hayashi, A., Masuzawa, N., Yubuchi, S., Tsuji, F., Hotehama, C., Sakuda, A., and Tatsumisago, M. (2019). A sodium-ion sulfide solid electrolyte with unprecedented conductivity at room temperature. Nat. Commun. 10, 5266.
49. Dolle, M., Sannier, L., Beaudoin, B., Trentin, M., and Tarascon, J.-M. Live Scanning Electron Microscope Observations of Dendritic Growth in Lithium/Polymer Cells. Electrochem. Solid ST. 5, A286-A289.
50. Zhao, F., Alahakoon, S. H., Adair, K., Zhang, S., Xia, W., Li, W., Yu, C., Feng, R., Hu, Y., Liang, J., et al. (2021). An Air-Stable and Li-Metal-Compatible Glass-Ceramic Electrolyte enabling High-Performance All-Solid-State Li Metal Batteries. Adv. Mater. 33, 2006577
51. Liang, J., Chen, N., Li, X., Li, X., Adair, K. R., Li, J., Wang, C., Yu, C., Norouzi Banis, M., Zhang, L., et al. (2020). Li₁₀Ge(P₁₋ₓSbₓ)₂S₁₂ Lithium-Ion Conductors with Enhanced Atmospheric Stability. Chem. Mater. 32, 2664-2672.
52. Jung, W. D., Jeon, M., Shin, S. S., Kim, J.-S., Jung, H.-G., Kim, B.-K., Lee, J.-H., Chung, Y.-C., and Kim, H. (2020). Functionalized Sulfide Solid Electrolyte with Air-Stable and Chemical-Resistant Oxysulfide Nanolayer for All-Solid-State Batteries. ACS Omega 5, 26015-26022.
53. Wang, H., Chen, Y., Hood, Z. D., Sahu, G., Pandian, A. S., Keum, J. K., An, K., and Liang, C. (2016). An Air-Stable Na₃SbS₄ Superionic Conductor Prepared by a Rapid and Economic Synthetic Procedure. Angew. Chem. 128, 8693-8697.
54. Karasulu, B., Emge, S. P., Groh, M. F., Grey, C. P., and Morris, A. J. (2020). AI/Ga-Doped Li₇La₃Zr₂O₁₂ Garnets as Li-Ion Solid-State Battery Electrolytes: Atomistic Insights into Local Coordination Environments and Their Influence on ¹⁷O, ²⁷Al, and ⁷¹Ga NMR Spectra. J. Am. Chem. Soc. 142, 3132-3148.
55. Sheng, O., Jin, C., Ding, X., Liu, T., Wan, Y., Liu, Y., Nai, J., Wang, Y., Liu, C., and Tao, X. (2021). A Decade of Progress on Solid-State Electrolytes for Secondary Batteries: Advances and Contributions. Adv. Funct.l Mater. 31, 2100891.
56. Wang, C., Liang, J., Zhao, Y., Zheng, M., Li, X., and Sun, X. (2021). All-solid-state lithium batteries enabled by sulfide electrolytes: from fundamental research to practical engineering design. Energy Environ. Sci. 14, 2577-2619.
57. Lu, Y., Zhao, C.-Z., Yuan, H., Cheng, X.-B., Huang, J.-Q., and Zhang, Q. (2021). Critical Current Density in Solid-State Lithium Metal Batteries: Mechanism, Influences, and Strategies. Adv. Funct. Mater. 31, 2009925.
58. Gao, W., Singh, N., Song, L., Liu, Z., Reddy, A. L. M., Ci, L., Vajtai, R., Zhang, Q., Wei, B., and Ajayan, P. M. (2011). Direct laser writing of micro-supercapacitors on hydrated graphite oxide films. Nat. Nanotech. 6, 496-500.
59. Ashby, D. S., Choi, C. S., Edwards, M. A., Talin, A. A., White, H. S., and Dunn, B. S. (2020). High-Performance Solid-State Lithium-Ion Battery with Mixed 2D and 3D Electrodes. ACS Appl. Energy Mater. 3, 8402-8409.
60. Lang, J., Jin, Y., Liu, K., Long, Y., Zhang, H., Qi, L., Wu, H., and Cui, Y. (2020). High-purity electrolytic lithium obtained from low-purity sources using solid electrolyte. Nat. Sustain. 3, 386-390.
61. Chen, C., Jiang, M., Zhou, T., Raijmakers, L., Vezhlev, E., Wu, B., Schulli, T. U., Danilov, D. L., Wei, Y., Eichel, R.-A., et al. (2021). Interface Aspects in All-Solid-State Li-Based Batteries Reviewed. Adv. Energy Mater. 11, 2003939.
62. Wang, H., Zhu, J., Su, Y., Gong, Z., and Yang, Y. (2021). Interfacial compatibility issues in rechargeable solid-state lithium metal batteries: a review. Sci. China Chem. 64, 879-898.
63. Meng, N., Lian, F., and Cui, G. (2021). Macromolecular Design of Lithium Conductive Polymer as Electrolyte for Solid-State Lithium Batteries. Small 17, 2005762.
64. Dwibedi, D., Araujo, R. B., Chakraborty, S., Shanbogh, P. P., Sundaram, N. G., Ahuja, R., and Barpanda, P. (2015). Na_{2.44}Mn_{1.79}(SO₄)₃: a new member of the alluaudite family of insertion compounds for sodium ion batteries. J. Mater. Chem. A 3, 18564-18571.
65. Zhang, Z., Shao, Y., Lotsch, B., Hu, Y.-S., Li, H., Janek, J., Nazar, L. F., Nan, C.-W., Maier, J., Armand, M., et al. (2018). New horizons for inorganic solid state ion conductors. Energy Environ. Sci. 11, 1945-1976.
66. Pervez, S. A., Kim, G., Vinayan, B. P., Cambaz, M. A., Kuenzel, M., Hekmatfar, M., Fichtner, M., and Passerini, S. (2020). Overcoming the Interfacial Limitations Imposed by the Solid-Solid Interface in Solid-State Batteries Using Ionic Liquid-Based Interlayers. Small 16, 2000279.
67. Zhou, D., Shanmukaraj, D., Tkacheva, A., Armand, M., and Wang, G. (2019). Polymer Electrolytes for Lithium-Based Batteries: Advances and Prospects. Chem 5, 2326-2352.
68. Xia, S., Wu, X., Zhang, Z., Cui, Y., and Liu, W. (2019). Practical Challenges and Future Perspectives of All-Solid-State Lithium-Metal Batteries. Chem 5, 753-785.
69. Yang, C., Fu, K., Zhang, Y., Hitz, E., and Hu, L. (2017). Protected Lithium-Metal Anodes in Batteries: From Liquid to Solid. Adv. Mater. 29, 1701169.
70. Zheng, F., Kotobuki, M., Song, S., Lai, M. O., and Lu, L. (2018). Review on solid electrolytes for all-solid-state lithium-ion batteries. J. Power Sources 389, 198-213.
71. Zhao, W., Yi, J., He, P., and Zhou, H. (2019). Solid-State Electrolytes for Lithium-Ion Batteries: Fundamentals, Challenges and Perspectives. Electrochem. Energy Rev. 2, 574-605.
72. Lau, J., DeBlock, R. H., Butts, D. M., Ashby, D. S., Choi, C. S., and Dunn, B. S. (2018). Sulfide Solid Electrolytes for Lithium Battery Applications. Adv. Energy Mater. 8, 1800933.
73. Zhang, Q., Cao, D., Ma, Y., Natan, A., Aurora, P., and Zhu, H. (2019). Sulfide-Based Solid-State Electrolytes: Synthesis, Stability, and Potential for All-Solid-State Batteries. Adv. Mater. 31, 1901131.
74. Choi, C. S., Lau, J., Hur, J., Smith, L., Wang, C., and Dunn, B. (2018). Synthesis and Properties of a Photopatternable Lithium-Ion Conducting Solid Electrolyte. Adv. Mater. 30, 1703772.
75. Ma, J., Li, Y., Grundish, N. S., Goodenough, J. B., Chen, Y., Guo, L., Peng, Z., Qi, X., Yang, F., Qie, L., et al. (2021). The 2021 battery technology roadmap. J. Phys. D: Appl. Phys. 54, 183001.
76. Wang, X., Kerr, R., Chen, F., Goujon, N., Pringle, J. M., Mecerreyes, D., Forsyth, M., and Howlett, P. C. (2020). Toward High-Energy-Density Lithium Metal Batteries: Opportunities and Challenges for Solid Organic Electrolytes. Adv. Mater. 32, 1905219.
77. Dudney, N. J. (2005). Solid-state thin-film rechargeable batteries. Mater. Sci. Eng.: B 116, 245-249.
78. Qi, Y., Ban, C., and Harris, S. J. (2020). A New General Paradigm for Understanding and Preventing Li Metal Penetration through Solid Electrolytes. Joule 4, 2599-2608.
79. Zhao, Y., Zheng, K., and Sun, X. (2018). Addressing Interfacial Issues in Liquid-Based and Solid-State Batteries by Atomic and Molecular Layer Deposition. Joule 2, 2583-2604.
80. Tan, D. H. S., Banerjee, A., Chen, Z., and Meng, Y. S. (2020). From nanoscale interface characterization to sustainable energy storage using all-solid-state batteries. Nat. Nanotech. 15, 170-180.
81. Lou, S., Zhang, F., Fu, C., Chen, M., Ma, Y., Yin, G., and Wang, J. (2021). Interface Issues and Challenges in All-Solid-State Batteries: Lithium, Sodium, and Beyond. Adv. Mater. 33, 2000721.
82. Xu, L., Tang, S., Cheng, Y., Wang, K., Liang, J., Liu, C., Cao, Y.-C., Wei, F., and Mai, L. (2018). Interfaces in Solid-State Lithium Batteries. Joule 2, 1991-2015.
83. Huang, K. J., Ceder, G., and Olivetti, E. A. (2021). Manufacturing scalability implications of materials choice in inorganic solid-state batteries. Joule 5, 564-580.
84. Judez, X., Eshetu, G. G., Li, C., Rodriguez-Martinez, L. M., Zhang, H., and Armand, M. (2018). Opportunities for Rechargeable Solid-State Batteries Based on Li-Intercalation Cathodes. Joule 2, 2208-2224.
85. Duffner, F., Kronemeyer, N., Tubke, J., Leker, J., Winter, M., and Schmuch, R. (2021). Post-lithium-ion battery cell production and its compatibility with lithium-ion cell production infrastructure. Nat. Energy 6, 123-134.
86. Balaish, M., Gonzalez-Rosillo, J. C., Kim, K. J., Zhu, Y., Hood, Z. D., and Rupp, J. L. M. (2021). Processing thin but robust electrolytes for solid-state batteries. Nat Energy 6, 227-239.
87. Zhao, N., Khokhar, W., Bi, Z., Shi, C., Guo, X., Fan, L.-Z., and Nan, C.-W. (2019). Solid Garnet Batteries. Joule 3, 1190-1199.
88. Abakumov, A. M., Fedotov, S. S., Antipov, E. V., and Tarascon, J.-M. (2020). Solid state chemistry for developing better metal-ion batteries. Nat. Commun. 11, 4976.
89. Shen, Y., Zhang, Y., Han, S., Wang, J., Peng, Z., and Chen, L. (2018). Unlocking the Energy Capabilities of Lithium Metal Electrode with Solid-State Electrolytes. Joule 2, 1674-1689.
90. Nanda, J., Wang, C., and Liu, P. (2018). Frontiers of solid-state batteries. MRS Bull. 43, 740-745.
91. Albertus, P., Anandan, V., Ban, C., Balsara, N., Belharouak, I., Buettner-Garrett, J., Chen, Z., Daniel, C., Doeff, M., Dudney, N. J., et al. (2021). Challenges for and Pathways toward Li-Metal-Based All-Solid-State Batteries. ACS Energy Lett., 1399-1404.
92. Eshetu, G. G., Elia, G. A., Armand, M., Forsyth, M., Komaba, S., Rojo, T., and Passerini, S. (2020). Electrolytes and Interphases in Sodium-Based Rechargeable Batteries: Recent Advances and Perspectives. Adv. Energy Mater. 10, 2000093.
93. Wang, M. J., Kazyak, E., Dasgupta, N. P., and Sakamoto, J. (2021). Transitioning solid-state batteries from lab to market: Linking electro-chemo-mechanics with practical considerations. Joule 5, 1371-1390.
94. Handbook of Solid State Batteries (2015). (WORLD SCIENTIFIC).
95. Albertus, P., Anandan, V., Ban, C., Balsara, N., Belharouak, I., Buettner-Garrett, J., Chen, Z., Daniel, C., Doeff, M., Dudney, N. J., et al. (2021). Challenges for and Pathways toward Li-Metal-Based All-Solid-State Batteries. ACS Energy Lett. 6, 1399-1404.
96. Brahmbhatt, T., Yang, G., Self, E., and Nanda, J. (2020). Cathode-Sulfide Solid Electrolyte Interfacial Instability: Challenges and Solutions. Front. Energy Res. 8, 247.
97. Sacci, R. L., Bennett, T. H., Drews, A. R., Anandan, V., Kirkham, M. J., Daemen, L. L., and Nanda, J. (2021). Phase evolution during lithium-indium halide superionic conductor dehydration. J. Mater. Chem. A 9, 990-996.
98. Ong, S. P., Mo, Y., Richards, W. D., Miara, L., Lee, H. S., and Ceder, G. (2013). Phase stability, electrochemical stability and ionic conductivity of the Li_{10±1}MP₂X₁₂ (M=Ge, Si, Sn, Al or P, and X═O, S or Se) family of superionic conductors. Energy Environ. Sci. 6, 148-156.
99. Zhao, Y., and Daemen, L. L. (2012). Superionic Conductivity in Lithium-Rich Anti-Perovskites. J. Am. Chem. Soc. 134, 15042-15047.
100. Fang, H., Wang, S., Liu, J., Sun, Q., and Jena, P. (2017). Superhalogen-based lithium superionic conductors. J. Mater. Chem. A 5, 13373-13381.
101. Fang, H., and Jena, P. (2019). Sodium Superionic Conductors Based on Clusters. ACS Appl. Mater. Interfaces 11, 963-972.
102. He, X., Zhu, Y., and Mo, Y. (2017). Origin of fast ion diffusion in super-ionic conductors. Nat. Commun. 8, 15893.
103. Kozinsky, B. (2018). Transport in Frustrated and Disordered Solid Electrolytes. In Handbook of Materials Modeling, W. Andreoni and S. Yip, eds. (Springer International Publishing), pp. 1-20.
104. Fang, H., and Jena, P. (2017). Li-rich antiperovskite superionic conductors based on cluster ions. Proc. Natl. Acad. Sci. USA 114, 11046-11051.
105. Zhang, Z., Li, H., Kaup, K., Zhou, L., Roy, P.-N., and Nazar, L. F. (2020). Targeting Superionic Conductivity by Turning on Anion Rotation at Room Temperature in Fast Ion Conductors. Matter 2, 1667-1684.
106. Kweon, K. E., Varley, J. B., Shea, P., Adelstein, N., Mehta, P., Heo, T. W., Udovic, T. J., Stavila, V., and Wood, B. C. (2017). Structural, Chemical, and Dynamical Frustration: Origins of Superionic Conductivity in closo-Borate Solid Electrolytes. Chem. Mater. 29, 9142-9153.
107. Sakuda, A., Hayashi, A., and Tatsumisago, M. (2013). Sulfide Solid Electrolyte with Favorable Mechanical Property for All-Solid-State Lithium Battery. Sci. Rep. 3, 2261.
108. Dawson, J. A., Canepa, P., Famprikis, T., Masquelier, C., and Islam, M. S. (2018). Atomic-Scale Influence of Grain Boundaries on Li-Ion Conduction in Solid Electrolytes for All-Solid-State Batteries. J. Am. Chem. Soc. 140, 362-368.
109. Monroe, C., and Newman, J. (2005). The Impact of Elastic Deformation on Deposition Kinetics at Lithium/Polymer Interfaces. J. Electrochem. Soc. 152, A396.
110. Tang, H., Deng, Z., Lin, Z., Wang, Z., Chu, I.-H., Chen, C., Zhu, Z., Zheng, C., and Ong, S. P. (2018). Probing Solid-Solid Interfacial Reactions in All-Solid-State Sodium-Ion Batteries with First-Principles Calculations. Chem. Mater. 30, 163-173.
111. Persson, K. Department of Materials Science and Engineering, University of California at Berkeley. https://materialsproject.org/.
112. Zhu, Y., He, X., and Mo, Y. (2015). Origin of Outstanding Stability in the Lithium Solid Electrolyte Materials: Insights from Thermodynamic Analyses Based on First-Principles Calculations. ACS Appl. Mater. Interfaces 7, 23685-23693.
113. Dove, M. T. (2003). Structure and Dynamics—An Atomic View of Materials. Mater. Today 6, 59.
114. Hull, S. (2004). Superionics: crystal structures and conduction processes. Rep. Prog. Phys. 67, 1233-1314.
115. Schmitz, K. S. (2017). Solid State. In Physical Chemistry (Elsevier), pp. 261-290.
116. Chu, I.-H., Kompella, C. S., Nguyen, H., Zhu, Z., Hy, S., Deng, Z., Meng, Y. S., and Ong, S. P. (2016). Room-Temperature All-solid-state Rechargeable Sodium-ion Batteries with a CI-doped Na₃PS₄ Superionic Conductor. Sci. Rep. 6, 33733.
117. Wang, S. F., Ding, Y., Zhou, G. M, Yu, G. H., Manthiram, A., Durability of the Li₁₊ₓTi₂₋ₓAlₓ(PO₄)₃ Solid Electrolyte in Li—S batteries. ACS Energy Lett. 1, 1080-1085
118. Nishimura, S., Tanibata, N., Hayashi, A., Tatsumisago, M., and Yamada, A. (2017). The crystal structure and sodium disorder of high-temperature polymorph β-Na₃PS₄. J. Mater. Chem. A 5, 25025-25030.
119. Mo, Y., Ong, S. P., and Ceder, G. (2012). First Principles Study of the Li₁₀GeP₂S₁₂ Lithium Super Ionic Conductor Material. Chem. Mater. 24, 15-17.
120. Famprikis, T., Dawson, J. A., Fauth, F., Clemens, O., Suard, E., Fleutot, B., Courty, M., Chotard, J.-N., Islam, M. S., and Masquelier, C. (2019). A New Superionic Plastic Polymorph of the Na⁺ Conductor Na₃PS₄. ACS Mater. Lett. 1, 641-646.
121. Makiura, R., Yonemura, T., Yamada, T., Yamauchi, M., Ikeda, R., Kitagawa, H., Kato, K., and Takata, M. (2009). Size-controlled stabilization of the superionic phase to room temperature in polymer-coated Agl nanoparticles. Nat. Mater. 8, 476-480.
122. Choi, Y. S., Lee, Y.-S., Oh, K. H., and Cho, Y. W. (2016). Interface-enhanced Li ion conduction in a LiBH₄—SiO₂ solid electrolyte. Phys. Chem. Chem. Phys. 18, 22540-22547.
123. Liu, Z. C., Fu, W. J., Payzant, A., Yu, X., Wu, Z. L., Dudney, N. J., Kiggans, J., Hong, K. L., Rondinone, A. J., Liang, C. D. (2013). Anomalous High Ionic Conductivity of Nanoporous β-Li₃PS₄. J. Am. Chem. Soc. 2013, 135, 3, 975-978
124. Maekawa, H., Matsuo, M., Takamura, H., Ando, M., Noda, Y., Karahashi, T., and Orimo, S. (2009). Halide-Stabilized LiBH₄, a Room-Temperature Lithium Fast-Ion Conductor. J. Am. Chem. Soc. 131, 894-895.
125. Chamorro, J. R., and McQueen, T. M. (2018). Progress toward Solid State Synthesis by Design. Acc. Chem. Res. 51, 2918-2925.
126. Blanchard, D., Nale, A., Sveinbjörnsson, D., Eggenhuisen, T. M., Verkuijlen, M. H. W., Suwarno, Vegge, T., Kentgens, A. P. M., and de Jongh, P. E. (2015). Nanoconfined LiBH₄ as a Fast Lithium Ion Conductor. Adv. Funct. Mater. 25, 184-192.
127. Ngene, P., Lambregts, S. F. H., Blanchard, D., Vegge, T., Sharma, M., Hagemann, H., and de Jongh, P. E. (2019). The influence of silica surface groups on the Li-ion conductivity of LiBH₄/SiO₂ nanocomposites. Phys. Chem. Chem. Phys. 21, 22456-22466.
128. Kong, S.-T., Deiseroth, H.-J., Reiner, C., Gun, O., Neumann, E., Ritter, C., and Zahn, D. (2010). Lithium Argyrodites with Phosphorus and Arsenic: Order and Disorder of Lithium Atoms, Crystal Chemistry, and Phase Transitions. Chem. Eur. J. 16, 2198-2206.
129. Deiseroth, H.-J., Kong, S.-T., Eckert, H., Vannahme, J., Reiner, C., ZaiB, T., and Schlosser, M. (2008). Li₆PS₅X: A Class of Crystalline Li-Rich Solids With an Unusually High Li⁺ Mobility. Angew. Chem. Int. Ed. 47, 755-758.
130. Zhang, Z., Sun, Y., Duan, X., Peng, L., Jia, H., Zhang, Y., Shan, B., and Xie, J. (2019). Design and synthesis of room temperature stable Li-argyrodite superionic conductors via cation doping. J. Mater. Chem. A 7, 2717-2722.
131. Bell, M. F., and Wichelhaus, W. Phase Transition in NASICON (Na₃Zr₂Si₂PO₁₂). Mater. Res. Bull. 14, 1317-1322.
132. Ma, Q., Tsai, C.-L., Wei, X.-K., Heggen, M., Tietz, F., and Irvine, J. T. S. (2019). Room temperature demonstration of a sodium superionic conductor with grain conductivity in excess of 0.01 S cm⁻¹ and its primary applications in symmetric battery cells. J. Mater. Chem. A 7, 7766-7776.
133. Goodenough, J. B., Hong, H. Y.-P., and Kafalas, J. A. (1976). Fast Na+-ion transport in skeleton structures. Mater. Res. Bull. 11, 203-220.
134. Jolley, A. G., Taylor, D. D., Schreiber, N. J., and Wachsman, E. D. (2015). Structural Investigation of Monoclinic-Rhombohedral Phase Transition in Na₃Zr₂Si₂PO₁₂ and Doped NASICON. J. Am. Ceram. Soc. 98, 2902-2907.
135. Filinchuk, Y., Chernyshov, D., and Cerny, R. (2008). Lightest Borohydride Probed by Synchrotron X-ray Diffraction: Experiment Calls for a New Theoretical Revision. J. Phys. Chem. C 112, 10579-10584.
136. Jansen, M., Henseler, U. (1992). Synthesis, structure determination, and ionic conductivity of sodium tetrathiophosphate. J. Solid State Chem. 99, 110-119.
137. Zhang, Q., Zhang, C., Hood, Z. D., Chi, M., Liang, C., Jalarvo, N. H., Yu, M., and Wang, H. (2020). Abnormally Low Activation Energy in Cubic Na₃SbS₄ Superionic Conductors. Chem. Mater. 32, 2264-2271.
138. Zhang, L., Yang, K., Mi, J., Lu, L., Zhao, L., Wang, L., Li, Y., and Zeng, H. (2015). Na₃PSe₄: A Novel Chalcogenide Solid Electrolyte with High Ionic Conductivity. Adv. Energy Mater. 5, 1501294.
139. Song, A.-Y., Xiao, Y., Turcheniuk, K., Upadhya, P., Ramanujapuram, A., Benson, J., Magasinski, A., Olguin, M., Meda, L., Borodin, O., et al. (2018). Protons Enhance Conductivities in Lithium Halide Hydroxide/Lithium Oxyhalide Solid Electrolytes by Forming Rotating Hydroxy Groups. Adv. Energy Mater. 8, 1700971.
140. Zhao, Y., and Daemen, L. L. (2012). Superionic Conductivity in Lithium-Rich Anti-Perovskites. J. Am. Chem. Soc. 134, 15042-15047.
141. Adams, S., and Rao, R. P. (2012). Ion transport and phase transition in Li₇₋ₓLa₃(Zr₂₋ₓMx)O₁₂ (M=Ta⁵⁺, Nb⁵⁺, x=0, 0.25). J. Mater. Chem. 22, 1426-1434.
142. Awaka, J., Kijima, N., Hayakawa, H., and Akimoto, J. (2009). Synthesis and structure analysis of tetragonal Li₇La₃Zr₂O₁₂ with the garnet-related type structure. J. Solid State Chem. 182, 2046-2052.
143. Geiger, C. A., Alekseev, E., Lazic, B., Fisch, M., Armbruster, T., Langner, R., Fechtelkord, M., Kim, N., Pettke, T., and Weppner, W. (2011). Crystal Chemistry and Stability of “Li₇La₃Zr₂O₁₂” Garnet: A Fast Lithium-Ion Conductor. Inorg. Chem. 50, 1089-1097.
144. Kwon, O., Hirayama, M., Suzuki, K., Kato, Y., Saito, T., Yonemura, M., Kamiyama, T., and Kanno, R. (2015). Synthesis, structure, and conduction mechanism of the lithium superionic conductor Li_{10+δ}Ge_{1+δ}P_{2-δ}S₁₂. J. Mater. Chem. A, 3, 438-446.
145. Kamaya, N., Homma, K., Yamakawa, Y., Hirayama, M., Kanno, R., Yonemura, M., Kamiyama, T., Kato, Y., Hama, S., Kawamoto, K., et al. (2011). A lithium superionic conductor. Nat. Mater. 10, 682-686.
146. Ma, C., Cheng, Y. Q., Yin, K. B., Luo, J., Sharafi, A., Sakamoto, J., Li, J., More, K. L., Dudney, N. J., and Chi, M. F. (2016). Interfacial Stability of Li Metal-Solid Electrolyte Elucidated via in Situ Electron Microscopy. Nano Lett. 16, 7030-7036.
147. Han, F., Yue, J., Chen, C., Zhao, N., Fan, X., Ma, Z., Gao, T., Wang, F., Guo, X., and Wang, C. (2018). Interphase Engineering Enabled All-Ceramic Lithium Battery. Joule 2, 497-508.
148. Sharafi, A., Meyer, H. M., Nanda, J., Wolfenstine, J., and Sakamoto, J. (2016). Characterizing the Li—Li₇La₃Zr₂O₁₂ interface stability and kinetics as a function of temperature and current density. J. Power Sources 302, 135-139.
149. Sharafi, A., Yu, S., Naguib, M., Lee, M., Ma, C., Meyer, H. M., Nanda, J., Chi, M., Siegel, D. J., and Sakamoto, J. (2017). Impact of air exposure and surface chemistry on Li—Li₇La₃Zr₂O₁₂ interfacial resistance. J. Mater. Chem. A 5, 13475-13487.
150. Naguib, M., Sharafi, A., Self, E. C., Meyer, H. M., Sakamoto, J., and Nanda, J. (2019). Interfacial Reactions and Performance of Li₇La₃Zr₂O₁₂-Stabilized Li-Sulfur Hybrid Cell. ACS Appl. Mater. Interfaces 11, 42042-42048.
151. Jia, M., Zhao, N., Huo, H., and Guo, X. (2020). Comprehensive Investigation into Garnet Electrolytes Toward Application-Oriented Solid Lithium Batteries. Electrochem. Energ. Rev. 3, 656-689.
152. Awaka, J., Takashima, A., Kataoka, K., Kijima, N., Idemoto, Y., and Akimoto, J. (2011). Crystal Structure of Fast Lithium-ion-conducting Cubic Li₇La₃Zr₂O₁₂. Chem. Lett. 40, 60-62.
153. Bernstein, N., Johannes, M. D., and Hoang, K. (2012). Origin of the Structural Phase Transition in Li₇La₃Zr₂O₁₂. Phys. Rev. Lett. 109, 205702.
154. Liu, C. (2015). Reversible ion exchange and structural stability of garnet-type Nb-doped Li₇La₃Zr₂O₁₂ in water for applications in lithium batteries. J. Power Sources, 282, 286-293.
155. Thompson, T., Wolfenstine, J., Allen, J. L., Johannes, M., Huq, A., David, I. N., and Sakamoto, J. (2014). Tetragonal vs. cubic phase stability in Al-free Ta doped Li₇La₃Zr₂O₁₂ (LLZO). J. Mater. Chem. A 2, 13431-13436.
156. Liu, X. M., Chen, Y., Hood, Z. D., Ma, C., Yu, S., Sharafi, A., Wang, H., An, K., Sakamoto, J., Siegel, D. J., Cheng, Y. Q., Jalarvo, N. H., and Chi, M. F. (2019). Elucidating the mobility of H⁺ and Li⁺ ions in (Li_{6.25-x}HₓAl_{0.25})La₃Zr₂O₁₂ via correlative neutron and electron spectroscopy. Energy Environ. Sci. 12, 945-951.
157. Huo, H., Luo, J., Thangadurai, V., Guo, X., Nan, C.-W., and Sun, X. (2020). Li₂CO₃: A Critical Issue for Developing Solid Garnet Batteries. ACS Energy Lett. 5, 252-262.
158. Cheng, D., Wynn, T. A., Wang, X., Wang, S., Zhang, M., Shimizu, R., Bai, S., Nguyen, H., Fang, C., Kim, M., et al. (2020). Unveiling the Stable Nature of the Solid Electrolyte Interphase between Lithium Metal and LiPON via Cryogenic Electron Microscopy. Joule 4, 2484-2500.
159. Sharafi, A., Kazyak, E., Davis, A. L., Yu, S., Thompson, T., Siegel, D. J., Dasgupta, N. P., and Sakamoto, J. (2017). Surface Chemistry Mechanism of Ultra-Low Interfacial Resistance in the Solid-State Electrolyte Li₇La₃Zr₂O₁₂. Chem. Mater. 29, 7961-7968.
160. Gupta, A., and Sakamoto, J. (2019). Controlling Ionic Transport through the PEO-LiTFSI/LLZTO Interface. Electrochem. Soc. Interface 28, 63-69.
161. Zhu, Y., Connell, J. G., Tepavcevic, S., Zapol, P., Garcia-Mendez, R., Taylor, N. J., Sakamoto, J., Ingram, B. J., Curtiss, L. A., Freeland, J. W., et al. (2019). Dopant-Dependent Stability of Garnet Solid Electrolyte Interfaces with Lithium Metal. Adv. Energy Mater., 11.
162. Han, F., Zhu, Y., He, X., Mo, Y., and Wang, C. (2016). Electrochemical Stability of Li₁₀GeP₂S₁₂ and Li₇La₃Zr₂O₁₂ Solid Electrolytes. Adv. Energy Mater. 6, 1501590.
163. Cheng, E. J., Sharafi, A., and Sakamoto, J. (2017). Intergranular Li metal propagation through polycrystalline Li_{6.25}Al_{0.25}La₃Zr₂O₁₂ ceramic electrolyte. Electrochim. Acta 223, 85-91.
164. Song, Y., Yang, L., Zhao, W., Wang, Z., Zhao, Y., Wang, Z., Zhao, Q., Liu, H., and Pan, F. (2019). Revealing the Short-Circuiting Mechanism of Garnet-Based Solid-State Electrolyte. Adv. Energy Mater. 9, 1900671.
165. Han, X., Gong, Y., Fu, K., He, X., Hitz, G. T., Dai, J., Pearse, A., Liu, B., Wang, H., Rubloff, G., et al. (2017). Negating interfacial impedance in garnet-based solid-state Li metal batteries. Nat. Mater. 16, 572-579.
166. Wang, M. J., Choudhury, R., and Sakamoto, J. (2019). Characterizing the Li-Solid-Electrolyte Interface Dynamics as a Function of Stack Pressure and Current Density. Joule 3, 2165-2178.
167. Dixit, M. B., Zaman, W., Hortance, N., Vujic, S., Harkey, B., Shen, F., Tsai, W.-Y., De Andrade, V., Chen, X. C., Balke, N., et al. (2020). Nanoscale Mapping of Extrinsic Interfaces in Hybrid Solid Electrolytes. Joule 4, 207-221.
168. Zhou, W., Wang, S., Li, Y., Xin, S., Manthiram, A., and Goodenough, J. B. (2016). Plating a Dendrite-Free Lithium Anode with a Polymer/Ceramic/Polymer Sandwich Electrolyte. J. Am. Chem. Soc. 138, 9385-9388.
169. Raj, R., and Wolfenstine, J. (2017). Current limit diagrams for dendrite formation in solid-state electrolytes for Li-ion batteries. J. Power Sources 343, 119-126.
170. Yu, S., and Siegel, D. J. (2017). Grain Boundary Contributions to Li-Ion Transport in the Solid Electrolyte Li₇La₃Zr₂O₁₂ (LLZO). Chem. Mater. 29, 9639-9647.
171. Cheng, L., Crumlin, E. J., Chen, W., Qiao, R., Hou, H., Franz Lux, S., Zorba, V., Russo, R., Kostecki, R., Liu, Z., et al. (2014). The origin of high electrolyte-electrode interfacial resistances in lithium cells containing garnet type solid electrolytes. Phys. Chem. Chem. Phys. 16, 18294-18300.
172. Jin, Y., and McGinn, P. J. (2013). Bulk solid state rechargeable lithium ion battery fabrication with Al-doped Li₇La₃Zr₂O₁₂ electrolyte and Cu_{0.1}V₂O₅ cathode. Electrochim. Acta 89, 407-412.
173. Tian, H.-K., Liu, Z., Ji, Y., Chen, L.-Q., and Qi, Y. (2019). Interfacial Electronic Properties Dictate Li Dendrite Growth in Solid Electrolytes. Chem. Mater. 31, 7351-7359.
174. Cheng, Z., Liu, M., Ganapathy, S., Li, C., Li, Z., Zhang, X., He, P., Zhou, H., and Wagemaker, M. (2020). Revealing the Impact of Space-Charge Layers on the Li-Ion Transport in All-Solid-State Batteries. Joule 4, 1311-1323.
175. Krauskopf, T., Dippel, R., Hartmann, H., Peppler, K., Mogwitz, B., Richter, F. H., Zeier, W. G., and Janek, J. (2019). Lithium-Metal Growth Kinetics on LLZO Garnet-Type Solid Electrolytes. Joule 3, 2030-2049.
176. Cheng, Q., Li, A., Li, N., Li, S., Zangiabadi, A., Li, T.-D., Huang, W., Li, A. C., Jin, T., Song, Q., et al. (2019). Stabilizing Solid Electrolyte-Anode Interface in Li-Metal Batteries by Boron Nitride-Based Nanocomposite Coating. Joule 3, 1510-1522.
177. Tian, H.-K., Xu, B., and Qi, Y. (2018). Computational study of lithium nucleation tendency in Li₇La₃Zr₂O₁₂ (LLZO) and rational design of interlayer materials to prevent lithium dendrites. J. Power Sources 392, 79-86.
178. Han, F., Westover, A. S., Yue, J., Fan, X., Wang, F., Chi, M., Leonard, D. N., Dudney, N. J., Wang, H., and Wang, C. (2019). High electronic conductivity as the origin of lithium dendrite formation within solid electrolytes. Nat. Energy 4, 187-196.
179. Kasemchainan, J., Zekoll, S., Spencer Jolly, D., Ning, Z., Hartley, G. O., Marrow, J., and Bruce, P. G. (2019). Critical stripping current leads to dendrite formation on plating in lithium anode solid electrolyte cells. Nat. Mater. 18, 1105-1111.
180. Le Van-Jodin, L., Ducroquet, F., Sabary, F., and Chevalier, I. (2013). Dielectric properties, conductivity and Li⁺ ion motion in LiPON thin films. Solid State Ionics 253, 151-156.
181. Monroe, C., and Newman, J. (2005). The Impact of Elastic Deformation on Deposition Kinetics at Lithium/Polymer Interfaces. J. Electrochem. Soc. 152, A396-A404.
182. Ni, J. E., Case, E. D., Sakamoto, J. S., Rangasamy, E., and Wolfenstine, J. B. (2012). Room temperature elastic moduli and Vickers hardness of hot-pressed LLZO cubic garnet. J. Mater. Sci. 47, 7978-7985.
183. Baranowski, L. L., Heveran, C. M., Ferguson, V. L., and Stoldt, C. R. (2016). Multi-Scale Mechanical Behavior of the Li₃PS₄ Solid-Phase Electrolyte. ACS Appl. Mater. Interfaces 8, 29573-29579.
184. Kataoka, K., Nagata, H., and Akimoto, J. (2018). Lithium-ion conducting oxide single crystal as solid electrolyte for advanced lithium battery application. Sci. Rep. 8, 9965.
185. Xiao, Y., Miara, L. J., Wang, Y., and Ceder, G. (2019). Computational Screening of Cathode Coatings for Solid-State Batteries. Joule 3, 1252-1275.
186. Li, Y., Chen, X., Dolocan, A., Cui, Z., Xin, S., Xue, L., Xu, H., Park, K., and Goodenough, J. B. (2018). Garnet Electrolyte with an Ultralow Interfacial Resistance for Li-Metal Batteries. J. Am. Chem. Soc. 140, 6448-6455.
187. Kotobuki, M., Munakata, H., Kanamura, K., Sato, Y., and Yoshida, T. Compatibility of Li₇La₃Zr₂O₁₂ Solid Electrolyte to All-Solid-State Battery Using Li Metal Anode. J. Electrochem. Soc., 4.
188. Ohta, S., Kobayashi, T., Seki, J., and Asaoka, T. (2012). Electrochemical performance of an all-solid-state lithium ion battery with garnet-type oxide electrolyte. J. Power Sources 202, 332-335.
189. Vardar, G., Bowman, W. J., Lu, Q., Wang, J., Chater, R. J., Aguadero, A., Seibert, R., Terry, J., Hunt, A., Waluyo, I., et al. (2018). Structure, Chemistry, and Charge Transfer Resistance of the Interface between Li₇La₃Zr₂O₁₂ Electrolyte and LiCoO₂ Cathode. Chem. Mater. 30, 6259-6276.
190. Aurbach, D., Markovsky, B., Rodkin, A., Cojocaru, M., Levi, E., and Kim, H.-J. (2002). An analysis of rechargeable lithium-ion batteries after prolonged cycling. Electrochim. Acta 47, 1899-1911.
191. Luo, W., Gong, Y., Zhu, Y., Li, Y., Yao, Y., Zhang, Y., Fu, K. (Kelvin), Pastel, G., Lin, C., Mo, Y., et al. (2017). Reducing Interfacial Resistance between Garnet-Structured Solid-State Electrolyte and Li-Metal Anode by a Germanium Layer. Adv. Mater. 29, 1606042.
192. Fu, K. (Kelvin), Gong, Y., Liu, B., Zhu, Y., Xu, S., Yao, Y., Luo, W., Wang, C., Lacey, S. D., Dai, J., et al. (2017). Toward garnet electrolyte-based Li metal batteries: An ultrathin, highly effective, artificial solid-state electrolyte/metallic Li interface. Sci Adv 3, e1601659.
193. Gong, Y., Fu, K., Xu, S., Dai, J., Hamann, T. R., Zhang, L., Hitz, G. T., Fu, Z., Ma, Z., McOwen, D. W., et al. (2018). Lithium-ion conductive ceramic textile: A new architecture for flexible solid-state lithium metal batteries. Mater. Today 21, 594-601.
194. Shen, F., Dixit, M. B., Xiao, X., and Hatzell, K. B. (2018). Effect of Pore Connectivity on Li Dendrite Propagation within LLZO Electrolytes Observed with Synchrotron X-ray Tomography. ACS Energy Lett. 3, 1056-1061.
195. Wang, M. J., Carmona, E., Gupta, A., Albertus, P., and Sakamoto, J. (2020). Enabling “lithium-free” manufacturing of pure lithium metal solid-state batteries through in situ plating. Nat. Commun. 11, 5201.
196. Yi, E., Shen, H., Heywood, S., Alvarado, J., Parkinson, D. Y., Chen, G., Sofie, S. W., and Doeff, M. M. (2020). All-Solid-State Batteries Using Rationally Designed Garnet Electrolyte Frameworks. ACS Appl. Energy Mater. 3, 170-175.
197. Jiang, Z., Wang, S., Chen, X., Yang, W., Yao, X., Hu, X., Han, Q., and Wang, H. (2020). Tape-Casting Li_{0.34}La_{0.56}TiO₃ Ceramic Electrolyte Films Permit High Energy Density of Lithium-Metal Batteries. Adv. Mater. 32, 1906221.
198. Fu, K. (Kelvin), Gong, Y., Hitz, G. T., McOwen, D. W., Li, Y., Xu, S., Wen, Y., Zhang, L., Wang, C., Pastel, G., et al. (2017). Three-dimensional bilayer garnet solid electrolyte based high energy density lithium metal-sulfur batteries. Energy Environ. Sci. 10, 1568-1575.
199. Fu, K. (Kelvin), Gong, Y., Liu, B., Zhu, Y., Xu, S., Yao, Y., Luo, W., Wang, C., Lacey, S. D., Dai, J., et al. (2017). Toward garnet electrolyte-based Li metal batteries: An ultrathin, highly effective, artificial solid-state electrolyte/metallic Li interface. Sci. Adv. 3, e1601659.
200. Liu, B., Fu, K., Gong, Y., Yang, C., Yao, Y., Wang, Y., Wang, C., Kuang, Y., Pastel, G., Xie, H., et al. (2017). Rapid Thermal Annealing of Cathode-Garnet Interface toward High-Temperature Solid State Batteries. Nano Lett. 17, 4917-4923.
201. Shao, Y., Wang, H., Gong, Z., Wang, D., Zheng, B., Zhu, J., Lu, Y., Hu, Y.-S., Guo, X., Li, H., et al. (2018). Drawing a Soft Interface: An Effective Interfacial Modification Strategy for Garnet-Type Solid-State Li Batteries. ACS Energy Lett. 3, 1212-1218.
202. Huo, H., Chen, Y., Zhao, N., Lin, X., Luo, J., Yang, X., Liu, Y., Guo, X., and Sun, X. (2019). In-situ formed Li₂CO₃-free garnet/Li interface by rapid acid treatment for dendrite-free solid-state batteries. Nano Energy 61, 119-125.
203. Feng, X., Chien, P.-H., Wang, Y., Patel, S., Wang, P., Liu, H., Immediato-Scuotto, M., and Hu, Y.-Y. (2020). Enhanced ion conduction by enforcing structural disorder in Li-deficient argyrodites Li₆₋ₓPS₅₋ₓCl₁₊ₓ. Energy Stor. Mater. 30, 67-73.
204. Adeli, P., Bazak, J. D., Park, K.-H., Kochetkov, I., Huq, A., Goward, G. and Nazar, L., (2019). Boosting solid-state diffusivity and coductivity in lithium superionic argyrodites by halide substitution. Angew. Chem. Int. Ed. 131, 8773-8778.
205. Kraft, M. A., Ohno, S., Zinkevich, T., Koerver, R., Culver, S. P., Fuchs, T., Senyshyn, A., Indris, S., Morgan, B. J., and Zeier, W. G. (2018). Inducing High Ionic Conductivity in the Lithium Superionic Argyrodites Li₆₊ₓP₁₋ₓGeₓS₅I for All-Solid-State Batteries. J. Am. Chem. Soc. 140, 16330-16339.
206. Zhou, L., Assoud, A., Zhang, Q., Wu, X., and Nazar, L. F. (2019). New Family of Argyrodite Thioantimonate Lithium Superionic Conductors. J. Am. Chem. Soc. 141, 19002-19013.
207. Patel, S. V., Banerjee, S., Liu, H., Wang, P., Chien, P.-H., Feng, X., Liu, J., Ong, S. P., and Hu, Y.-Y. (2021). Tunable Lithium-Ion Transport in Mixed-Halide Argyrodites Li₆₋ₓPS₅₋ₓClBrₓ: An Unusual Compositional Space. Chem. Mater. 33, 1435-1443.
208. Yu, C., Zhao, F., Luo, J., Zhang, L., and Sun, X. (2021). Recent development of lithium argyrodite solid-state electrolytes for solid-state batteries: Synthesis, structure, stability and dynamics. Nano Energy 83, 105858.
209. Deiseroth, H.-J., Maier, J., Weichert, K., Nickel, V., Kong, S.-T., and Reiner, C. (2011). Li₇PS₆ and Li₆PS₅X (X: Cl, Br, I): Possible Three-dimensional Diffusion Pathways for Lithium Ions and Temperature Dependence of the Ionic Conductivity by Impedance Measurements. Z. anorg. allg. Chem. 637, 1287-1294.
210. Kraft, M. A., Culver, S. P., Calderon, M., Böcher, F., Krauskopf, T., Senyshyn, A., Dietrich, C., Zevalkink, A., Janek, J., and Zeier, W. G. (2017). Influence of Lattice Polarizability on the Ionic Conductivity in the Lithium Superionic Argyrodites Li₆PS₅X (X═Cl, Br, I). J. Am. Chem. Soc. 139, 10909-10918.
211. Doux, J., Nguyen, H., Tan, D. H. S., Banerjee, A., Wang, X., Wu, E. A., Jo, C., Yang, H., and Meng, Y. S. (2020). Stack Pressure Considerations for Room-Temperature All-Solid-State Lithium Metal Batteries. Adv. Energy Mater. 10, 1903253.
212. Auvergniot, J., Cassel, A., Ledeuil, J.-B., Viallet, V., Seznec, V., and Dedryvere, R. (2017). Interface Stability of Argyrodite Li₆PS₅Cl toward LiCoO₂, LiNi_{1/3}Co_{1/3}Mn_{1/3}O₂, and LiMn₂O₄ in Bulk All-Solid-State Batteries. Chem. Mater. 29, 3883-3890.
213. Yu, C., Li, Y., Willans, M., Zhao, Y., Adair, K. R., Zhao, F., Li, W., Deng, S., Liang, J., Banis, M. N., et al. (2020). Superionic conductivity in lithium argyrodite solid-state electrolyte by controlled CI-doping. Nano Energy 69, 104396.
214. Kato, Y., Hori, S., Saito, T., Suzuki, K., Hirayama, M., Mitsui, A., Yonemura, M., Iba, H., and Kanno, R. (2016). High-power all-solid-state batteries using sulfide superionic conductors. Nat. Energy 1, 16030.
215. Delnick, F. M., Yang, G., Self, E. C., Meyer, H. M., and Nanda, J. (2020). Investigation of Complex Intermediates in Solvent-Mediated Synthesis of Thiophosphate Solid-State Electrolytes. J. Phys. Chem. C 124, 27396-27402.
216. Self, E. C., Hood, Z. D., Brahmbhatt, T., Delnick, F. M., Meyer, H. M., Yang, G., Rupp, J. L. M., and Nanda, J. (2020). Solvent-Mediated Synthesis of Amorphous Li₃PS₄/Polyethylene Oxide Composite Solid Electrolytes with High Li+ Conductivity. Chem. Mater. 32, 8789-8797.
217. Ates, T., Keller, M., Kulisch, J., Adermann, T., and Passerini, S. (2019). Development of an all-solid-state lithium battery by slurry-coating procedures using a sulfidic electrolyte. Energy Stor. Mater. 17, 204-210.
218. Kim, D. H., Oh, D. Y., Park, K. H., Choi, Y. E., Nam, Y. J., Lee, H. A., Lee, S.-M., and Jung, Y. S. (2017). Infiltration of Solution-Processable Solid Electrolytes into Conventional Li-Ion-Battery Electrodes for All-Solid-State Li-Ion Batteries. Nano Lett. 17, 3013-3020.
219. Yu, C., Ganapathy, S., Eck, E. R. H. van, Wang, H., Basak, S., Li, Z., and Wagemaker, M. (2017). Accessing the bottleneck in all-solid state batteries, lithium-ion transport over the solid-electrolyte-electrode interface. Nat. Commun. 8, 1086.
220. Cheng, Z., Liu, M., Ganapathy, S., Li, C., Li, Z., Zhang, X., He, P., Zhou, H., and Wagemaker, M. (2020). Revealing the Impact of Space-Charge Layers on the Li-Ion Transport in All-Solid-State Batteries. Joule 4, 1311-1323.
221. Wang, L., Xie, R., Chen, B., Yu, X., Ma, J., Li, C., Hu, Z., Sun, X., Xu, C., Dong, S., et al. (2020). In-situ visualization of the space-charge-layer effect on interfacial lithium-ion transport in all-solid-state batteries. Nat. Commun. 11, 5889.
222. Yu, C., Ganapathy, S., de Klerk, N. J. J., Roslon, I., van Eck, E. R. H., Kentgens, A. P. M., and Wagemaker, M. (2016). Unravelling Li-Ion Transport from Picoseconds to Seconds: Bulk versus Interfaces in an Argyrodite Li₆PS₅Cl—Li₂S All-Solid-State Li-Ion Battery. J. Am. Chem. Soc. 138, 11192-11201.
223. Ohno, S., Koerver, R., Dewald, G., Rosenbach, C., Titscher, P., Steckermeier, D., Kwade, A., Janek, J., and Zeier, W. G. (2019). Observation of Chemomechanical Failure and the Influence of Cutoff Potentials in All-Solid-State Li—S Batteries. Chem. Mater. 31, 2930-2940.
224. Zhao, F., Sun, Q., Yu, C., Zhang, S., Adair, K., Wang, S., Liu, Y., Zhao, Y., Liang, J., Wang, C., et al. (2020). Ultrastable Anode Interface Achieved by Fluorinating Electrolytes for All-Solid-State Li Metal Batteries. ACS Energy Lett. 5, 1035-1043.
225. Xiao, W., Xu, H., Xuan, M., Wu, Z., Zhang, Y., Zhang, X., Zhang, S., Shen, Y., and Shao, G. (2021). Stable all-solid-state battery enabled with Li_{6.25}PS_{5.25}Cl_{0.75} as fast ion-conducting electrolyte. J. Energy Chem. 53, 147-154.
226. Kim, D. H., Lee, Y.-H., Song, Y. B., Kwak, H., Lee, S.-Y., and Jung, Y. S. (2020). Thin and Flexible Solid Electrolyte Membranes with Ultrahigh Thermal Stability Derived from Solution-Processable Li Argyrodites for All-Solid-State Li-Ion Batteries. ACS Energy Lett. 5, 718-727.
227. Zhang, J., Zhong, H., Zheng, C., Xia, Y., Liang, C., Huang, H., Gan, Y., Tao, X., and Zhang, W. (2018). All-solid-state batteries with slurry coated LiNi_{0.3}Co_{0.1}Mn_{0.1}O₂ composite cathode and Li₆PS₅Cl electrolyte: Effect of binder content. J. Power Sources 391, 73-79.
228. Moon, C. K., Lee, H.-J., Park, K. H., Kwak, H., Heo, J. W., Choi, K., Yang, H., Kim, M.-S., Hong, S.-T., Lee, J. H., et al. (2018). Vacancy-Driven Na⁺ Superionic Conduction in New Ca-Doped Na₃PS₄ for All-Solid-State Na-Ion Batteries. ACS Energy Lett. 3, 2504-2512.
229. Feng, X., Chien, P.-H., Zhu, Z., Chu, I.-H., Wang, P., Immediato-Scuotto, M., Arabzadeh, H., Ong, S. P., and Hu, Y.-Y. (2019). Studies of Functional Defects for Fast Na-Ion Conduction in Na_{3-y}PS₄₋ₓClₓ with a Combined Experimental and Computational Approach. Adv. Funct. Mater. 29, 1807951.
230. Yu, Z., Shang, S.-L., Seo, J.-H., Wang, D., Luo, X., Huang, Q., Chen, S., Lu, J., Li, X., Liu, Z.-K., et al. (2017). Exceptionally High Ionic Conductivity in Na₃P_{0.62}As_{0.38}S₄ with Improved Moisture Stability for Solid-State Sodium-Ion Batteries. Adv. Mater. 29, 1605561.
231. Banerjee, A., Park, K. H., Heo, J. W., Nam, Y. J., Moon, C. K., Oh, S. M., Hong, S.-T., and Jung, Y. S. (2016). Na₃SbS₄: A Solution Processable Sodium Superionic Conductor for All-Solid-State Sodium-Ion Batteries. Angew. Chem. Int. Ed. 55, 9634-9638.
232. Hayashi, A., Noi, K., Sakuda, A., and Tatsumisago, M. (2012). Superionic glass-ceramic electrolytes for room-temperature rechargeable sodium batteries. Nat. Commun. 3, 856.
233. Jalem, R., Hayashi, A., Tsuji, F., Sakuda, A., and Tateyama, Y. (2020). First-Principles Calculation Study of Na⁺ Superionic Conduction Mechanism in W- and Mo-Doped Na₃SbS₄ Solid Electrolytes. Chem. Mater. 32, 8373-8381.
234. Zhang, L., Zhang, D., Yang, K., Yan, X., Wang, L., Mi, J., Xu, B., and Li, Y. (2016). Vacancy-Contained Tetragonal Na₃SbS₄ Superionic Conductor. Adv. Sci. 3, 1600089.
235. de Klerk, N. J. J., and Wagemaker, M. (2016). Diffusion Mechanism of the Sodium-Ion Solid Electrolyte Na₃PS₄ and Potential Improvements of Halogen Doping. Chem. Mater. 28, 3122-3130.
236. Tanibata, N., Noi, K., Hayashi, A., and Tatsumisago, M. (2014). Preparation and characterization of highly sodium ion conducting Na₃PS₄—Na₄SiS═ solid electrolytes. RSC Adv. 4, 17120-17123.
237. Zhu, Z., Chu, I.-H., Deng, Z., and Ong, S. P. (2015). Role of Na+ Interstitials and Dopants in Enhancing the Na⁺ Conductivity of the Cubic Na₃PS₄ Superionic Conductor. Chem. Mater. 27, 8318-8325.
238. Krauskopf, T., Culver, S. P., and Zeier, W. G. (2018). Local Tetragonal Structure of the Cubic Superionic Conductor Na₃PS₄. Inorg. Chem. 57, 4739-4744.
239. Zhang, D., Cao, X., Xu, D., Wang, N., Yu, C., Hu, W., Yan, X., Mi, J., Wen, B., Wang, L., et al. (2018). Synthesis of cubic Na₃SbS₄ solid electrolyte with enhanced ion transport for all-solid-state sodium-ion batteries. Electrochim. Acta 259, 100-109.
240. Wu, E. A., Kompella, C. S., Zhu, Z., Lee, J. Z., Lee, S. C., Chu, I.-H., Nguyen, H., Ong, S. P., Banerjee, A., and Meng, Y. S. (2018). New Insights into the Interphase between the Na Metal Anode and Sulfide Solid-State Electrolytes: A Joint Experimental and Computational Study. ACS Appl. Mater. Inter. 10, 10076-10086.
241. Tian, Y., Sun, Y., Hannah, D. C., Xiao, Y., Liu, H., Chapman, K. W., Bo, S.-H., and Ceder, G. (2019). Reactivity-Guided Interface Design in Na Metal Solid-State Batteries. Joule 3, 1037-1050.
242. Tanibata, N., Deguchi, M., Hayashi, A., and Tatsumisago, M. (2017). All-Solid-State Na/S Batteries with a Na₃PS₄ Electrolyte Operating at Room Temperature. Chem. Mater. 29, 5232-5238.
243. Lu, Y., Li, L., Zhang, Q., Niu, Z., and Chen, J. (2018). Electrolyte and Interface Engineering for Solid-State Sodium Batteries. Joule 2, 1747-1770.
244. Tian, Y., Shi, T., Richards, W. D., Li, J., Kim, J. C., Bo, S.-H., and Ceder, G. (2017). Compatibility issues between electrodes and electrolytes in solid-state batteries. Energy Environ. Sci. 10, 1150-1166.
245. Zhang, S., Zhao, Y., Zhao, F., Zhang, L., Wang, C., Li, X., Liang, J., Li, W., Sun, Q., Yu, C., et al. (2020). Gradiently Sodiated Alucone as an Interfacial Stabilizing Strategy for Solid-State Na Metal Batteries. Adv. Funct. Mater. 30, 2001118.
246. Zhang, Z., Cao, H., Yang, M., Yan, X., Yu, C., Liu, D., and Zhang, L. (2020). High performance room temperature all-solid-state Na—SeS battery with Na₃SbS₄-coated cathode via aqueous solution. J. Energy Chem. 48, 250-258.
247. Xu, X., Li, Y., Cheng, J., Hou, G., Nie, X., Ai, Q., Dai, L., Feng, J., and Ci, L. (2020). Composite solid electrolyte of Na₃PS₄—PEO for all-solid-state SnS₂/Na batteries with excellent interfacial compatibility between electrolyte and Na metal. J. Energy Chem. 41, 73-78.
248. Nguyen, H., Banerjee, A., Wang, X., Tan, D., Wu, E. A., Doux, J.-M., Stephens, R., Verbist, G., and Meng, Y. S. (2019). Single-step synthesis of highly conductive Na3PS4 solid electrolyte for sodium all solid-state batteries. J. Power Sources 435, 126623.
249. Oh, J. A. S., He, L., Plewa, A., Morita, M., Zhao, Y., Sakamoto, T., Song, X., Zhai, W., Zeng, K., and Lu, L. (2019). Composite NASICON (Na₃Zr₂Si₂PO₁₂) Solid-State Electrolyte with Enhanced Na⁺ Ionic Conductivity: Effect of Liquid Phase Sintering. ACS Appl. Mater. Inter. 11, 40125-40133.
250. Park, H., Jung, K., Nezafati, M., Kim, C.-S., and Kang, B. (2016). Sodium Ion Diffusion in NASICON (Na₃Zr₂Si₂PO₁₂) Solid Electrolytes: Effects of Excess Sodium. ACS Appl. Mater. Inter. 8, 27814-27824.
251. Boilot, J. P., Collin, G., and Colomban, P. H. (1988). Ion Conduction in the NASICON. J. Solid State Chem. 73, 160-171.
252. Noguchi, Y., Kobayashi, E., Plashnitsa, L. S., Okada, S., and Yamaki, J. (2013). Fabrication and performances of all solid-state symmetric sodium battery based on NASICON-related compounds. Electrochim. Acta 101, 59-65.
253. Samiee, M., Radhakrishnan, B., Rice, Z., Deng, Z., Meng, Y. S., Ong, S. P., and Luo, J. (2017). Divalent-doped Na₃Zr₂Si₂PO₁₂ natrium superionic conductor: Improving the ionic conductivity via simultaneously optimizing the phase and chemistry of the primary and secondary phases. J. Power Sources 347, 229-237.
254. Feng, X., Chien, P.-H., Patel, S., Wang, Y., and Hu, Y.-Y. (2020). Enhanced Ion Conduction in Li_{2.5}Zn_{0.25}PS₄ via Anion Doping. Chem. Mater. 32, 3036-3042.
255. Lacivita, V., Wang, Y., Bo, S.-H., and Ceder, G. (2019). Ab initio investigation of the stability of electrolyte/electrode interfaces in all-solid-state Na batteries. J. Mater. Chem. A 7, 8144-8155.
256. Gao, H., Xin, S., Xue, L., and Goodenough, J. B. (2018). Stabilizing a High-Energy-Density Rechargeable Sodium Battery with a Solid Electrolyte. Chem 4, 833-844.
257. Schmid, H., Dejonghe, L., and Cameron, C. (1982). Chemical stability of NASICON. Solid State Ionics 6, 57-63.
258. Lu, Y., Alonso, J. A., Yi, Q., Lu, L., Wang, Z. L., and Sun, C. (2019). A High-Performance Monolithic Solid-State Sodium Battery with Ca²⁺ Doped Na₃Zr₂Si₂PO₁₂ Electrolyte. Adv. Energy Mater. 9, 1901205.
259. Zhou, W., Li, Y., Xin, S., and Goodenough, J. B. (2017). Rechargeable Sodium All-Solid-State Battery. ACS Cent. Sci. 3, 52-57.
260. Yu, X., Xue, L., Goodenough, J. B., and Manthiram, A. (2019). A High-Performance All-Solid-State Sodium Battery with a Poly(ethylene oxide)-Na₃Zr₂Si₂PO₁₂ Composite Electrolyte. ACS Materials Lett. 1, 132-138.
261. Zhao, Y., Wang, C., Dai, Y., and Jin, H. (2021). Homogeneous Na+ transfer dynamic at Na/Na₃Zr₂Si₂PO₁₂ interface for all solid-state sodium metal batteries. Nano Energy 88, 106293.
262. Wang, X., Liu, Z., Tang, Y., Chen, J., Wang, D., and Mao, Z. (2021). Low temperature and rapid microwave sintering of Na₃Zr₂Si₂PO₁₂ solid electrolytes for Na-Ion batteries. J. Power Sources 481, 228924.
263. Yang, J., Liu, G., Avdeev, M., Wan, H., Han, F., Shen, L., Zou, Z., Shi, S., Hu, Y.-S., Wang, C., et al. (2020). Ultrastable All-Solid-State Sodium Rechargeable Batteries. ACS Energy Lett. 5, 2835-2841.
264. Lu, Y., Li, L., Zhang, Q., Niu, Z., and Chen, J. (2018). Electrolyte and Interface Engineering for Solid-State Sodium Batteries. Joule 2, 1747-1770.
265. Evstigneeva, M. A., Nalbandyan, V. B., Petrenko, A. A., Medvedev, B. S., and Kataev, A. A. (2011). A New Family of Fast Sodium Ion Conductors: Na₂M₂TeO₆ (M=Ni, Co, Zn, Mg). Chem. Mater. 23, 1174-1181.
266. Zuo, X., Chang, K., Zhao, J., Xie, Z., Tang, H., Li, B., and Chang, Z. (2016). K₂Fe₄O₇ superionic conductor for all-solid-state potassium metal batteries. J. Mater. Chem. A 4, 51-58.
267. Feng, T., Li, L., Lv, Z., Li, B., Zhang, Y., and Li, G. (2019). Temperature-dependent electrical transport behavior and structural evolution in hollandite-type titanium-based oxide. J. Am. Ceram. Soc. 102, 6741-6750.
268. Udovic, T. J., Matsuo, M., Tang, W. S., Wu, H., Stavila, V., Soloninin, A. V., Skoryunov, R. V., Babanova, O. A., Skripov, A. V., Rush, J. J., et al. (2014). Exceptional Superionic Conductivity in Disordered Sodium Decahydro-closo-decaborate. Adv. Mater. 26, 7622-7626.
269. Wang, S., Ding, Y., Zhou, G., Yu, G., and Manthiram, A. (2016). Durability of the Li₁₊ₓTi₂₋ₓAlₓ(PO₄)₃ Solid Electrolyte in Lithium-Sulfur Batteries. ACS Energy Lett. 1, 1080-1085.
270. Choi, B.-K. (2019). Ionic Conductivities and Melting Transition Studies of NaBH₄, KBH₄, and Their Mixtures. ASCT 28, 169-172.
271. Duchêne, L., Kühnel, R.-S., Rentsch, D., Remhof, A., Hagemann, H., and Battaglia, C. (2017). A highly stable sodium solid-state electrolyte based on a dodeca/deca-borate equimolar mixture. Chem. Commun. 53, 4195-4198.
272. Zhang, Z., Li, H., Kaup, K., Zhou, L., Roy, P.-N., and Nazar, L. F. (2020). Targeting Superionic Conductivity by Turning on Anion Rotation at Room Temperature in Fast Ion Conductors. Matter 2, 1667-1684.
273. Andersen, N., Bandaranayake, P., Careem, M., Dissanayake, M., Wijayasekera, C., Kaber, R., Lunden, A., Mellander, B., Nilsson, L., and Thomas, J. (1992). Paddle-wheel versus percolation mechanism for cation transport in some sulphate phases☆. Solid State Ionics 57, 203-209.
274. Zhong, Y., Shi, Q., Zhu, C., Zhang, Y., Li, M., Francisco, J. S., and Wang, H. (2021). Mechanistic Insights into Fast Charging and Discharging of the Sodium Metal Battery Anode: A Comparison with Lithium. J. Am. Chem. Soc., jacs.1c06794.
275. Chen, R., Nolan, A. M., Lu, J., Wang, J., Yu, X., Mo, Y., Chen, L., Huang, X., and Li, H. (2020). The Thermal Stability of Lithium Solid Electrolytes with Metallic Lithium. Joule 4, 812-821.
276. Weiss, M., Simon, F. J., Busche, M. R., Nakamura, T., Schroder, D., Richter, F. H., and Janek, J. (2020). From Liquid- to Solid-State Batteries: Ion Transfer Kinetics of Heteroionic Interfaces. Electrochem. Energ. Rev. 3, 221-238.

1. An electrochemical cell comprising:
a solid-state electrolyte comprising two or more separate phases;
wherein at least one phase is an ion-conductive phase; and
wherein at least one phase is a toughening phase, wherein the toughening phase is structurally and/or chemically different from the ion-conductive phase.

2. (canceled)

3. The electrochemical cell of claim 1, wherein the solid-state electrolyte comprises a bulk and a first and a second surface, and wherein the toughening phase is disposed on at least the first and/or the second surface of the solid-state electrolyte.

4. The electrochemical cell of claim 3, wherein the ion-conductive phase is dispersed through the bulk of the solid-state electrolyte and wherein the toughening phase is dispersed at one or more grain boundaries of the ion-conductive phase or wherein the solid-state electrolyte comprises two or more ion-conductive phases and two or more toughening phases, wherein at least one of the two or more toughening phases behave as an interphase between at least two of the two or more ion-conductive phases.

5. (canceled)

6. (canceled)

7. (canceled)

8. (canceled)

9. (canceled)

10. The electrochemical cell of claim 1, wherein the toughening phase comprises ZrO₂, Y₂O₃, Yttria-stabilized zirconia (YSZ), (ZrO₂)₁₋ₓ(Y₂O₃)ₓ where 0.001≤x≤0.999, zirconia toughened alumina (ZTA) based on xZrO₂-yAl₂O₃ where x+y=1, mixed oxide ceramics, 20% ZrO₂ and 80% Al₂O₃, magnesium oxide ceramics, MgO, beryllium oxide ceramics, BeO, mullite ceramics based on x(Al₂O₃)y(SiO₂) where x=2 and y=3 or x=2 and y=1, zirconia toughened mullite (ZTM) based on x(ZrO₂)_{y}(Al₂O₃)_{z}(SiO₂) where x=0.25, y=2 and z=3, phase transforming ceramics, PZT lead zirconate titanate Pb[ZrₓTi₁₋ₓ]O₃ where 0≤x≤1, oxygen-rich or oxygen-deficient versions thereof, alloys thereof, multiphase composites thereof, or a combination thereof; and wherein the toughening phase prevents dendrites and/or fractures during cell operation and/or storage.

11. The electrochemical cell of claim 1, wherein the toughening phase exhibits morphology of equiaxed spherical, cuboidal, ill-defined particulate, plate-like, whiskers, or combinations thereof.

12. (canceled)

13. The electrochemical cell of claim 1, wherein the toughening phase is present in the solid-state electrolyte in a range from about 0.01% to about 50% by weight.

14. (canceled)

15. The electrochemical cell of claim 1, wherein the ion-conductive phase comprises garnets, argyrodites, lithium phosphorus oxynitrides, NASICON-type, LISICON-types, beta-alumina, sulfides and halides, thiophosphates, or combinations thereof.

16. The electrochemical cell of claim 1, wherein the ion-conductive phase comprises pure or dopped LLZO (Li₇La₃Zr₂O₁₂); Li₆AS₅X, wherein A=P, Sb and X═Cl, Br, I; or Na₃AB₄ or K₃AB₄, wherein A is P, Sb, or As and B is S or Se, wherein the ion-conductive phase is optionally doped with Ta, Nb, Zr, Me, B, Si, Mo, or any combination thereof, and wherein the ion-conductive phase exhibits ionic conductivity from about 5.0×10⁻⁶ to about 1.0×10⁻¹ S/m or more.

17. (canceled)

18. (canceled)

19. The electrochemical cell of claim 1, further comprising an anode material comprising Li, Na, K, Zn, Mg, Li alloys, Li intermetallics, Li compounds, Na alloys, Na intermetallics, Na compounds, K alloys, K intermetallics, K compounds, Si, Si alloys, Si compounds or any combination thereof.

20. (canceled)

21. The electrochemical cell of claim 1, further comprising a cathode material, wherein the cathode material is a metal, a ceramic, or a composite.

22. (canceled)

23. (canceled)

24. The electrochemical cell of claim 3, therein the first and/or second surface of the solid-state electrolyte comprises a layer comprising Ga, Al₂O₃, or a combination thereof, wherein at least one phase is an electron-conductive phase, and wherein the electron-conductive phase is disposed on the first or the second surface of the solid-state electrolyte.

25. (canceled)

26. (canceled)

27. The electrochemical cell of claim 1, where the electrochemical cell exhibits continuous plating of about 0.01 mAh/cm⁻² to about 10 mAh/cm⁻² operating at 25-100° C. for 2-5000 cycles.

28. A method comprising:
incorporating at least one toughening additive into a solid-state electrolyte, wherein the at least one toughening additive is incorporated into the solid-state electrolyte by any of mixing, milling or sintering, post-sintering impregnation and post-sintering surface coating based on physical or chemical vapor deposited thin films, or wet chemical synthesis.

29. (canceled)

30. (canceled)

31. The method of claim 28, wherein the toughening additive comprises a metal carbide, or a metal oxide, or a metal nitride, or a metal oxynitride, or a metal boride.

32. (canceled)

33. (canceled)

34. (canceled)

35. (canceled)

36. The method of claim 28, wherein the toughening additive comprises;
a) TaC, MoC, SiC, WC, WC—(Fe, Ni, C), TiC, TaC, NbC, WC—Co, carbon rich or carbon deficient versions of thereof, alloys thereof, multiphase composites thereof, or a combination thereof; or
b) TaN, MoN, SiN, W₃N₂, TiN, NbN, nitrogen rich or nitrogen deficient versions thereof, alloys thereof, multiphase composites thereof, or a combination thereof; or
c) TaNₓO₁₋ₓ where 0.001≤x≤0.999, MoNₓO₁₋ₓ, SiNₓO₁₋ₓ, W₃N₂ₓO₁₋ₓ, TiNₓO₁₋ₓ, NbNₓO₁₋ₓ, nitrogen rich or nitrogen deficient versions of thereof, alloys thereof, multiphase composites thereof, or a combination thereof; or
d) TaB₂), ZrB₂ and HfB₂, boron rich or boron deficient versions of thereof, alloys thereof, borides containing oxygen, TaB₂O₁₋ₓ where 0.001≤x≤0.999, multiphase composites thereof, or a combination thereof; or
e) metal dichalcogenides; or
f) Te, Se, S, MoS₂, MoSe₂, MoTe₂, WS₂, and/or WSe₂.

37. (canceled)

38. (canceled)

39. (canceled)

40. (canceled)

41. (canceled)

42. The method of claim 28, wherein the toughening additive promotes densification of the solid-state electrolyte during sintering, resulting in higher final compact density of the solid-state electrolyte comprising the toughening agent than for a given processing regiment of a solid-state electrolyte not comprising the toughening additive.

43. The method of claim 28, wherein the toughening additive is about 5% by weight of the solid-state electrolyte.

44. (canceled)

45. The method of claim 28, wherein the solid-state electrolyte comprises garnets, argyrodites, lithium phosphorus oxynitrides, NASICON-type, LISICON-types, beta-alumina, sulfides and halides, thiophosphates, or combinations thereof.

46. The method of claim 28, wherein the solid-state electrolyte comprises pure or dopped LLZO (Li₇La₃Zr₂O₁₂); Li₆AS₅X, wherein A=P, Sb and X═Cl, Br, I; or Na₃AB₄ or K₃AB₄, wherein A is P, Sb, or As and B is S or Se, wherein the solid-state electrolyte optionally electrolyte is doped with Ta, Nb, Zr, Mg, B, Si, Mo, or any combination thereof.

47. (canceled)

48. The method of claim 28, further comprising providing an electron-conductive phase onto one or more surfaces of the solid-state electrolyte.
